(19) United States
(12) Patent Application Publication
(10) Pub. No.: US 2024/0345433 A1
(43) Pub. Date: Oct. 17, 2024

(54) POLYMERIZABLE COMPOSITION, CURED PRODUCT, WAVELENGTH CONVERSION MEMBER, BACKLIGHT UNIT, AND LIQUID CRYSTAL DISPLAY DEVICE

(71) Applicant: FUJIFILM Corporation, Tokyo (JP)

(72) Inventors: Daisuke HAYASHI, Kanagawa (JP); Keita TAKAHASHI, Kanagawa (JP); Natsuru CHIKUSHI, Kanagawa (JP)

(73) Assignee: FUJIFILM Corporation, Tokyo (JP)

(21) Appl. No.: 18/611,248

(22) Filed: Mar. 20, 2024

Related U.S. Application Data
(63) Continuation of application No. PCT/JP2022/035370, filed on Sep. 22, 2022.

(30) Foreign Application Priority Data
Sep. 22, 2021 (JP) 2021-154610

(51) Int. Cl. G02F 1/1335; C09K 11/02; C09K 11/62; C09K 11/70; G02F 1/13357

(52) U.S. Cl. CPC G02F 1/133514; C09K 11/02; C09K 11/623; C09K 11/703; G02F 1/133617; C09K 2211/10

(57) ABSTRACT

A polymerizable composition including quantum dots, a polymerizable compound containing one or more polymerizable groups selected from the group consisting of a (meth)acryloyl group and a (meth)allyl group in one molecule, inorganic particles having an average particle diameter of 0.10 μm or more, and a compound represented by General Formula (1)

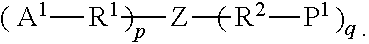

In General Formula (1), P¹ represents a polymer structure having an I/O value of 0.250 or more and 1.650 or less.

### CROSS-REFERENCE TO RELATED APPLICATIONS

This application is a Continuation of PCT International Application No. PCT/JP2022/035370 filed on Sep. 22, 2022, which was published under PCT Article 21(2) in Japanese, and which claims priority under 35 U.S.C. § 119(a) to Japanese Patent Application No. 2021-154610 filed on Sep. 22, 2021. The above applications are hereby expressly incorporated by reference, in their entirety, into the present application.

### BACKGROUND OF THE INVENTION

### 1. Field of the Invention

The present invention relates to a polymerizable composition, a cured product, a wavelength conversion member, a backlight unit, and a liquid crystal display device.

### 2. Description of the Related Art

Flat panel displays such as liquid crystal display devices (hereinafter, also referred to as “LCD”) have been widely used year by year as a space-saving image display device with low power consumption. Each liquid crystal display device typically includes at least a backlight unit and a liquid crystal cell.

In recent years, a quantum dot (also referred to as QD, quantum point, or the like) has been attracting attention as a light emitting material for flat panel displays (see WO2016/189827A and JP2019-175952A).

### SUMMARY OF THE INVENTION

The backlight unit may include at least a member including quantum dots and a light source. Such a member is typically called a wavelength conversion member. For example, in a case where light is incident into the wavelength conversion member from a light source, the quantum dots are excited by the incident light to emit fluorescence. Here, by using quantum dots having different light emission characteristics, each bright line light of red light, green light, and blue light can be emitted from the wavelength conversion member as fluorescence emitted from the quantum dots and/or light emitted from the light source and passing through the wavelength conversion member. White light can be thus realized. Since the fluorescence emitted from the quantum dots has a small half-width, the resulting white light has high luminance and has excellent color reproducibility. With the progress of such a three wavelength light source technology using quantum dots, the color reproduction range has been expanded from 72% to 100% of the current television (TV) standard (full high definition (FHD)) from National Television System Committee (NTSC).

Examples of the wavelength conversion member include a member having a cured product (typically referred to as a “wavelength conversion layer”) obtained by curing a polymerizable composition containing quantum dots and a polymerizable compound. WO2016/189827A suggests that a polymer dispersant represented by General Formula I described in WO2016/189827A is used as such a polymerizable composition in order to improve the dispersion stability of quantum dots in a polymerizable composition containing an epoxy monomer.

In paragraph [0066] and the like of JP2019-175952A, a white pigment, specifically, various inorganic particles are described as a component that may be contained in a polymerizable composition containing quantum dots.

From the viewpoint of improving the luminance of the wavelength conversion member including a cured product obtained by curing this polymerizable composition, it is considered that it is preferable that the polymerizable composition including the quantum dots and the polymerizable compound further contains inorganic particles. However, in a case where the dispersibility of the inorganic particles in the polymerizable composition is low, a decrease in luminance may be caused. Thus, the inventors of the present invention have studied a dispersant for increasing the dispersibility of inorganic particles in a polymerizable composition including quantum dots, a polymerizable compound, and inorganic particles. As such a dispersant, a dispersant having excellent solubility in the polymerizable compound is desirable from the viewpoint of favorably exhibiting the effect of improving the dispersibility of the inorganic particles in the polymerizable composition.

In consideration of the above circumstances, an object of an aspect of the present invention is to provide a polymerizable composition including quantum dots, a polymerizable compound, and inorganic particles, and further including a compound capable of functioning as a dispersant with respect to the inorganic particles and exhibiting high solubility with respect to the polymerizable compound.

An aspect of the present invention is as follows.

[1] A polymerizable composition comprising:
quantum dots;
a polymerizable compound containing one or more polymerizable groups selected from the group consisting of a (meth)acryloyl group and a (meth)allyl group in one molecule;
inorganic particles having an average particle diameter of 0.10 μm or more; and
a compound represented by General Formula (1),

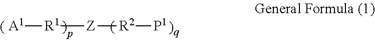

in General Formula (1), p is in a range of 2 to 9, q is in a range of 1 to 8, p+q is an integer in a range of 3 to 10, Z represents a (p+q)-valent organic group, R¹ and R² each independently represent a single bond or a divalent group, A¹ represents a monovalent group including one or more groups selected from the group consisting of an acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group, P¹ represents a polymer structure having an I/O value of 0.250 or more and 1.650 or less, p pieces of A¹'s and p pieces of R¹'s each independently may be the same or different from each other, and in a case where q is 2 or more, q pieces of R²'s and q pieces of P¹'s each independently may be the same or different from each other.

[2] The polymerizable composition according to [1], wherein the I/O value of P¹ is 0.300 or more and 1.300 or less.

[3] The polymerizable composition according to [1] or [2], wherein the I/O value of P¹ is 0.400 or more and 0.700 or less.

[4] The polymerizable composition according to any one of [1] to [3], wherein the compound has a melting point of 30° C. or lower.

[5] The polymerizable composition according to any one of [1] to [4], wherein the compound is a compound represented by General Formula (2),

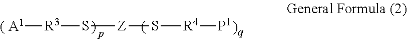

in General Formula (2), R³ and R⁴ each independently represent a single bond or a divalent group, p pieces of R³'s may be the same or different from each other, in a case where q is 2 or more, q pieces of R⁴'s may be the same or different from each other, and A¹, Z, P¹, p, and q each have the same definition as in General Formula (1).

[6] The polymerizable composition according to any one of [1] to [5], wherein the polymer structure represented by P¹ includes a vinyl polymer chain.

[7] The polymerizable composition according to [6], wherein the vinyl polymer chain includes a repeating unit represented by General Formula (4-3),

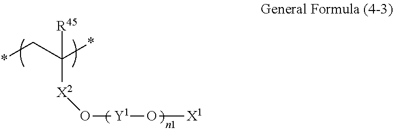

in General Formula (4-3), X¹ represents a hydrogen atom or a monovalent organic group, X² represents a divalent organic group, Y¹ represents a divalent organic group, X¹ and Y¹ may form a ring, n1 is 1 or more, and * represents a bonding position with an adjacent atom.

[8] The polymerizable composition according to any one of [1] to [7], wherein the polymer structure represented by P¹ includes a polyalkylene glycol chain.

[9] The polymerizable composition according to [8] wherein the polyalkylene glycol chain is a polypropylene glycol chain.

[10] The polymerizable composition according to any one of [1] to [9], wherein the compound has a weight-average molecular weight in a range of 4,000 to 15,000.

[11] The polymerizable composition according to any one of [1] to [10], wherein the inorganic particles have an average particle diameter of 0.30 μm or more and 5.00 μm or less.

[12] A cured product obtained by curing the polymerizable composition according to any one of [1] to [11].

[13] A wavelength conversion member comprising the cured product according to [12].

[14] A backlight unit comprising:
the wavelength conversion member according to [13]; and
a light source.

[15] A liquid crystal display device comprising:
the backlight unit according to [14]; and
a liquid crystal cell.

According to an aspect of the present invention, it is possible to provide a polymerizable composition including quantum dots, a polymerizable compound, and inorganic particles, and further including a compound capable of functioning as a dispersant with respect to the inorganic particles and exhibiting high solubility with respect to the polymerizable compound. In addition, according to an aspect of the present invention, it is possible to provide a cured product obtained by curing the polymerizable composition, a wavelength conversion member including the cured product, a backlight unit including the wavelength conversion member, and a liquid crystal display device including the backlight unit.

### BRIEF DESCRIPTION OF THE DRAWINGS

FIG. 1 is a perspective view conceptually illustrating an example of a wavelength conversion member.

FIG. 2 is a plan view of the wavelength conversion member of FIG. 1.

FIG. 3 is a cross-sectional view taken along the line III-III of FIGS. 1 and 2.

FIG. 4 is a cross-sectional view for describing an example of a shape of a resin layer of the wavelength conversion member.

FIG. 5 is a partially enlarged view of FIG. 3.

FIG. 6 is a cross-sectional view conceptually illustrating another example of the wavelength conversion member.

FIG. 7 is a cross-sectional view conceptually illustrating another example of the wavelength conversion member.

FIG. 8 is a plan view illustrating an example of a pattern of a quantum dot-containing part.

FIG. 9 is a plan view illustrating another example of the pattern of the quantum dot-containing part.

FIG. 10 is a conceptual diagram for describing a method for specifying the contour of the quantum dot-containing part.

FIG. 11 is a conceptual diagram for describing an example of a method for producing a wavelength conversion member.

FIG. 12 is a conceptual diagram for describing an example of the method for producing a wavelength conversion member.

FIG. 13 is a conceptual diagram for describing another example of the method for producing a wavelength conversion member.

FIG. 14 is a diagram conceptually illustrating a configuration of an example of a backlight unit.

FIG. 15 is a diagram conceptually illustrating a configuration of an example of a liquid crystal display device.

### DESCRIPTION OF THE PREFERRED EMBODIMENTS

The following description may be based on representative embodiments of the present invention. However, the present invention is not limited to such embodiments. In the present invention and the specification, a numerical range represented by using “to” means a range including numerical values described before and after “to” as a lower limit value and an upper limit value.

In the present invention and the specification, the “half-width” of a peak refers to a width of a peak at a peak height of ½. Light having a light emission center wavelength in the range of 400 nm or more to less than 500 nm is referred to as blue light, light having a light emission center wavelength in the range of 500 nm or more to less than 600 nm is referred to as green light, and light having a light emission center wavelength in the range of 600 nm or more to 680 nm or less is referred to as red light.

### [Polymerizable Composition]

An aspect of the present invention relates to a polymerizable composition comprising quantum dots, a polymerizable compound containing one or more polymerizable groups selected from a (meth)acryloyl group and a (meth)allyl group in one molecule, inorganic particles having an average particle diameter of 0.10 μm or more, and a compound represented by General Formula (1).

In the present invention and the specification, the “polymerizable composition” is a composition including at least one polymerizable compound, and has a property of curing by being subjected to a polymerization treatment such as light irradiation or heating. The “polymerizable compound” is a compound including one or more polymerizable groups in one molecule. The “polymerizable group” is a group that can participate in a polymerization reaction, and the (meth)acryloyl group and the (meth)allyl group are polymerizable groups.

In the present invention and the specification, the term “(meth)acryloyl” is used to indicate either or both of acryloyl and methacryloyl. The term “(meth)acrylate” refers to a compound containing one or more (meth)acryloyl groups in one molecule. The functional number regarding “(meth)acrylate” described later refers to the number of (meth)acryloyl groups contained in one molecule of (meth)acrylate. With respect to the (meth)acrylate, “monofunctional” means that the number of (meth)acryloyl groups contained in one molecule is one, and “polyfunctional” means that the number of (meth)acryloyl groups contained in one molecule is two or more. The (meth)acryloyl group may be contained in the (meth)acrylate in the form of a (meth)acryloyloxy group. The term “(meth)acryloyloxy group” is used to indicate either or both of an acryloyloxy group and a methacryloyloxy group.

In the present invention and the specification, the term “(meth)allyl” is used to indicate either or both of allyl and methallyl. The “(meth) allyl compound” refers to a compound including one or more (meth)allyl groups in one molecule. The functional number regarding the “(meth)allyl compound” described later refers to the number of (meth)allyl groups contained in one molecule of the (meth)allyl compound. Regarding the (meth)allyl compound, the term “monofunctional” means that the number of (meth)allyl groups contained in one molecule is one, and the term “polyfunctional” means that the number of (meth)allyl groups included in one molecule is two or more.

As a result of intensive studies, the inventors of the present invention have newly found that the compound represented by General Formula (1) is excellent in solubility in a polymerizable compound containing one or more polymerizable groups selected from the group consisting of a (meth)acryloyl group and a (meth)allyl group (hereinafter, also simply referred to as “solubility”) and can contribute to enhancement of dispersibility of inorganic particles in a polymerizable composition containing such a polymerizable compound, quantum dots, and inorganic particles having an average particle diameter of 0.1 μm or more (hereinafter, also simply referred to as “dispersibility”). The inventors presume that the I/O value of the polymer structure included as P¹ in General Formula (1) being in the range described above and the like can contribute to the improvement of the solubility described above. The inventors considers that the group included in A¹ in General Formula (1) being able to functioning as an adsorbing group, the I/O value of the polymer structure included as P¹ in General Formula (1) is in the above-described range, and the like can contribute to the improvement of dispersibility. However, the present invention is not limited to the above and other presumptions described in the present specification.

Hereinafter, the polymerizable composition will be further described in detail.

### <Quantum Dot>

The polymerizable composition may contain only one kind of quantum dots or may contain two or more kinds of quantum dots having different light emission characteristics. Quantum dots can be excited by excitation light to emit fluorescence. Known quantum dots include a quantum dot (A) having a light emission center wavelength in a wavelength range of 600 nm or more to 680 nm or less, a quantum dot (B) having a light emission center wavelength in a wavelength range of 500 nm or more to less than 600 nm, and a quantum dot (C) having a light emission center wavelength in a wavelength range of 400 nm or more to less than 500 nm. The quantum dot (A) can be excited by excitation light to emit red light, the quantum dot (B) can be excited by excitation light to emit green light, and the quantum dot (C) can be excited by excitation light to emit blue light. For example, in a case where blue light as excitation light is incident into a wavelength conversion member including the quantum dot (A) and the quantum dot (B), red light emitted by the quantum dot (A), green light emitted by the quantum dot (B), and blue light passing through the wavelength conversion member. As a result, white light can be realized. In addition, in a case where ultraviolet light as excitation light is incident into a wavelength conversion member including the quantum dots (A), (B), and (C), red light emitted by the quantum dot (A), green light emitted by the quantum dot (B), and blue light emitted by the quantum dot (C). As a result, white light can be realized.

In the present invention and the specification, the “quantum dots” are particles having an average particle diameter of less than 0.10 μm. The average particle diameter of the quantum dots may be, for example, 50 nm or less, 20 nm or less, or 10 nm or less, and may be, for example, 1 nm or more, or 3 nm or more. The quantum dots may be, for example, inorganic particles or organic particles. In the present invention and the specification, the “inorganic particles” are particles containing an inorganic substance as a main component, and the “organic particles” are particles containing an organic substance as a main component. The main component refers to a component occupying the largest amount on a mass basis among the components constituting the particles, and the content of the main component in the particles may be, for example, 50 mass % or more, 60 mass % or more, 70 mass % or more, 80 mass % or more, 90 mass % or more, 95 mass % or more, or 99 mass % or more, and may be 100 mass % or less, or less than 100 mass %. The inorganic particles may be particles formed of only an inorganic substance, and the organic particles may be particles formed of only an organic substance. Here, the particles formed of only an inorganic substance refer to particles containing only an inorganic substance except for impurities inevitably mixed in the production process. The same applies to particles formed of only an organic substance.

Semiconductor particles having an average particle diameter of less than 0.10 μm (that is, less than 100 nm, for example, 1 nm or more and 90 nm or less) are typically referred to as semiconductor nanoparticles. Examples of the quantum dots, may include core-shell type semiconductor nanoparticles may be exemplified. Examples of the core include Group II-VI semiconductor nanoparticles, Group III-V semiconductor nanoparticles, and multi-component semiconductor nanoparticles. Specific examples thereof include CdSe, CdTe, CdS, ZnS, ZnSe, ZnTe, InP, InAs, and InGaP. The present invention is not limited to these materials. CdSe, CdTe, InP, and InGaP are preferable because they can emit visible light with high efficiency. As the shell, Cds, ZnS, ZnO, GaAs, and/or a composite thereof may be used. The present invention is not limited to these materials. For the quantum dots, for example, known technologies such as paragraphs [0060] to [0066] of JP2012-169271A and paragraphs [0070] to [0076] of WO2018/186300A can be referenced. As the quantum dots, a commercially available product may be used, and quantum dots produced by a known method may also be used. The light emission characteristics of the quantum dots can usually be adjusted by the composition and/or size of the particles.

The quantum dots may also have a coating layer on the surface of the particle having a core-shell type structure. Having such a coating layer can contribute to prevent a decrease in performance due to moisture and/or oxygen.

The coating layer preferably has low permeability to moisture and/or oxygen and is transparent in the visible light region. Examples of a material suitable as the coating layer material include a metal oxide and a metal nitride, and specific examples thereof include silicon dioxide (SiO₂) (also referred to as “silica”) and aluminum oxide (Al₂O₃). The coating layer is not limited to these materials. As a method for forming a coating layer on the surface of a particle having a core-shell type structure, a known method such as a physical vapor deposition (PVD) method, a chemical vapor deposition (CVD) method, or an atomic layer deposition (ALD) method may be used. Of these, the CVD method and the ALD method are preferable from the viewpoint that a thin film can be uniformly formed on the quantum dot surface, and the ALD method is preferable from the viewpoint that the thickness of the coating layer can be precisely controlled. Hereinafter, the ALD method will be described as an example of a method for forming a coating layer. However, the coating layer is not limited to that formed by the ALD method.

### (ALD Method)

The ALD method is also referred to as an atomic layer deposition method, and is a method in which a raw material gas containing elements constituting a molecular layer (atomic layer) is alternately introduced into a vacuum apparatus, and each monoatomic (monomolecular) layer is deposited through a reaction between molecules adsorbed on the outermost surface of a film formation body disposed in the vacuum apparatus and a raw material gas introduced next, with which the film thickness of the layer can be controlled at an atomic layer level. Since the ALD method is a method in which film formation starts while each monoatomic (monomolecular) layer is deposited from the side of the film forming body, it is possible to form a coating layer (first coating layer, second coating layer, or the like) or the like having no pinhole on the film formation body (powder base material). In a typical vacuum film forming method (a vacuum evaporation method, a sputtering method, an ion plating method, an ion beam sputtering method, or the like), since clusters of a film raw material fly onto a film formation body, adhere to the surface of the film formation body, and the clusters are bonded to each other to form a film, pinholes may be latently formed between the clusters. The ALD method is significantly different from such a typical vacuum film forming method. According to the ALD method, a uniform film can be formed even on the surface of a film formation body having unevenness. It is difficult to form a film on the surface of a film formation body having unevenness by a sputtering method or a vacuum evaporation method having high straightness. Further, since the raw material is a gas in the ALD method, there is no occurrence of splash (flying of the film raw material as a lump to the film formation body) which frequently occurs in the sputtering method and the vacuum evaporation method. Thus, there is no phenomenon in which the splash adheres to the film being formed and falling off to form a pinhole. In addition, in the vacuum apparatus used in the ALD method, an expensive power supply unit or the like required in the vacuum apparatus used in the PVD method and the CVD method is not required. Thus, according to the ALD method, the film formation cost can be reduced as compared with the conventional film forming method.

In the polymerizable composition, the content of the quantum dots may be, for example, in a range of 0.1 to 10.0 mass % with respect to the total amount of the composition. In the present invention and the specification, regarding the polymerizable composition, the content of each component with respect to the total amount of the composition refers to, in a case where the polymerizable composition includes a solvent, a content calculated assuming that the total content of all the components excluding the solvent is 100.0 mass %. In a case where the polymerizable composition does not include a solvent, the content of each component with respect to the total amount of the composition is a content calculated by setting the total content of all the components included in the composition as 100.0 mass %. A certain component may be used alone or in combination of two or more kinds thereof. In a case where two or more kinds are used as a certain component, the content of the component refers to the total content thereof.

### <Inorganic Particle>

The polymerizable composition includes inorganic particles having an average particle diameter of 0.10 μm or more. Such inorganic particles can contribute to the improvement in luminance of a wavelength conversion member including a cured product obtained by curing the polymerizable composition. The inorganic particles having an average particle diameter of 0.10 μm or more are likely to be sedimentated, and thus dispersibility is likely to be decreased, whereas the inventors of the present invention presume that the above-described compound can increase dispersibility by preventing the sedimentation.

In the present invention and the specification, the “average particle diameter” of particles such as inorganic particles is a value obtained by the following method. Hereinafter, the particles before being used for preparing the polymerizable composition are referred to as “powder”.

Particles to be measured are observed with a scanning electron microscope (SEM) and imaged at 5000-fold magnification. Regarding particles present as a powder, the powder is observed. Regarding the particles contained in the polymerizable composition, a cross section of a cured product obtained by curing the polymerizable composition is observed. Regarding the particles in the cured product included in the wavelength conversion member, a cross section of this cured product is observed. The primary particle size is measured from the captured image. For particles that are not spherical, the average value of the length of the major axis and the length of the minor axis is determined and adopted as the primary particle size. In the captured image, an arithmetic average of primary particle sizes of 20 particles randomly selected is defined as an average particle diameter. The average particle diameter of the inorganic particles shown in examples which will be described later is a value obtained by observing and measuring a cross section of a cured product obtained by curing the polymerizable composition by using S-3400N manufactured by Hitachi High-Tech Corporation as a scanning electron microscope.

Examples of the inorganic substance constituting the inorganic particles having an average particle diameter of 0.10 μm or more include alumina particles, titanium oxide particles, silica particles, zirconium oxide particles, zinc oxide particles, and particles of inorganic lamella compounds such as mica and talc. The “alumina particles” are particles containing alumina as a main component in the same manner as the above description regarding the inorganic particles. The same applies to the various particles described above. The main component is as described above.

Regarding the inorganic particles having an average particle diameter of 0.10 μm or more, the average particle diameter is preferably 0.20 μm or more, and more preferably 0.30 μm or more, 0.40 μm or more, 0.50 μm or more, 0.60 μm or more, 0.70 μm or more, 0.80 μm or more, 0.90 μm or more, or 1.00 μm or more in this order, from the viewpoint of further improving the luminance of the wavelength conversion member including the cured product obtained by curing the polymerizable composition (hereinafter, also simply referred to as “luminance”). On the other hand, from the viewpoint of further improving dispersibility, the average particle diameter is preferably 5.00 μm or less, more preferably 4.00 μm or less, and still more preferably 3.00 m or less.

In the polymerizable composition, the content of the inorganic particles having an average particle diameter of 0.10 μm or more is preferably 3 mass % or more, and more preferably 5 mass % or more, with respect to the total amount of the composition, from the viewpoint of further improving luminance. The content of the inorganic particles having an average particle diameter of 0.10 μm or more is preferably 40 mass % or less, and more preferably 20 mass % or less with respect to the total mass of the composition, from the viewpoint of further improving luminance.

<Compound represented by General Formula (1)>

The polymerizable composition contains a compound represented by General Formula (1).

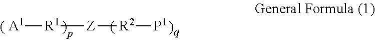

Hereinafter, General Formula (1) will be described in more detail.

In General Formula (1), p is in a range of 2 to 9, q is in a range of 1 to 8, and p+q is an integer in a range of 3 to 10.

P is 2 or more and preferably 3 or more. In addition, p is 9 or less, preferably 8 or less, more preferably 7 or less, and still more preferably 6 or less.

q is 1 or more, and may be 2 or more. In addition, q is 8 or less, preferably 7 or less, and more preferably in order of 6 or less, 5 or less, 4 or less, or 3 or less.

P+q is 3 or more, and may be 4 or more or 5 or more. In addition, p+q is 10 or less, and may be 9 or less, 8 or less, or 7 or less.

Z represents a (p+q)-valent organic group. Examples of the organic group represented by Z include an organic group formed of 1 to 100 carbon atoms, 0 to 10 nitrogen atoms, 0 to 50 oxygen atoms, 1 to 200 hydrogen atoms, and 0 to 20 sulfur atoms. Such an organic group may be unsubstituted or may further have a substituent.

Specific examples of the organic group represented by Z include a group (which may form a ring structure) including the following structural unit or a combination of two or more of the following structural units. Such an organic group may be unsubstituted or may further have a substituent.

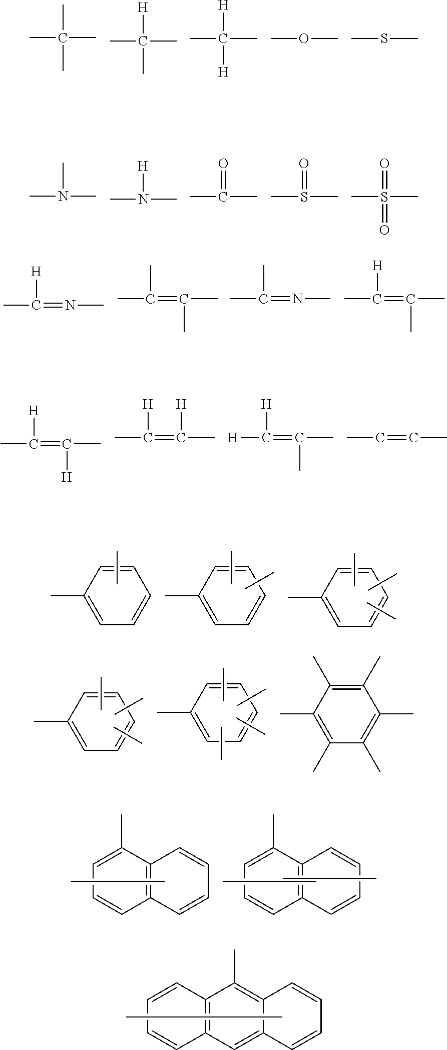

As the organic group represented by Z, an organic group formed of 1 to 60 carbon atoms, 0 to 10 nitrogen atoms, 0 to 40 oxygen atoms, 1 to 120 hydrogen atoms, and 0 to 10 sulfur atoms is preferable, an organic group constituted with 1 to 50 carbon atoms, 0 to 10 nitrogen atoms, 0 to 30 oxygen atoms, 1 to 100 hydrogen atoms, and 0 to 7 sulfur atoms is more preferable, and an organic group formed of 1 to 40 carbon atoms, 0 to 8 nitrogen atoms, 0 to 20 oxygen atoms, 1 to 80 hydrogen atoms, and 0 to 5 sulfur atoms is still more preferable. Such an organic group may be unsubstituted or may further have a substituent.

In a case where the organic group has a substituent, examples of the substituent include: an alkyl group having 1 to 20 carbon atoms such as a methyl group or an ethyl group; an aryl group having 6 to 16 carbon atoms such as a phenyl group or a naphthyl group; a hydroxy group; an amino group; a carboxy group; a sulfonamide group; an N-sulfonylamide group; an acyloxy group having 1 to 6 carbon atoms such as an acetoxy group; an alkoxy group having 1 to 6 carbon atoms such as a methoxy group or an ethoxy group; a halogen atom such as a chlorine atom or a bromine atom; an alkoxycarbonyl group having 2 to 7 carbon atoms such as a methoxycarbonyl group, an ethoxycarbonyl group, or a cyclohexyloxycarbonyl group; a cyano group; and a carbonate ester group such as a t-butyl carbonate.

In addition, various groups described below may be unsubstituted or may further have a substituent. For such substituents, the above description can be referenced. In the present invention and the specification, the number of carbon atoms described for a group having a substituent is the number of carbon atoms of a portion not including the substituent.

Specific examples of the organic group represented by Z (specific examples (1) to (17)) are shown below. However, the present invention is not limited to the following specific examples.

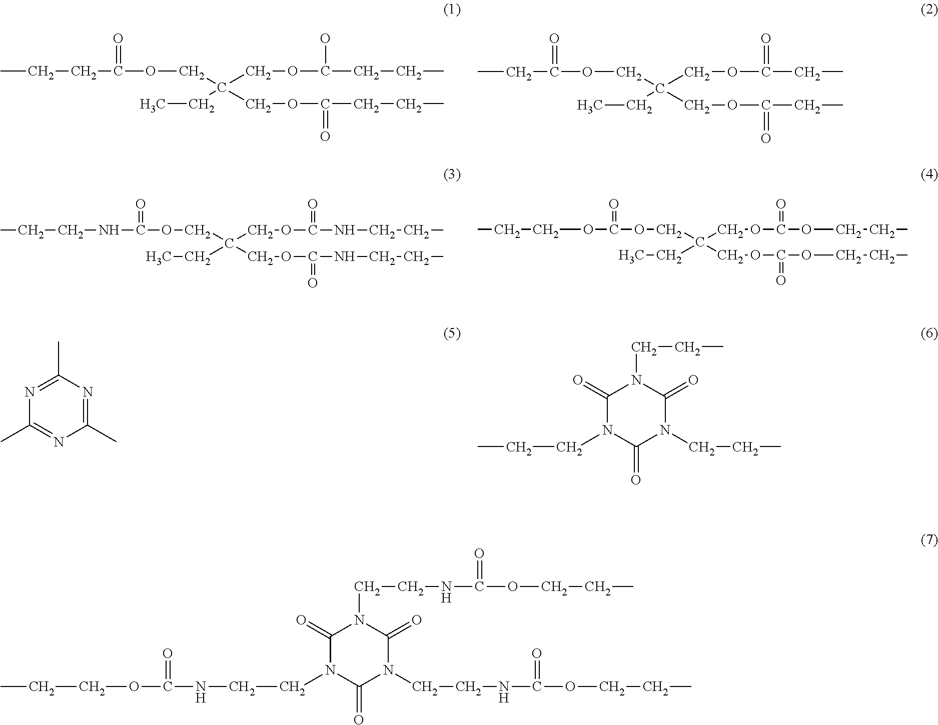

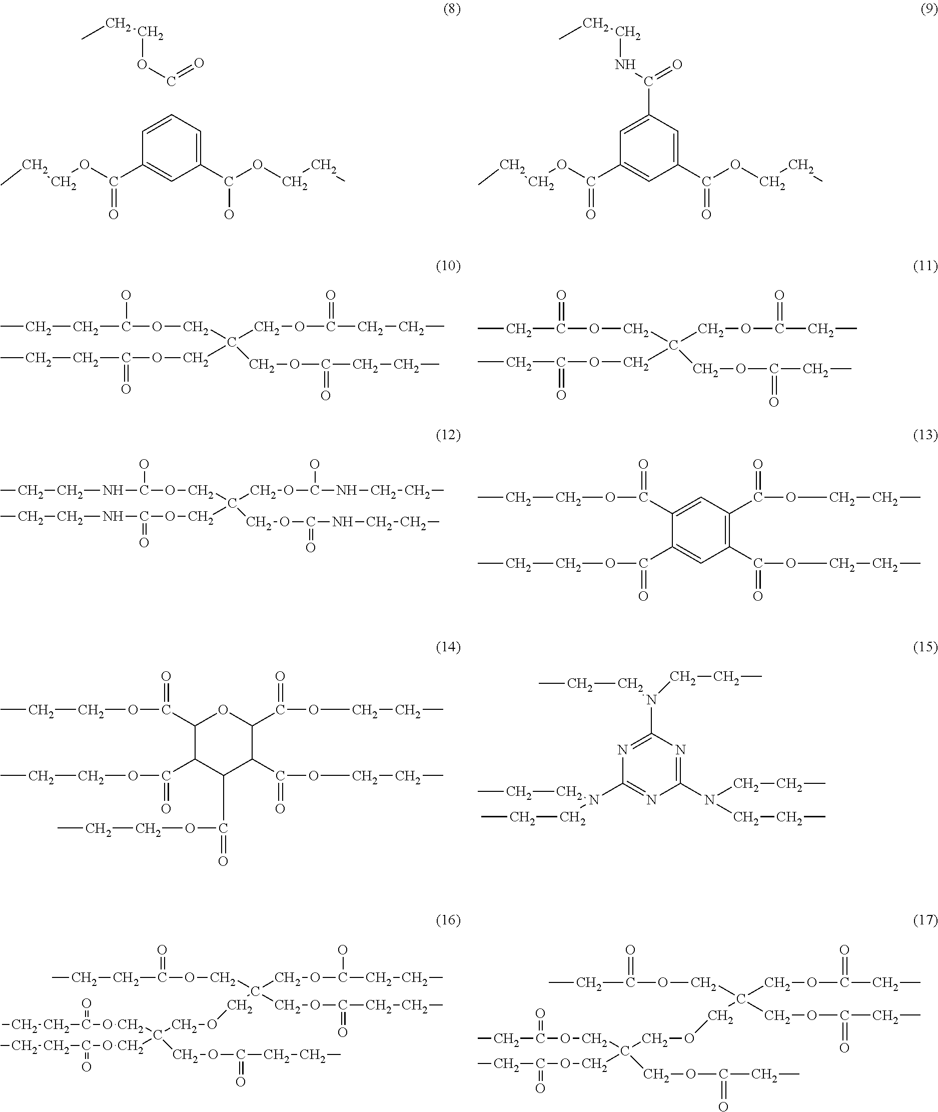

In General Formula (1), R¹ and R² each independently represent a single bond or a divalent group. P pieces of R¹'s may be the same or different from each other, and in a case where q is 2 or more, q pieces of R²'s may be the same or different from each other.

In a case where R¹ represents a divalent group, this group may be an inorganic or organic group.

Examples of the inorganic group include the following groups or a combination of two or more thereof.

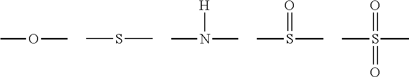

Examples of the organic group include an organic group formed of 1 to 100 carbon atoms, 0 to 10 nitrogen atoms, 0 to 50 oxygen atoms, 1 to 200 hydrogen atoms, and 0 to 20 sulfur atoms. Such an organic group may be unsubstituted or may further have a substituent.

Specific examples of the organic group represented by R¹ include an organic group formed of the following structural unit or a combination of two or more of the following structural units. Such an organic group may be unsubstituted or may further have a substituent.

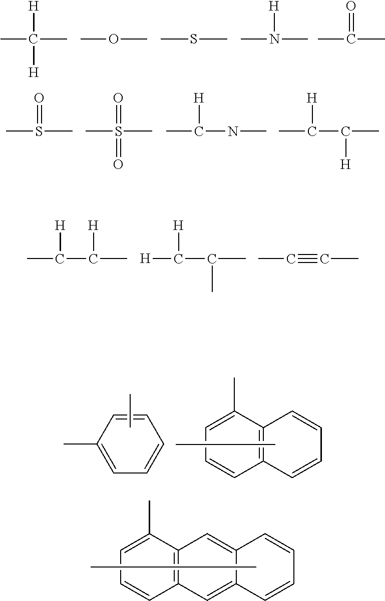

As R¹, a single bond or a divalent organic group formed of 1 to 50 carbon atoms, 0 to 8 nitrogen atoms, 0 to 25 oxygen atoms, 1 to 100 hydrogen atoms, and 0 to 10 sulfur atoms is preferable, a single bond or a divalent organic group formed of 1 to 30 carbon atoms, 0 to 6 nitrogen atoms, 0 to 15 oxygen atoms, 1 to 50 hydrogen atoms, and 0 to 7 sulfur atoms is more preferable, and a single bond or a divalent organic group formed of 1 to 10 carbon atoms, 0 to 5 nitrogen atoms, 0 to 10 oxygen atoms, 1 to 30 hydrogen atoms, and 0 to 5 sulfur atoms is still more preferable. Such an organic group may be unsubstituted or may further have a substituent.

R² represents a single bond or a divalent group. The details of R² are as described for R¹. In an aspect, it is preferable that R² is a divalent inorganic group. For such an inorganic group, the above description regarding R¹ can be referenced.

A¹ represents a monovalent group containing one or more groups selected from the group consisting of an acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group. An acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group can function as an adsorption group. p pieces of A¹'s may be the same or different from each other. In the group represented by A¹, the total number of groups selected from the group consisting of an acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group is 1 or more, and may be, for example, 5 or less, 4 or less, 3 or less, or 2 or less.

In the present invention and the specification, the “acidic group” refers to a group having a pKa at 25° C. of 6 or less. Examples of the acidic group include a carboxy group, a sulfonic acid group, a monosulfuric acid ester group, a phosphoric acid group, a monophosphoric acid ester group, and a boric acid group. A carboxy group, a sulfonic acid group, a monosulfuric acid ester group, a phosphoric acid group, and a monophosphoric acid ester group are preferable, and a carboxy group, a sulfonic acid group, and a phosphoric acid group are more preferable. The carboxy group is a functional group represented by —COOH. The carboxy group may be contained in the form of —COOH or in the form of a salt in the compound represented by General Formula (1). The salt of the carboxy group is a salt represented by —COO⁻M⁺. The sulfonic acid group is a functional group represented by —S(═O)₂OH, and may be contained in the form of —S(═O)₂OH or in the form of a salt in the compound represented by General Formula (1). The salt of the sulfonic acid group is a salt represented by —S(═O)₂O⁻M⁺. The phosphoric acid group is a functional group represented by —P═O(OH)₂, and may be contained in the form of —P═O(OH)₂ or may be contained in the form of a salt in the compound represented by General Formula (1). The salt of the phosphoric acid group is a salt represented by —P═O(O⁻M⁺)₂. In the above description, M⁺ represents a cation such as an alkali metal ion. Specific examples of the monovalent group represented by A¹ containing one or more acidic groups include the following groups. In the following description, * represents a bonding position with an adjacent atom.

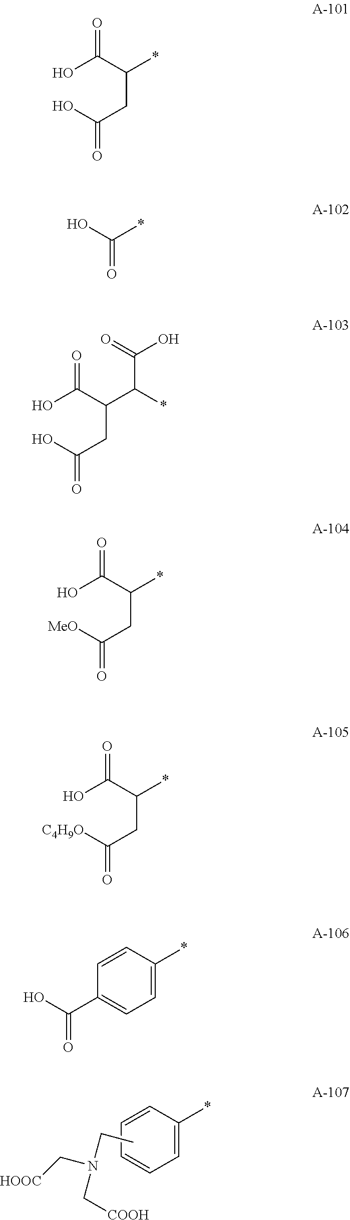

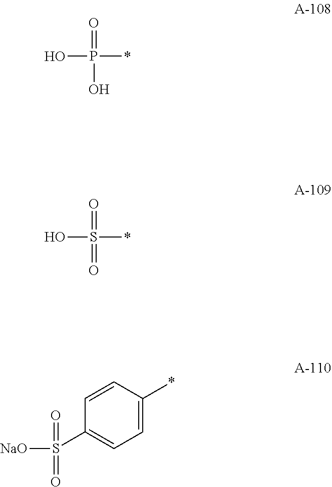

In the present invention and the specification, the “basic group” refers to a group having a pKa of a conjugate acid of 4 or more at 25° C. Examples of the basic group having a nitrogen atom include an amino group (—NH₂), a substituted imino group (—NHR⁸, —NR⁹R¹⁰, where R⁸, R⁹, and R¹⁰ each independently represent an alkyl group having 1 to 20 carbon atoms, an aryl group having 6 or more carbon atoms, or an aralkyl group having 7 or more carbon atoms), a guanidyl group represented by the following Formula (a1), and an amidinyl group represented by the following Formula (a2).

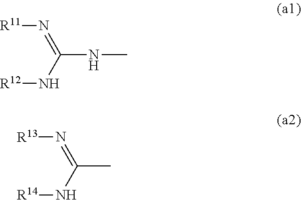

In Formula (a1), R¹¹ and R¹² each independently represent an alkyl group having 1 to 20 carbon atoms, an aryl group having 6 or more carbon atoms, or an aralkyl group having 7 or more carbon atoms.

In Formula (a2), R¹³ and R¹⁴ each independently represent an alkyl group having 1 to 20 carbon atoms, an aryl group having 6 or more carbon atoms, or an aralkyl group having 7 or more carbon atoms.

Of these, an amino group (—NH₂), a substituted imino group (—NHR⁸, —NR⁹R¹⁰, where R⁸, R⁹, and R¹⁰ each independently represent an alkyl, phenyl, or benzyl group having 1 to 10 carbon atoms), a guanidyl group represented by Formula (a1) (in Formula (a1), R¹¹ and R¹² each independently represent an alkyl, phenyl, or benzyl group having 1 to 10 carbon atoms), and an amidinyl group represented by Formula (a2) (in Formula (a2), R¹³ and R¹⁴ each independently represent an alkyl, phenyl, or benzyl group having 1 to 10 carbon atoms) is preferable.

Further, an amino group (—NH₂), a substituted imino group (—NHR⁸, —NR⁹R¹⁰, where R⁸, R⁹, and R¹⁰ each independently represent an alkyl, phenyl, or benzyl group having 1 to 5 carbon atoms), a guanidyl group represented by Formula (a1) (in Formula (a1), R¹¹ and R¹² each independently represent an alkyl, phenyl, or benzyl group having 1 to 5 carbon atoms), and an amidinyl group represented by Formula (a2) (in Formula (a2), R¹³ and R¹⁴ each independently represent an alkyl, phenyl, or benzyl group having 1 to 5 carbon atoms) is preferable.

Examples of the urea group include —NR¹⁵CONR¹⁶R¹⁷ (here, R¹⁵, R¹⁶, and R¹⁷ each independently represent a hydrogen atom, an alkyl group having 1 to 20 a carbon atom, an aryl groups having 6 or more carbon atoms, or an aralkyl groups having 7 or more carbon atoms), —NR¹⁵CONHR¹⁷ (here, R¹⁵ and R¹⁷ each independently represent a hydrogen atom, an alkyl groups having 1 to 10 carbon atoms, an aryl group having 6 or more carbon atoms, or an aralkyl groups having 7 or more carbon atoms) is preferable, and —NHCONHR¹⁷ (here, R¹⁷ represents a hydrogen atom, an alkyl group having 1 to 10 carbon atoms, an aryl group having 6 or more carbon atoms, or an aralkyl group having 7 or more carbon atoms) is more preferable.

Examples of the urethane group include —NHCOOR¹⁸, —NR¹⁹COOR²⁰, —OCONHR²¹, —OCONR²²R²³ (here, R¹⁸, R¹⁹, R²⁰, R²¹, R²², and R²³ each independently represent an alkyl group having 1 to 20 carbon atoms, an aryl group having 6 or more carbon atoms, or an aralkyl group having 7 or more carbon atoms). Of these, —NHCOOR¹⁸, —OCONHR²¹ (here, R¹⁸ and R²¹ each independently represent an alkyl group having 1 to 20 carbon atoms, an aryl group having 6 or more carbon atoms, or an aralkyl group having 7 or more carbon atoms) or the like is preferable, and —NHCOOR¹⁸, —OCONHR²¹ (here, R¹⁸ and R²¹ each independently represent an alkyl group having 1 to 10 carbon atoms, an aryl group having 6 or more carbon atoms, or an aralkyl group having 7 or more carbon atoms) or the like is more preferable.

Examples of the group having a coordinating oxygen atom include an acetylacetonate group and an acetoacetyl group. An acetylacetonate group and an acetoacetyl group are each a monovalent group having the following structure. In the structure below, * represents a bonding position with an adjacent atom.

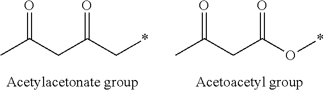

Examples of the hydrocarbon group having 4 or more carbon atoms include an alkyl group having 4 or more carbon atoms, an aryl group having 6 or more carbon atoms, and an aralkyl group having 7 or more carbon atoms. An alkyl group having 4 to 20 carbon atoms, an aryl group having 6 to 20 carbon atoms, and an aralkyl group having 7 to 20 carbon atoms are preferable, and an alkyl group having 4 to 15 carbon atoms (for example, an octyl group and a dodecyl group), an aryl group having 6 to 15 carbon atoms (for example, a phenyl group and a naphthyl group), and an aralkyl group having 7 to 15 carbon atoms (for example, a benzyl group) are more preferable.

Examples of the alkoxysilyl group include a trimethoxysilyl group and a triethoxysilyl group.

In an aspect, the group represented by A¹ may be a monovalent organic group in which one or more groups selected from the group consisting of an acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group, are bonded to an organic group (hereinafter, also referred to as a “linking group”) formed of 1 to 200 carbon atoms, 0 to 20 nitrogen atoms, 0 to 100 oxygen atoms, 1 to 400 hydrogen atoms, and 0 to 40 sulfur atoms. The organic group exemplified as the linking group may be unsubstituted or may further have a substituent. In addition, in an aspect, the group represented by A¹ may be a group selected from the group consisting of an acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group.

It is preferable that the linking group is an organic group formed of 1 to 100 carbon atoms, 0 to 10 nitrogen atoms, 0 to 50 oxygen atoms, 1 to 200 hydrogen atoms, and 0 to 20 sulfur atoms. Such an organic group may be unsubstituted or may further have a substituent.

Specific examples of the organic group exemplified as the linking group include an organic group formed of the following structural unit or a combination of two or more of the following structural units. Such an organic group may be unsubstituted or may further have a substituent.

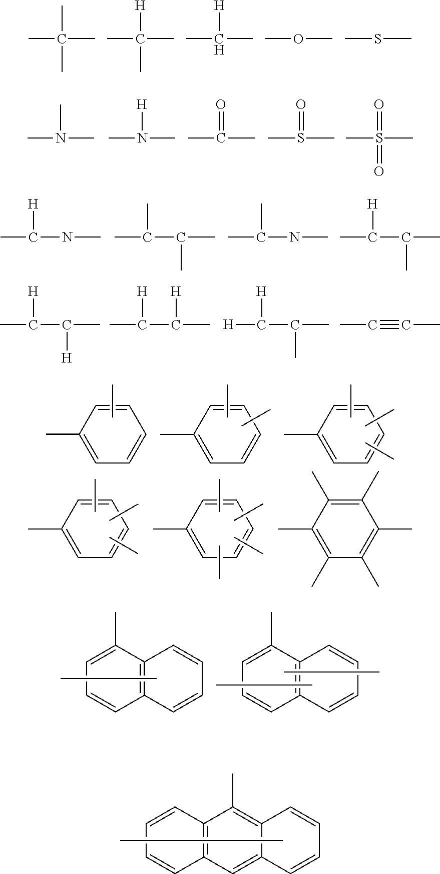

Examples of A¹ include a monovalent organic group represented by the following General Formula (3).

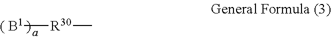

In General Formula (3), B¹ represents a group selected from the group consisting of an acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group, and R³⁰ represents a single bond or an (a+1)-valent organic group. a represents an integer in a range of 1 to 10, and in a case where a is 2 or more, a pieces of B's may be the same or different from each other.

The details of the group represented by B¹ are as described above regarding A¹.

R³⁰ represents a single bond or an (a+1)-valent organic group, and a represents an integer in a range of 1 to 10. a is preferably an integer in a range of 1 to 7, more preferably an integer in a range of 1 to 5, still more preferably an integer in a range of 1 to 3, and even still more preferably 1 or 2.

Examples of the (a+1)-valent organic group include an organic group formed of 1 to 100 carbon atoms, 0 to 10 nitrogen atoms, 0 to 50 oxygen atoms, 1 to 200 hydrogen atoms, and 0 to 20 sulfur atoms. Such an organic group may be unsubstituted or may further have a substituent.

Examples of the (a+1)-valent organic group include an organic group (in which a ring structure may be formed) including one of the following structural units or a combination of two or more of the following structural units. Such an organic group may be unsubstituted or may further have a substituent.

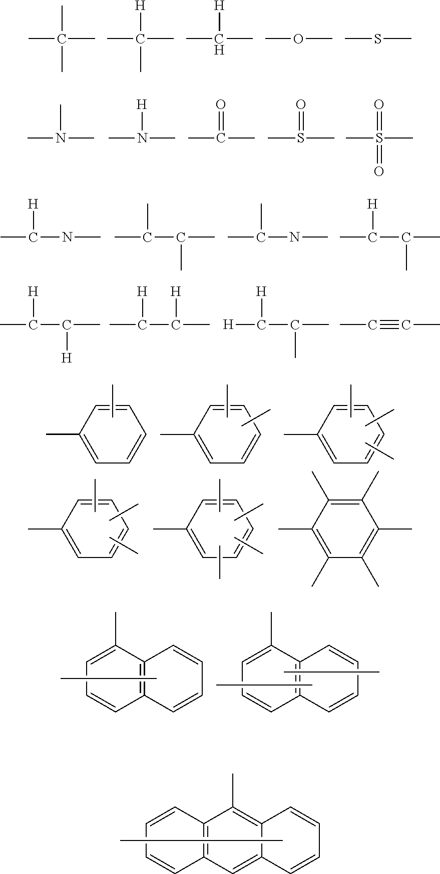

As R³⁰, a single bond or an (a+1)-valent organic group formed of 1 to 50 carbon atoms, 0 to 8 nitrogen atoms, 0 to 25 oxygen atoms, 1 to 100 hydrogen atoms, and 0 to 10 sulfur atoms is preferable, a single bond or an (a+1)-valent organic group formed of 1 to 30 carbon atoms, 0 to 6 nitrogen atoms, 0 to 15 oxygen atoms, 1 to 50 hydrogen atoms, and 0 to 7 sulfur atoms is more preferable, and a single bond or an (a+1)-valent organic group formed of 1 to 10 carbon atoms, 0 to 5 nitrogen atoms, 0 to 10 oxygen atoms, 1 to 30 hydrogen atoms, and 0 to 5 sulfur atoms is still more preferable. Such an organic group may be unsubstituted or may further have a substituent.

In General Formula (1), P¹ represents a polymer structure having an I/O value of 0.250 or more and 1.650 or less. In a case where q is 2 or more, q pieces of P¹'s may be the same or different from each other.

### (I/O Value)

The “I/O value” is a value obtained by separating the properties of a compound into the organic value (O value) and the inorganic value (I value) and dividing the I value by the O value. In the present invention and the specification, the “I/O value” is a value obtained by a method described in “New Edition Organic Conceptual Diagram, pp. 13-20, Sankyo Shuppan Co., Ltd. (2008)”. The I/O value shown in examples which will be described later is a value thus obtained.

Hereinafter, a structure in which a plurality of one kind of repeating units are linked is referred to as a “homopolymer structure”, and a structure including two or more different homopolymer structures is referred to as a “copolymer structure”. The “polymer structure” in the present invention and the specification includes a homopolymer structure and a copolymer structure.

The I/O value of the polymer structure represented by P¹ is 0.250 or more and 1.650 or less. The inventors of the present invention considers that the I/O value of P¹ in the above-described range contributes to high solubility of the compound represented by General Formula (1) in the polymerizable composition, improvement in dispersibility, and improvement in luminance of a wavelength conversion member including a cured product obtained by curing the composition. The I/O value is preferably 0.300 or more, more preferably 0.400 or more, and still more preferably 0.500 or more from the viewpoint of further improving solubility.

Meanwhile, in an aspect, regarding a component added to a polymerizable composition including quantum dots, it is preferable that the light emission performance of a cured product obtained by curing the polymerizable composition does not significantly change depending on the presence or absence of the component. As an example of the change in light emission performance, a shift in the position of the light emission center wavelength (hereinafter, referred to as “wavelength shift”) can be mentioned. The suppression of the wavelength shift is also preferable from the viewpoint of further improvement in luminance. From the viewpoint of suppressing a wavelength shift and/or from the viewpoint of further improving solubility, the I/O value is preferably 1.600 or less, and more preferably 1.500 or less, 1.400 or less, 1.300 or less, 1.200 or less, 1.100 or less, 1.000 or less, 0.900 or less, 0.800 or less, 0.700 or less, or 0.600 or less in this order.

In an aspect, the polymer structure represented by P¹ may include a vinyl polymer chain. In the present invention and the specification, the “vinyl polymer chain” is a polymer chain including a plurality of repeating units represented by the following General Formula (4). In General Formula (4), R⁴⁰ to R⁴³ each independently represent a hydrogen atom or a substituent. For specific examples of the substituent, the following description regarding General Formula (4-1) can be referenced. * represents a bonding position with an adjacent atom. The same applies to other general formulas. The vinyl polymer chain includes a vinyl polymer chain containing only a homopolymer structure in which a plurality of the same repeating units are linked, and a vinyl polymer chain containing two or more different homopolymer structures.

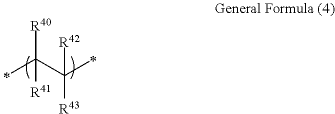

Specific examples of the repeating unit represented by General Formula (4) include a repeating unit represented by the following General Formula (4-1). The repeating unit represented by General Formula (4-1) is a repeating unit in which R⁴⁰ and R⁴¹ in General Formula (4) represent a hydrogen atom, R⁴² represent a hydrogen atom or a methyl group, and R⁴³ are a partial structure represented by “—X²—O—R⁴⁴”.

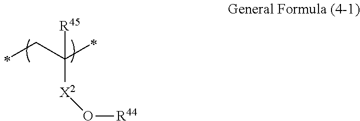

In General Formula (4-1), R⁴⁵ represents a hydrogen atom or a methyl group. X² represents a divalent organic group, and examples thereof include a carbonyl group (—C(═O)—).

In General Formula (4-1), R⁴⁴ represents a substituent. Specific examples of the substituent include “—(Y¹—O)ₙ₁—X¹” in the following General Formula (4-3), an alkyl group (for example, a linear or branched alkyl group having 2 to 10 carbon atoms), an alicyclic group, a heterocyclic group, and a monovalent group represented by -L¹-Q (here, L¹ represents a divalent group such as an alkylene group (for example, an alkylene group having 1 to 5 carbon atoms), and Q represents an alicyclic group or a heterocyclic group). Specific examples of the groups exemplified above include groups contained in compounds shown in examples described later. In addition, the groups exemplified above may be unsubstituted or may further have a substituent.

Specific examples of the repeating unit represented by General Formula (4) include a repeating unit represented by General Formula (4-2). The repeating unit represented by General Formula (4-2) is a repeating unit in which X² in General Formula (4-1) is a carbonyl group. In General Formula (4-2), R⁴⁴ and R⁴⁵ are each as defined in General Formula (4-1).

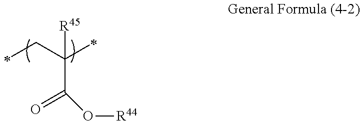

Specific examples of the repeating unit represented by General Formula (4) include a repeating unit represented by General Formula (4-3).

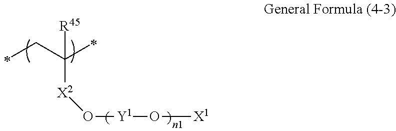

In General Formula (4-3), R⁴⁵ represents a hydrogen atom or a methyl group, X² represents a divalent organic group, and the details are as described above for X² in General Formula (4-1). X¹ represents a hydrogen atom or a monovalent organic group, Y¹ represents a divalent organic group, X¹ and Y¹ may form a ring, and n1 is 1 or more.

In General Formula (4-2), n1 is 1 or more, may be 2 or more, and may be 3 or more. Further, n1 may be, for example, 30 or less, 25 or less, 20 or less, 15 or less, or 10 or less.

In a case where X¹ represents a monovalent organic group, such an organic group may be, for example, a hydrocarbon group or may be a linear or branched alkyl group, and the number of carbon atoms of the alkyl group may be, for example, 1 or more and 15 or less, 1 or more and 10 or less, or 1 or more and 5 or less. In an aspect, X¹ may be a methyl group.

In a case where n1 is 1, X¹ preferably represents a monovalent organic group, Y¹ may represent a linear divalent hydrocarbon group or a branched divalent hydrocarbon group, and preferably represents a branched divalent hydrocarbon group, and X¹ and Y¹ may form a ring. Such a ring is preferably a ring of a 4-membered ring or more, and may be, for example, a ring of a 4-membered ring or more and a 10-membered ring or less. The linear divalent hydrocarbon group and the branched divalent hydrocarbon group are preferably alkylene groups. The number of carbon atoms of such an alkylene group may be 1 or more, preferably 2 or more, and for example, 5 or less or 4 or less.

In a case where n1 is 2 or more, Y¹ may represent a linear divalent hydrocarbon group or a branched divalent hydrocarbon group, and preferably represents a branched divalent hydrocarbon group, and X¹ and Y¹ may form a ring. Such a ring is preferably a ring of a 3-membered ring or more or a 4-membered ring or more, and may be, for example, a ring of a 4-membered ring or more and a 10-membered ring or less. The linear divalent hydrocarbon group and the branched divalent hydrocarbon group are preferably alkylene groups. The number of carbon atoms of such an alkylene group may be 1 or more, preferably 2 or more, and for example, 5 or less or 4 or less.

Specific examples of the repeating unit represented by General Formula (4) include a repeating unit represented by the following General Formula (4-4). The repeating unit represented by General Formula (4-4) is a repeating unit in which X² in General Formula (4-3) is a carbonyl group. In General Formula (4-4), R⁴⁵, X¹, Y¹, and n1 are each as defined in General Formula (4-3).

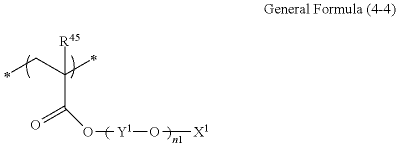

In an aspect, in General Formula (1), the polymer structure represented by P¹ may include a polyalkylene glycol chain. In the present invention and the specification, the “polyalkylene glycol chain” is a polymer chain including a plurality of repeating units represented by the following General Formula (5). The polyalkylene glycol chain includes those including only a homopolymer structure in which a plurality of the same repeating units are linked and those including two or more different homopolymer structures. In General Formula (5), R⁵⁰ represents a linear alkylene group or a branched alkylene group. The number of carbon atoms of such an alkylene group may be 1 or more, preferably 2 or more, and for example, 5 or less or 4 or less. The alkylene group may be unsubstituted or may further have a substituent. For example, “—Y¹—O—” in General Formula (4-3) and General Formula (4-4) may be a repeating unit represented by the following General Formula (5).

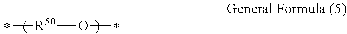

In an aspect, the polyalkylene glycol chain may be a polypropylene glycol chain. The polypropylene glycol chain may be a homopolymer structure in which a plurality of the following repeating units are linked. For example, “—Y¹—O—” in General Formula (4-3) or General Formula (4-4) may be the following repeating unit.

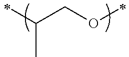

The compound represented by General Formula (1) may be preferably a compound represented by General Formula (2).

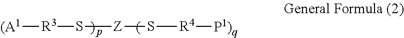

In General Formula (2), R³ and R⁴ each independently represent a single bond or a divalent group, p pieces of R³'s may be the same or different from each other, and in a case where q is 2 or more, q pieces of R⁴'s may be the same or different from each other. A¹, Z, P¹, p, and q are each as defined in General Formula (1).

With respect to A¹, Z, P¹, p, and q in General Formula (2), the above description regarding General Formula (1) can be referenced.

In a case where R³ represents a divalent group, the above description regarding R¹ in General Formula (1) can be referenced for such a divalent group except that the divalent group is linked to Z by a sulfur atom (S).

Specific examples of R³ include a single bond or a divalent organic group formed of the following structural unit or a combination of two or more of the following structural units, the group being formed of 1 to 10 carbon atoms, 0 to 5 nitrogen atoms, 0 to 10 oxygen atoms, 1 to 30 hydrogen atoms, and 0 to 5 sulfur atoms (which may have a substituent, and examples of such a substituent include: an alkyl group having 1 to 20 carbon atoms such as a methyl group or an ethyl group; an aryl group having 6 to 16 carbon atoms such as a phenyl group or a naphthyl group; a hydroxy group; an amino group; a carboxy group; a sulfonamide group; an N-sulfonylamide group; an acyloxy group having 1 to 6 carbon atoms such as an acetoxy group; an alkoxy group having 1 to 6 carbon atoms such as a methoxy group or an ethoxy group; a halogen atom such as a chlorine atom or a bromine atom; an alkoxycarbonyl group having 2 to 7 carbon atoms such as a methoxycarbonyl group, an ethoxycarbonyl group, or a cyclohexyloxycarbonyl group; a cyano group; and a carbonate ester group such as a t-butyl carbonate). In an aspect, R³ may be a linear alkylene group or a branched alkylene group. The number of carbon atoms of such an alkylene group may be 1 or more, preferably 2 or more, and for example, 5 or less or 4 or less.

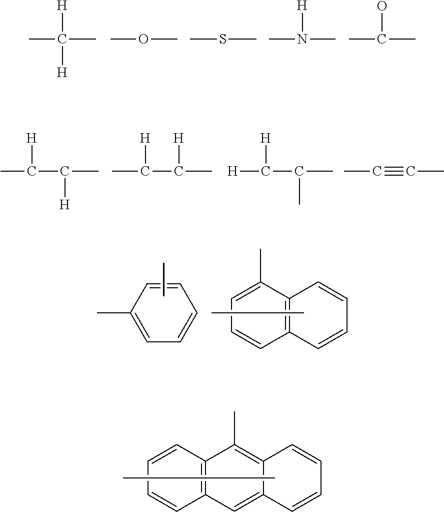

In General Formula (2), in a case where R⁴ represents a divalent group, the above description regarding R² in General Formula (1) can be referenced for such a divalent group except that the divalent group is linked to Z by a sulfur atom (S).

Specific examples of R⁴ include a single bond, an ethylene group, a propylene group, the following divalent group (a), and the following divalent group (b). In the following divalent groups, R¹² represents a hydrogen atom or a methyl group, and 1 represents 1 or 2.

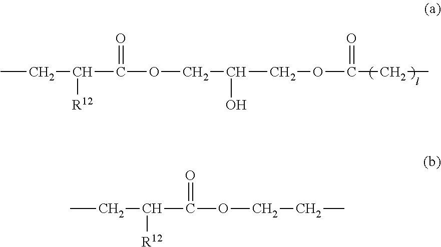

### (Weight-Average Molecular Weight)

In the present invention and the specification, the “weight-average molecular weight” is a weight-average molecular weight obtained by performing polystyrene conversion on a measurement value measured by gel permeation chromatography (GPC). As the measurement conditions of GPC, for example, the following conditions may be adopted. The weight-average molecular weight shown in examples described later is a value obtained under the following conditions. In the present invention and the specification, the molecular weight refers to a weight-average molecular weight for a polymer (including a homopolymer and a copolymer).
GPC apparatus: HLC-8120 (manufactured by Tosoh Corporation)
Column: TSK gel Multipore HXL-M (manufactured by Tosoh Corporation, 7.8 mmID (inner diameter)×30.0 cm)

The weight-average molecular weight of the compound represented by General Formula (1) may be, for example, 3,000 or more, and from the viewpoint of further improving dispersibility, it is preferably 4,000 or more, and more preferably 5,000 or more. The weight-average molecular weight of the compound represented by General Formula (1) may be, for example, 20,000 or less, 19,000 or less, or 18,000 or less, and from the viewpoint of suppressing wavelength shift, it is preferably 17,000 or less, more preferably 16,000 or less, still more preferably 15,000 or less, and even still more preferably 14,000 or less.

### (Melting Point)

In the present invention and the specification, the “melting point” is a transition temperature from a solid to a liquid obtained by observation with a polarization microscope while heating at a heating rate of 10° C./min. The melting point of a material that is liquid at room temperature is less than 25° C. Here, the “a material that is liquid at room temperature” refers to a material that is liquid in an environment with an atmospheric temperature of 25° C.

The melting point of the compound represented by General Formula (1) may be, for example, 90° C. or lower, 80° C. or lower, 70° C. or lower, 60° C. or lower, 50° C. or lower, or 40° C. or lower, and from the viewpoint of further improving the solubility, it is preferably 30° C. or lower, more preferably 25° C. or lower, and still more preferably lower than 25° C.

### (Acid Value)

In the present invention and the specification, the “acid value” is the number in mg of potassium hydroxide required to neutralize the sample 1 g, and is a value measured according to JIS K 2501:2003.

From the viewpoint of further improving dispersibility, the acid value of the compound represented by General Formula (1) is preferably 5 mgKOH/g or more, and more preferably 10 mgKOH/g or more. On the other hand, from the viewpoint of further improving solubility, the acid value of the compound represented by General Formula (1) is preferably 100 mgKOH/g or less, and more preferably 90 mgKOH/g or less.

### (Synthesis Method)

A synthesis method for the compound represented by General Formula (1) is not particularly limited, and a known method may be adopted. For the synthesis method, for example, paragraphs [0114] to [0140] of JP2007-277514A (paragraphs [0145] to [0173] in the corresponding US2010/233595A) and paragraphs [0266] to [0348] of JP2007-277514A (paragraphs [0289] to [0429] in the corresponding US2010/233595A) can be referenced.

From the viewpoint of further improving the dispersibility, the content of the compound represented by General Formula (1) in the polymerizable composition is preferably 0.01 mass % or more and more preferably 0.05 mass % or more with respect to the total amount of the composition. From the viewpoint of improving the luminance, the content of the compound represented by General Formula (1) is preferably 5 mass % or less and more preferably 2 mass % or less with respect to the total amount of the composition.

### <Polymerizable Compound>

The polymerizable composition contains one kind or two or more kinds of polymerizable compounds containing one or more polymerizable groups selected from the group consisting of a (meth)acryloyl group and a (meth)allyl group in one molecule. Among a (meth)acryloyl group and a (meth)allyl group, such a polymerizable compound may include only a (meth)acryloyl group; may include only a (meth)allyl group; or may include a (meth)acryloyl group and a (meth)allyl group.

### ((Meth)Acrylate)

### First (Meth)Acrylate

In a case where the polymerizable composition contains one or more kinds of (meth)acrylates, at least a polyfunctional (meth)acrylate is preferably contained as the (meth)acrylate. The polyfunctional (meth)acrylate is also referred to as “first (meth)acrylate”. Here, a polyfunctional (meth)acrylate corresponding to a second (meth)acrylate described below is interpreted as the second (meth)acrylate. The polyfunctional (meth)acrylate that may be contained in the polymerizable composition is one kind or two or more kinds of di- or higher functional (meth)acrylates, and may be one kind or two or more kinds selected from the group consisting of difunctional to octafunctional, difunctional to heptafunctional, difunctional to hexafunctional, difunctional to pentafunctional, or difunctional to tetrafunctional polyfunctional (meth)acrylates.

Specific examples of the bifunctional (meth)acrylate include neopentyl glycol di(meth)acrylate, 1,9-nonanedioldi(meth)acrylate, dipropylene glycol di(meth)acrylate, tripropylene glycol di(meth)acrylate, tetraethylene glycol di(meth)acrylate, hydroxypivalic acid neopentyl glycol di(meth)acrylate, polyethylene glycol di(meth)acrylate, dicyclopentenyl (meth)acrylate, dicyclopentenyloxyethyl (meth)acrylate, dicyclopentanyl di(meth)acrylate, and tricyclodecanedimethanol di(meth)acrylate.

Specific examples of the tri- or higher functional (meth)acrylate include epichlorohydrin (ECH)-modified glycerol tri(meth)acrylate, ethylene oxide (EO)-modified glycerol tri(meth)acrylate, propylene oxide (PO)-modified glycerol tri(meth)acrylate, trimethylolpropane tri(meth)acrylate, pentaerythritol tetra(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, caprolactone-modified dipentaerythritol hexa(meth)acrylate, and dipentaerythritol poly(meth)acrylate.

The molecular weight of the polyfunctional (meth)acrylate included as the first (meth)acrylate in the polymerizable composition may be, for example, 200 or more. From the viewpoint of the viscosity of the polymerizable composition, the molecular weight of the polyfunctional (meth)acrylate is preferably 1,000 or less and more preferably 500 or less.

In the polymerizable composition, from the viewpoint of suppressing a decrease in luminance, that is, improving durability, the content of the first (meth)acrylate is preferably 10.0 mass % or more, more preferably 20.0 mass % or more, and still more preferably 30.0 mass % or more with respect to the total amount of the composition. The polymerizable composition may contain only one kind of (meth)acrylate that is the first (meth)acrylate, or may include two or more kinds thereof.

### Second (Meth)Acrylate

Examples of the (meth)acrylate that may be contained in the polymerizable composition include a mono- or higher functional (meth)acrylate having a functional group selected from the group consisting of a carboxy group, a hydroxy group, a phosphoric acid group, and an amino group. Such a (meth)acrylate is also referred to as “second (meth) acrylate”. It is presumed that the inclusion of the second (meth)acrylate in the polymerizable composition contributes to the improvement in luminance of a wavelength conversion member including a cured product obtained by curing the polymerizable composition. The inventors of the present invention presume that acetic acid can also contribute to the improvement in luminance.

The second (meth)acrylate has one or more functional groups selected from the group consisting of a carboxy group, a hydroxy group, a phosphoric acid group, and an amino group in one molecule. In one molecule, the number of such functional groups may be 1 to 3, preferably 1 or 2, and more preferably 1. In a case where the second (meth)acrylate includes two or more of the functional groups in one molecule, these two or more functional groups may be the same functional groups or different functional groups. The carboxy group may be contained in the form of —COOH or in the form of a salt. The salt of the carboxy group is a salt represented by —COO⁻M⁺. The phosphoric acid group is a monovalent functional group represented by —P═O(OH)₂, and it may be contained in the form of —P═O(OH)₂ or in the form of a salt. The salt of the phosphoric acid group is a salt represented by —P═O(O⁻M⁺)₂. In the above description, M⁺ represents a cation such as an alkali metal ion. The amino group may be any of a primary amino group, a secondary amino group, or a tertiary amino group. From the viewpoint of further improving the luminance, as the functional group, a carboxy group, a hydroxy group, and a phosphoric acid group are preferable, and a carboxy group is more preferable.

The second (meth)acrylate is a mono- or higher functional (meth)acrylate. From the viewpoint of further improving the luminance, as the second (meth)acrylate, a monofunctional, bifunctional, or trifunctional (meth)acrylate is preferable, a monofunctional or bifunctional (meth)acrylate is more preferable, and a monofunctional (meth)acrylate is still more preferable. The monofunctional (meth)acrylate may be represented by, for example, Formula: A-L-X. In this formula, A represents any of the above-described functional groups, L represents a divalent linking group, and X represents a (meth)acryloyl group or a (meth)acryloyloxy group. The divalent linking group represented by L may be, for example, one or a combination of two or three or more of divalent groups selected from the group consisting of an alkylene group, a cycloalkylene group, and an ester group (—O—C(═O)—). Examples of the alkylene group include a linear or branched alkylene group having 1 to 3 carbon atoms (for example, a methylene group, an ethylene group, and a propylene group). Examples of the cycloalkylene group include a cycloalkylene group having 5 to 8 carbon atoms (for example, a cyclopentylene group, a cyclohexylene group, a cycloheptylene group, and a cyclooctylene group). The alkylene group may or may not have a substituent, and is preferably an unsubstituted alkylene group. The same applies to the cycloalkylene group. An example of the monofunctional (meth)acrylate having a carboxy group is acrylic acid. Acrylic acid is a carboxylic acid, represented by CH₂═CHCOOH, in which the carbonyl group (—C(═O)—) is both part of a carboxy group and part of an acryloyl group.

Specific examples of the second (meth)acrylate include carboxy group-containing (meth)acrylates such as acrylic acid, β-carboxyethyl acrylate, 2-acryloyloxyethyl-succinic acid, and 2-acryloyloxyethylhexahydrophthalic acid; phosphate group-containing (meth)acrylates such as 2-acryloyloxyethyl acid phosphate; and hydroxy group-containing (meth)acrylates such as 2-hydroxyethyl acrylate.

The molecular weight of the (meth)acrylate contained as the second (meth)acrylate in the polymerizable composition may be, for example, 50 or more, and from the viewpoint of further improving durability, it is preferably 70 or more and more preferably 100 or more. From the viewpoint of further improving the luminance, the molecular weight of the (meth)acrylate included as the second (meth)acrylate in the polymerizable composition is preferably 500 or less, more preferably 400 or less, still more preferably 300 or less, and even still more preferably 200 or less.

In the polymerizable composition, from the viewpoint of further improving the luminance, the content of the second (meth)acrylate is preferably 0.5 mass % or more and more preferably 3.0 mass % or more with respect to the total amount of the composition. The content of the second (meth)acrylate is preferably 20.0 mass % or less with respect to the total amount of the composition from the viewpoint of further improving durability. The polymerizable composition may contain only one kind of (meth)acrylate that is the second (meth)acrylate, or may include two or more kinds thereof.

### ((Meth)Allyl Compound)

In a case where the polymerizable composition includes one or more (meth)allyl compounds, the (meth)allyl compound may be a monofunctional (meth)allyl compound or a polyfunctional (meth)allyl compound, and it preferably includes at least a polyfunctional (meth)allyl compound. As the (meth)allyl compound, one kind may be used alone, two or more kinds may be used in combination, or one or more kinds of monofunctional (meth)allyl compounds and one or more kinds of polyfunctional (meth)allyl compounds may be used in combination.

Specific examples of the monofunctional (meth)allyl compound include (meth)allyl acetate, (meth)allyl n-propionate, (meth)allyl benzoate, (meth)allyl phenyl acetate, (meth)allyl phenoxy acetate, (meth)allyl methyl ether, and (meth)allyl glycidyl ether.

The functional number of the polyfunctional (meth)allyl compound is two or more and may be, for example, two, three, or four.

Specific examples of the polyfunctional (meth)allyl compound include di(meth)allyl benzenedicarboxylate, di(meth)allyl cyclohexanedicarboxylate, di(meth)allyl maleate, di(meth)allyl adipate, di(meth)allyl phthalate, di(meth)allyl isophthalate, di(meth)allyl terephthalate, glycerol di(meth)allyl ether, trimethylolpropane di(meth)allyl ether, pentaerythritol di(meth)allyl ether, 1,3-di(meth)allyl-5-glycidyl isocyanurate, tri(meth)allyl cyanurate, tri(meth)allyl isocyanurate, tri(meth)allyl trimellitate, tetra(meth)allyl pyromellitate, 1,3,4,6-tetra(meth)allyl glycoluril, 1,3,4,6-tetra(meth)allyl-3a-methylglycoluril, and 1,3,4,6-tetra(meth)allyl-3a,6a-dimethylglycoluril. Examples of a preferred (meth)allyl compound include one or more selected from the group consisting of tri(meth)allyl cyanurate, tri(meth)allyl isocyanurate, di(meth)allyl phthalate, di(meth)allyl isophthalate, di(meth)allyl terephthalate, and di(meth)allyl cyclohexane dicarboxylate, and tri(meth)allyl isocyanurate is more preferable.

In the polymerizable composition, from the viewpoint of suppressing a decrease in luminance, that is, improving durability, the content of the (meth)allyl compound is preferably 10.0 mass % or more, more preferably 20.0 mass % or more, and still more preferably 30.0 mass % or more with respect to the total amount of the composition.

### <Optionally Contained Component>

The polymerizable composition may optionally contain one or more components in addition to the components described above. Specific examples of the component that may be optionally contained include a polymerization initiator, a polymer, a viscosity adjuster, a silane coupling agent, a surfactant, an antioxidant, an oxygen getter, and light scattering particles. For details of specific examples and the like of the additive, for example, paragraphs [0108] to [0137], paragraphs [0162] and [0163], and paragraphs [0165] to [0169] of WO2018/186300A can be referenced. The polymerizable composition does not have to contain a solvent, but may contain one or more kinds of solvents as necessary. The kind and addition amount of the solvent are not limited. For example, one or more organic solvents may be used as the solvent.

In addition, examples of the component that may be optionally contained in the polymerizable composition include the following components.

### (Monofunctional (Meth)Acrylate)

The polymerizable composition may optionally contain one or more kinds of monofunctional (meth)acrylates as, for example, a diluent, in addition to the above-described components. Such a monofunctional (meth)acrylate does not include a monofunctional (meth)acrylate having the functional group described above contained in the second (meth)acrylate. Examples of the monofunctional (meth)acrylate that may be optionally contained include isobornyl (meth)acrylate, cyclohexyl (meth)acrylate, dicyclopentanyl (meth)acrylate, and lauryl (meth)acrylate.

The content of the monofunctional (meth)acrylate may be 0 mass %, or may be 0 mass % or more or more than 0 mass % with respect to the total composition amount of the polymerizable composition. In a case where the monofunctional (meth)acrylate is contained in the polymerizable composition, the content thereof is preferably 50.0 mass % or less with respect to the total amount of the polymerizable composition from the viewpoint of further improving durability.

### (Polyfunctional Thiol)

The polymerizable composition may optionally contain one or more polyfunctional thiols. In the present invention and the specification, the “polyfunctional thiol” is a compound having two or more thiol groups in one molecule. The functional number of thiol refers to the number of thiol groups included in one molecule of thiol. The polyfunctional thiol that may be contained in the polymerizable composition is a di- or higher functional thiol and preferably a tri- or higher functional thiol. The polyfunctional thiol may be, for example, a thiol having 8 or less functional groups, 7 or less functional groups, 6 or less functional groups, 5 or less functional groups, or 4 or less functional groups. From the viewpoint of further improving durability, the polyfunctional thiol is preferably one kind or two or more kinds selected from the group consisting of bifunctional to hexafunctional polyfunctional thiols, more preferably one kind or two or more kinds selected from the group consisting of bifunctional to tetrafunctional polyfunctional thiols, still more preferably one kind or two or more kinds selected from the group consisting of trifunctional or tetrafunctional polyfunctional thiols, and even still more preferably a trifunctional thiol.

Specific examples of the polyfunctional thiol include ethylene bis(thioglycolate), diethylene glycol bis(3-mercaptopropionate), tetraethylene glycol bis(3-mercaptopropionate), 1,2-propylene glycol bis(3-mercaptopropionate), diethylene glycol bis(3-mercaptobutyrate), 1,4-butanediol bis(3-mercaptopropionate), 1,4-butanediol bis(3-mercaptobutyrate), 1,8-octanediol bis(3-mercaptopropionate), 1,8-octanediol bis(3-mercaptobutyrate), hexanediol bisthioglycolate, trimethylolpropane tris(3-mercaptopropionate), trimethylolpropane tris(3-mercaptobutyrate), trimethylolpropane tris(3-mercaptoisobutyrate), trimethylolpropane tris(2-mercaptoisobutyrate), trimethylolpropane tristhioglycolate, trimethylolpropane tris(3-mercaptopropionate), tris-[(3-mercaptopropionyloxy)-ethyl]-isocyanurate, trimethylolethane tris(3-mercaptobutyrate), pentaerythritol tetrakis(3-mercaptopropionate), pentaerythritol tetrakis(3-mercaptobutyrate), pentaerythritol tetrakis(3-mercaptoisobutyrate), pentaerythritol tetrakis(2-mercaptoisobutyrate), dipentaerythritol hexakis(3-mercaptopropionate), dipentaerythritol hexakis(2-mercaptopropionate), dipentaerythritol hexakis(3-mercaptobutyrate), dipentaerythritol hexakis(3-mercaptoisobutyrate), dipentaerythritol hexakis(2-mercaptoisobutyrate), pentaerythritol tetrakisthioglycolate, dipentaerythritol hexakis thioglycolate, and dipentaerythritol hexakis(3-mercaptopropionate). As the polyfunctional thiol, a commercially available product can be used, and a compound synthesized by a well-known method may also be used. Examples of the commercially available product include a commercially available polyfunctional thiol such as Multhiol Y3 (trade name) manufactured by SC Organic Chemical Co., Ltd.

The molecular weight of the polyfunctional thiol contained in the polymerizable composition may be, for example, 200 or more, and is preferably 300 or more from the viewpoint of further improving durability. From the viewpoint of further improving the luminance, the molecular weight of the polyfunctional thiol is preferably 1,000 or less and more preferably 500 or less. Regarding the molecular weight, the molecular weight of the second (meth)acrylate is preferably equal to or lower than the molecular weight of the polyfunctional thiol, and more preferably lower than the molecular weight of the polyfunctional thiol. It is presumed that the second (meth)acrylate having a molecular weight equal to or lower than the molecular weight of the polyfunctional thiol is likely to approach the vicinity of a quantum dot even in a case where the quantum dot is coordinated to the polyfunctional thiol and is likely to be adsorbed to a portion of the surface of the quantum dot, the portion being not coated with the polyfunctional thiol. It is presumed that this can contribute to further improvement in luminance by increasing the coverage of the ligand on the surface of the quantum dot. The molecular weight ratio calculated as “molecular weight ratio (unit: %)=(molecular weight of second (meth)acrylate/molecular weight of polyfunctional thiol)×100” is preferably 100% or less, more preferably 80% or less, and still more preferably 50% or less.

In the polymerizable composition, from the viewpoint of further improving durability, the content of the polyfunctional thiol is preferably 5.0 mass % or more, more preferably 10.0 mass % or more, and still more preferably 15.0 mass % or more. In addition, from the viewpoint of further improving durability, the content of the polyfunctional thiol is preferably 40.0 mass % or less, more preferably 35.0 mass % or less, still more preferably 30.0 mass % or less, even still more preferably 25.0 mass % or less, and even still further more preferably 20.0 mass % or less with respect to the total mass of the composition. The polymerizable composition may contain only one kind of polyfunctional thiol, or may include two or more kinds thereof.

### (Phenol-Based Compound)

In an aspect, the polymerizable composition may include a phenol-based compound. The phenol-based compound can suppress a change in viscosity over time of the polymerizable composition including the compound having a (meth)acryloyl group and the polyfunctional thiol, that is, can contribute to improvement of liquid stability. This point will be further described below.

In a composition including both a compound containing a thiol group and a compound containing a (meth)acryloyl group, an increase in viscosity over time tends to easily occur due to the progress of a thiol-ene reaction. On the other hand, it is presumed that by adding a phenol-based compound to such a composition, the phenol-based compound can act as a polymerization inhibitor, and thus the increase in viscosity can be suppressed. It is considered that the phenol-based compound can also contribute to further improvement of the luminance of a wavelength conversion member including a cured product obtained by curing the polymerizable composition. Although this is merely a presumption, it is considered that the phenol-based compound may be adsorbed on the surface of the quantum dot, and this may contribute to further improvement of the luminance. However, this is merely a presumption and does not limit the present invention.

In the present invention and the specification, the term “phenol-based compound” is used as a meaning including phenol and a derivative thereof. The phenol-based compound can be represented by the following General Formula (6).

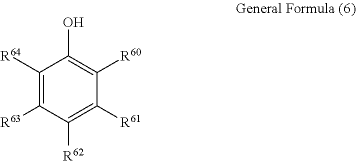

In General Formula (6), R⁶¹ to R⁶⁴ each independently represent a hydrogen atom or a substituent. Examples of the substituent include a hydroxy group, an alkyl group, and a carboxy group that may be substituted with an alkyl group.

Examples of the alkyl group include a linear or branched alkyl group having 1 to 6 carbon atoms. The alkyl group includes an unsubstituted alkyl group and an alkyl group having a substituent. In a case where a substituent is included, the number of carbon atoms refers to the number of carbon atoms of a portion excluding the substituent. Examples of the substituent that may substitute the alkyl group include a hydroxy group and a carboxy group. In an aspect, the alkyl group is preferably an unsubstituted alkyl group.

The same applies to the alkyl group that may substitute the carboxy group.

The number of hydroxy groups contained in one molecule of the phenol-based compound is preferably in a range of 1 to 3, more preferably 2 or 3, and still more preferably 3. In the phenol-based compound having a plurality of hydroxy groups, the substitution position of the hydroxy group is not limited, and the hydroxy group may be substituted at any position.

Specific examples of the phenol-based compound include pyrogallol, methyl gallate, 4-tert-butyl pyrocatechol, 2,6-di-tert-butyl-p-cresol, 4-methoxy-phenol, 2-tert-butyl-4,6-dimethylphenol, 4,4′-butylidenebis(6-tert-butyl-m-cresol), 2,6-di-tert-butylphenol, 2,2′,6,6′-tetra-tert-butyl-[1,1′-biphenyl]-4,4′-diol, and 3-(3,5-di-tert-butyl-4-hydroxyphenyl) propionic acid.

Preferred examples of the phenol-based compound include pyrogallol. From the viewpoint of further improving the luminance and/or further improving the liquid stability, the content of pyrogallol in the polymerizable composition is preferably 0.001 mass % or more, more preferably 0.003 mass % or more, and still more preferably 0.005 mass % or more with respect to the total amount of the composition. From the viewpoint of further suppressing a decrease in luminance, that is, further improving durability, the content of pyrogallol in the polymerizable composition is preferably 0.500 mass % or less, more preferably 0.300 mass % or less, and still more preferably 0.100 mass % or less with respect to the total amount of the composition.

In a case where the polymerizable composition includes a phenol-based compound, the polymerizable composition may include only one kind or two or more kinds of the phenol-based compounds. In a case where two or more kinds of phenol-based compounds are contained, for the content of each phenol-based compound, the description regarding the content of pyrogallol can be referenced.

The polymerizable composition may be prepared by mixing various components described above at the same time or sequentially in any order.

### [Cured Product and Wavelength Conversion Member]

An aspect of the present invention relates to a cured product obtained by curing the polymerizable composition.

An aspect of the present invention relates to a wavelength conversion member comprising the cured product.

The degree of curing of the cured product is not limited. The cured product may be a cured product in which the polymerization reaction of the polymerizable composition has partially progressed (typically referred to as a partially cured product, a semi-cured product, or the like), or may be a cured product in which the polymerization reaction is saturated or almost saturated (typically referred to as a fully cured product or the like).

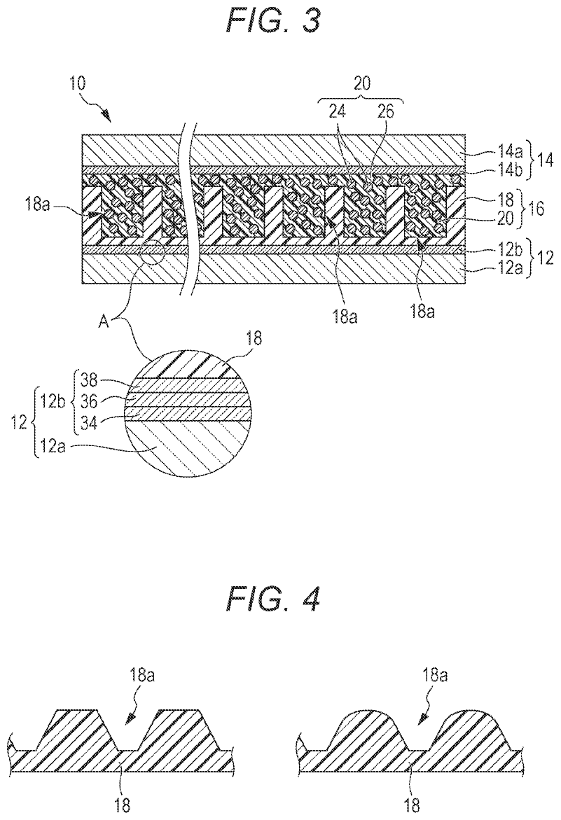

In an aspect, the wavelength conversion member may include a wavelength conversion layer that is a cured product obtained by curing the polymerizable composition into a film shape. With regard to a method for producing a wavelength conversion member having such a wavelength conversion layer, for example, paragraphs [0127] to [0155] and FIGS. 2 and 3 of WO2018/016589A can be referenced.

In an aspect, the wavelength conversion member may have a wavelength conversion layer having a resin layer having a plurality of discretely arranged recesses, and the resin layer may contain a cured product obtained by curing the polymerizable composition. Hereinafter, the wavelength conversion member of the above aspect will be described in more detail. Hereinafter, the description may be made with reference to the drawings. However, the embodiments illustrated in the drawings are examples, and the present invention is not limited to such examples.

### <Wavelength Conversion Member>

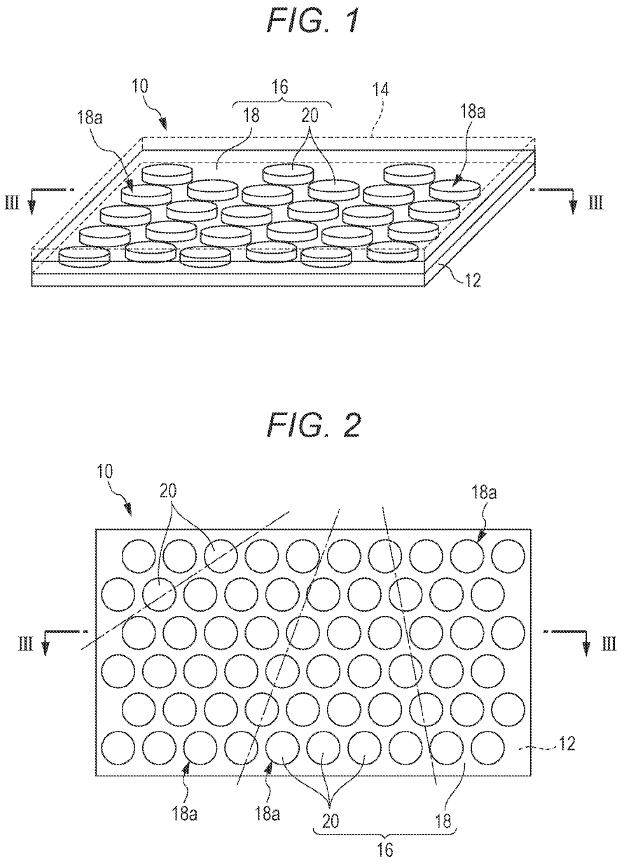

FIG. 1 is a perspective view of an example of a wavelength conversion member, FIG. 2 is a plan view of the wavelength conversion member illustrated in FIG. 1, and FIG. 3 is a cross-sectional view taken along line the III-III of FIGS. 1 and 2. The plan view of a wavelength conversion member is a view of a wavelength conversion member as viewed from a direction orthogonal to the main surface (maximum surface), and in the present specification, unless otherwise noted, the plan view is a view of a wavelength conversion member as viewed from a second base material film side.

As illustrated in FIGS. 1 to 3, a wavelength conversion member 10 has a first base material film 12, a second base material film 14, and a wavelength conversion layer 16. To clearly illustrate the configuration of the wavelength conversion member 10, the second base material film 14 is illustrated by a broken line in FIG. 1, and the second base material film 14 is omitted in FIG. 2.

As illustrated in FIG. 3, the first base material film 12 includes, for example, a support film 12a and a barrier layer 12b. The second base material film 14 also includes a support film 14a and a barrier layer 14b in the same manner.

As illustrated in FIG. 3, the wavelength conversion layer 16 includes a resin layer 18 having a recess 18a discretely formed in a plane direction (main surface direction) of the wavelength conversion member 10 (see FIG. 4), and a cured product (hereinafter, also referred to as a “quantum dot-containing part”) 20 formed by curing the polymerizable composition in the recess 18a of the resin layer 18. The quantum dot-containing part 20 includes quantum dots 24 and a matrix 26 formed through a polymerization reaction of the polymerizable compound. That is, a plurality of quantum dot-containing parts 20 including the quantum dots 24 are provided in the wavelength conversion layer 16 and the parts are separated from each other in the plane direction. Specifically, quantum dot-containing parts, which are regions including the quantum dots 24, are discretely arranged in the plane direction, and the parts are separated from each other in the plane direction by a wall forming the recess 18a of the resin layer 18.

In the present invention and the specification, the phrase “discretely arranged” more specifically means that, as illustrated in FIGS. 1 and 2, a plurality of quantum dot-containing parts 20 are disposed in isolation without contacting each other in the plane direction of the first base material film 12 as observed from a direction perpendicular to the main surface of the first base material film 12 (in plan view). In other words, the plane direction of the film is a two-dimensional direction along the film surface (main surface of the film). In the example illustrated in FIG. 1, the quantum dot-containing part has a columnar shape and is surrounded by the resin layer 18 in the plane direction of the first base material film 12, and the resin layer 18 makes it difficult for oxygen to enter the individual quantum dot-containing part from the plane direction of the first base material film 12.

It is preferable that at least the wall portion forming the recess 18a of the resin layer 18 has impermeability to oxygen, and it is more preferable that the entire region of the resin layer 18 has impermeability to oxygen. This configuration enables the wavelength conversion layer 16 to prevent deterioration of the quantum dots 24 of the quantum dot-containing part 20. In the present invention and the specification, “having impermeability to oxygen” means having an oxygen permeability of 10 cc/(m²·day·atm) or less. The oxygen permeability of the resin layer 18 having impermeability to oxygen is preferably 1 cc/(m²·day·atm) or less, and more preferably 1×10⁻¹ cc/(m²·day·atm) or less. The SI unit of the oxygen permeability is [fm/(s·Pa)]. “fm” means femtometers, and 1 fm=1×10⁻¹⁵ μm. The unit “cc/(m²·day·atm)” can be converted into the SI unit by the conversion formula “1 fm/(s·Pa)=8.752 cc/(m²·day·atm)”. In the present invention and the specification, the oxygen permeability is a value measured using an oxygen gas permeability measuring device (OX-TRAN 2/20 manufactured by MOCON Inc.) under the conditions of a measurement temperature of 23° C. and a relative humidity of 90%. In the present invention and the specification, “having impermeability” and “having barrier properties” have the same meaning. For example, in the present invention and the specification, the term “gas barrier properties” means having impermeability to gas, and the term “water vapor barrier properties” means having impermeability to water vapor. In addition, a layer having impermeability to both oxygen and water vapor is referred to as a “barrier layer”.

In the wavelength conversion layer 16, the quantum dot-containing parts 20 are discretely arranged in a two-dimensional direction. Thus, in a case where it is assumed that the wavelength conversion member 10 is a part of a long film, even in a case where the wavelength conversion member 10 is linearly cut at any place as shown by a one dot chain line in FIG. 2, the quantum dot-containing part other than the quantum dot-containing part that is the cut place can be maintained in a state of being surrounded by the resin layer 18 and sealed in the plane direction. The quantum dot-containing part that has been cut and exposed to the outside air may lose its original function as a region containing the quantum dots 24. However, since the quantum dot-containing part at the cut position, that is, the quantum dot-containing part at the end portion in the plane direction is usually covered with a member such as a frame constituting a display device (display) or the like, the quantum dot-containing part is not required to act as a region containing quantum dots, and thus, the quantum dot-containing part does not affect the performance of the wavelength conversion member. Further, the deactivated quantum dots can form a resin layer that protects a quantum dot-containing part that is not exposed to the outside air from the outside air.

In the wavelength conversion member 10, the first base material film 12 is stacked on a main surface on the bottom side of the recess 18a of the resin layer 18 of the wavelength conversion layer 16. That is, the first base material film 12 is stacked on the main surface on the closed surface (closed end) side of the recess 18a of the resin layer 18. In the illustrated example, the first base material film 12 is stacked such that the barrier layer 12b faces the resin layer 18.

On the other hand, the second base material film 14 is stacked on a main surface of the resin layer 18 constituting the wavelength conversion layer 16 on the side opposite to the first base material film 12 side. That is, the second base material film 14 is stacked on the main surface on the open surface (open end) side of the recess 18a of the resin layer 18. In the illustrated example, the second base material film 14 is stacked such that the barrier layer 14b faces the resin layer 18.

In the wavelength conversion layer, depending on the method for forming the resin layer, the resin layer may have a through-hole instead of the recess, the base material film may be used as a bottom surface, and the through-hole may be filled with the quantum dot-containing part. In this case, one base material film of two base material films sandwiching the resin layer serving as the wavelength conversion layer may be regarded as the first base material film and the other base material film may be regarded as the second base material film, the through-hole may be regarded as the recess of the resin layer, the first base material film may be regarded as a bottom of the recess of the resin layer, and the end portion of the wall portion of the resin layer 18 may be separated from the second base material film on the base material film side regarded as the second base material film as described later.

Here, in the wavelength conversion layer 16, as illustrated in FIG. 3, it is preferable that an end portion of the wall portion forming the recess 18a of the resin layer 18 on the second base material film 14 side is separated from the second base material film 14. Further, in the wavelength conversion member 10, it is preferable that the quantum dot-containing part is also present between the end portion of the wall portion of the resin layer 18 separated from the second base material film 14 on the second base material film 14 side and the second base material film 14. In the wavelength conversion member having a configuration in which the wavelength conversion layer provided by dividing the quantum dot-containing part into a plurality of regions is sealed with two base material films, a gap is provided between the wall portion dividing the quantum dot-containing part into a plurality of regions and the base material film, and the quantum dots are also present in the gap, whereby it is possible to enhance the adhesive force between the wavelength conversion layer and the base material film.

In the following description, the second base material film 14 side of the wavelength conversion member 10, that is, the opening side of the recess 18a of the resin layer 18, is referred to as “upper side”, and the first base material film 12 side, that is, the bottom side of the recess 18a of the resin layer 18, is referred to as “lower side”.

The wall portion forming the recess 18a of the resin layer 18 is, specifically, a portion between the recesses 18a of the resin layer 18 and a portion forming the outer periphery of the resin layer 18 in the plane direction of the base material film. That is, the wall portion forming the recess 18a of the resin layer 18 is, in other words, the resin layer 18 in the region between the quantum dot-containing parts in the plane direction of the wavelength conversion layer 16 and the region outside the quantum dot-containing part on the outermost side in the plane direction.

In the example illustrated in FIGS. 1 to 3, the quantum dot-containing part (quantum dot-containing part in the recess 18a) has a cylindrical shape, and the wall portion forming the recess 18a of the resin layer 18 has a rectangular cross-sectional shape. However, the present invention is not limited to this configuration, and the cross-sectional shape of the wall portion may be various shapes. For example, the wall portion forming the recess 18a of the resin layer 18 may have a trapezoidal cross-sectional shape as conceptually illustrated on the left side of FIG. 4, or may have a cross-sectional shape in which the corner portion on the upper bottom side of the trapezoid is chamfered into a curved surface shape as conceptually illustrated on the right side of FIG. 4. As illustrated in FIG. 4, it is preferable that the cross-sectional shape of the wall portion of the resin layer 18 is a shape that gradually spreads at least partially downward from the upper end, preferably from the upper end to the lower end. Here, “downward from the upper end” means from the end portion on the second base material film 14 side to the first base material film 12 side. In particular, as illustrated in the right side of FIG. 4, a shape in which the corner portion of the upper surface on the second base material film side is chamfered is preferable. Such a shape is advantageous in terms of ease of producing a mold for forming the resin layer 18, ease of removing the mold in a case where forming the resin layer 18, prevention of damage to the resin layer 18 to be formed, and the like.

In the wavelength conversion layer 16, the upper end is separated from the second base material film 14 in the wall portion forming the recess 18a of the resin layer 18. The quantum dot-containing part is also provided between the upper end of the wall portion separated from the second base material film 14 and the second base material film 14, in addition to the recess 18a of the resin layer 18. In the wavelength conversion member 10 of the illustrated example, as illustrated in FIG. 3, the quantum dot-containing part is provided between the wall portion and the second base material film 14 in such a manner that the upper ends of all the wall portion portions are separated from the second base material film 14. Having such a configuration can obtain improved adhesive force between the wavelength conversion layer 16 containing the quantum dots 24 and the second base material film on the upper side, that is, on the opening side of the recess 18a of the resin layer 18.

As will be described later, in the production of the wavelength conversion member, as an example, a coating liquid (composition for forming resin layer) to be the resin layer is filled in a mold having unevenness corresponding to the recess and the wall portion of the resin layer, the first base material film is stacked so as to cover the coating liquid filled in the mold, the coating liquid to be the resin layer is cured, and the mold is removed, whereby a stack of the first base material film and the resin layer is formed. Next, the recess of the resin layer is filled with the polymerizable composition containing quantum dots, the second base material film is stacked on the resin layer so as to seal the polymerizable composition filled in the resin layer, and then the polymerizable composition is cured to produce a wavelength conversion member in which a wavelength conversion layer having a resin layer and a quantum dot-containing part is sandwiched between the first base material film and the second base material film.

Since the coating liquid is cured after the resin layer is stacked in the state of the coating liquid, the first base material film and the resin layer can be stacked with sufficient adhesive force. In addition, since the resin layer and the quantum dot-containing part are cured after the recess is filled with the polymerizable composition, the resin layer and the quantum dot-containing part can be stacked with sufficient adhesive force. Here, regarding the wavelength conversion layer and the second base material film, since the region corresponding to the recess of the resin layer filled with the polymerizable composition including quantum dots is filled with a fluorescent material in the form of a coating liquid and cured, good adhesive force can be obtained. Further, in at least a part of the wall portion forming the recess 18a in the resin layer 18, the upper end is separated from the second base material film 14, and the quantum dot-containing part is present not only on the recess 18a but also between the upper end of the wall portion separated from the second base material film 14 and the second base material film 14, whereby the adhesive force between the wavelength conversion layer 16 and the second base material film 14 can be increased. In the present invention and the specification, not only a region immediately above the wall portion whose upper end is separated from the second base material film 14 but also a region between the recess 18a (upper end portion) of the recess adjacent to the wall portion whose upper end is separated from the second base material film 14 in the plane direction and the second base material film 14 are included between the upper end of the wall portion separated from the second base material film 14 and the second base material film 14.

In the wavelength conversion member 10, the wall portion of the resin layer 18 separated from the second base material film 14 is not limited to the configuration in which the upper end of the wall portion is separated from the second base material film 14 and the quantum dot-containing part is provided therebetween as illustrated in FIG. 3. As the number of wall portion portions of the resin layer 18 separated from the second base material film 14 increases, the adhesive force between the wavelength conversion layer 16 and the second base material film 14 can be increased. In consideration of this point, in the wavelength conversion layer 16, it is preferable that the upper end of the wall portion of a portion corresponding to an area of 30% or more of the area of a display unit of a display device in which the wavelength conversion member 10 is used is separated from the second base material film 14, and it is more preferable that the upper end of the entire wall portion is separated from the second base material film 14 and the quantum dot-containing part and the second base material film 14 are in contact with each other on the entire surface.

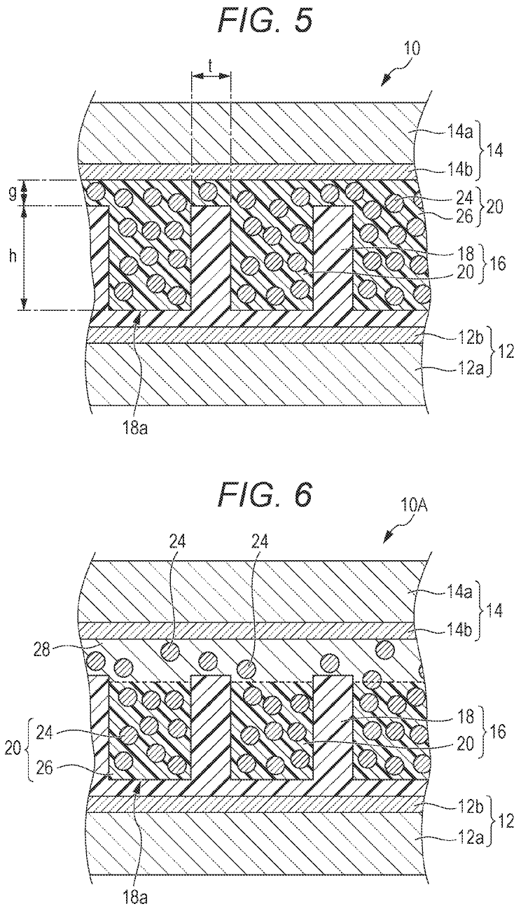

In the wavelength conversion layer 16, in the wall portion whose upper end is separated from the second base material film, a gap g (shortest distance) between the upper end (uppermost portion) of the wall portion and the second base material film 14 is not particularly limited, and both may be separated from each other (see FIG. 5). Here, the gap g between the upper end of the wall portion and the second base material film 14 is preferably 0.01 to 10 μm, more preferably 0.05 to 4 μm, and still more preferably 0.1 to 4 μm. By setting the gap g between the upper end of the wall portion and the second base material film 14 to 0.01 μm or more, the effect of the presence of the quantum dot-containing part between the upper end of the wall portion and the second base material film 14 can be sufficiently exhibited, and the adhesive force between the wavelength conversion layer 16 and the second base material film 14 can be sufficiently increased. In addition, since the quantum dot-containing part can allow oxygen to permeate more than the resin layer 18, in a case where the gap g between the upper end of the wall portion and the second base material film 14 is too large, there is a possibility that oxygen permeates the gap between the upper end of the wall portion and the second base material film 14 and the quantum dots 24 deteriorate. By setting the gap g between the upper end of the wall portion and the second base material film 14 to 10 μm or less, permeation of oxygen in the gap between the upper end of the wall portion and the second base material film 14 can be sufficiently suppressed, and deterioration of the quantum dots 24 caused by oxygen can be prevented. On the other hand, in a case where a mixed layer 28 further an impermeable layer 30 described later is provided between the upper end of the wall portion and the second base material film 14, it is possible to prevent a decrease in light emission luminance caused by an excessive thickness of the mixed layer 28 or further the impermeable layer 30 by setting the gap g between the upper end of the wall portion and the second base material film 14 to 10 μm or less. The gap g between the upper end of the wall portion and the second base material film 14 may be obtained, for example, by cutting a portion of the wall portion of the wavelength conversion member 10 with a microtome or the like to form a cross section, and observing the cross section with a scanning electron microscope (SEM) or the like. The “portion of the wall portion of the wavelength conversion member 10” is a “portion that is not the recess 18a of the wavelength conversion member 10”. The gap g can be obtained as an arithmetic average of measured values at 10 positions randomly extracted.

In the wavelength conversion layer 16, a depth h of the recess 18a of the resin layer 18 and an interval t between the adjacent quantum dot-containing parts (between the quantum dot-containing parts in the recesses 18a adjacent to each other) are not particularly limited. The depth h of the recess of the resin layer 18 is preferably a depth with which the thickness (that is, “depth h+gap g”) of the quantum dot-containing part from the bottom of the recess 18a to the second base material film 14 can be set to 1 to 100 μm. The interval t between the quantum dot-containing parts adjacent to each other is preferably 5 to 300 μm.

The thickness (which may also be referred to as the height) of the quantum dot-containing part is preferably 1 μm or more from the viewpoint of the ease of reaching the target chromaticity. On the other hand, in a case where the quantum dot-containing part becomes thick, the light absorption amount in the quantum dot-containing part increases. In consideration of these points, the thicknesses of the quantum dot-containing part from the bottom of the recess 18a to the second base material film 14 are preferably 1 to 100 μm, more preferably 5 to 80 μm, and still more preferably 10 to 50 μm. The depth h of the recess 18a formed in the resin layer 18 and the thickness of the quantum dot-containing part from the bottom of the recess 18a to the second base material film 14 may be determined by cutting a portion of the recess 18a of the wavelength conversion member 10 with a microtome to form a cross section, irradiating the wavelength conversion layer 16 with excitation light to cause the quantum dots to emit light, and in this state, observing this cross section with a confocal laser microscope or the like. As the depth h and the thickness of the quantum dot-containing part, an arithmetic average of measured values of 10 quantum dot-containing parts randomly extracted may be adopted.

In addition, it is preferable that the interval t between adjacent quantum dot-containing parts, that is, the thicknesses of the wall portion of the resin layer 18 between adjacent quantum dot-containing parts (between adjacent recesses 18a) is short (the wall portion is thin) so that the resin layer 18 cannot be visually recognized. On the other hand, from the viewpoint of strength and durability, the interval t between adjacent quantum dot-containing parts is preferably a value equal to or greater than a certain value. From these viewpoints, the interval t between adjacent quantum dot-containing parts is preferably 5 to 300 μm, more preferably 10 to 200 μm, and still more preferably 15 to 100 μm. The interval t between adjacent quantum dot-containing parts is the shortest distance between the quantum dot-containing parts adjacent to each other. The interval t can be obtained by observing the surface from one surface of the wavelength conversion member 10 using a confocal laser microscope or the like in a state where the wavelength conversion layer 16 is irradiated with excitation light to cause the quantum dots to emit light, and measuring the thickness of the wall portion of the resin layer 18 between adjacent quantum dot-containing parts. As the interval t between adjacent quantum dot-containing parts, an arithmetic average of the intervals of 20 positions randomly extracted may be adopted.

The shape, size, arrangement pattern, and the like of the quantum dot-containing part are not particularly limited and may be appropriately designed. In designing, geometric constraints for arranging the quantum dot-containing parts to be separated from each other in plan view, allowable values of the width of the non-light emitting region generated at the time of cutting, and the like can be taken into consideration. In addition, for example, as will be described later, in a case where a printing method is used as one of the methods for forming the quantum dot-containing parts, from the viewpoint of ease of printing, it is preferable that the individual occupied areas are equal to or more than a certain size. The occupied area in this case is an occupied area in a plan view. Further, from the viewpoint of improving the mechanical strength of the wavelength conversion member, it is preferable that the shortest distance between adjacent quantum dot-containing parts, that is, the thickness of the wall portion is large. In consideration of these points, the shape, size, and arrangement pattern of the quantum dot-containing parts may be designed.

The ratio between a volume Vp of the quantum dot-containing part and a volume Vb of the resin layer 18 may be any ratio. In an aspect, regarding the ratio “Vp/(Vp+Vb)”, 0.1≤Vp/(Vp+Vb)<0.9 is preferable, 0.2≤Vp/(Vp+Vb)<0.85 is more preferable, and 0.3≤Vp/(Vp+Vb)<0.8 is still more preferable. Here, the volume Vp of the quantum dot-containing part and the volume Vb of the resin layer 18 are defined as being multiplied by the respective areas and thicknesses as observed from a direction orthogonal to the main surface of the wavelength conversion member 10.

In the wavelength conversion layer, the quantum dot-containing part between the upper end of the wall portion forming the recess 18a of the second base material film 14 and between the recess 18a (upper end portion thereof) and the second base material film 14 may include a material having impermeability to oxygen in addition to the quantum dot-containing part. FIG. 6 conceptually illustrates an example thereof in a cross-sectional view of the wavelength conversion member. Since the wavelength conversion member illustrated in FIG. 6 includes the same members as those of the wavelength conversion member 10, the same members are denoted by the same reference numerals, and different parts will be mainly described. In this regard, the same applies to other drawings.

In the wavelength conversion member 10A illustrated in FIG. 6, the mixed layer 28 includes quantum dots and a material having impermeability to oxygen. In the following description, the “material having impermeability to oxygen” is also referred to as “oxygen-impermeable material”. Since the wavelength conversion member 10A has such a mixed layer 28, it is possible to prevent oxygen from being transmitted to the quantum dot-containing part between the upper end of the wall portion forming the recess 18a and the second base material film 14, and to suppress deterioration of the quantum dots 24 due to oxygen. In the present invention and the specification, the “oxygen-impermeable material” preferably refers to a material with which an oxygen permeability of a film having a thickness of 50 μm formed using this material is 200 cc/(m²·day·atm) or less. The oxygen-impermeable material is more preferably a material with which an oxygen permeability of a film having a thickness of 50 μm formed using this material is preferably 20 cc/(m²·day·atm) or less, and still more preferably a material with which the oxygen permeability of the film is 2 cc/(m²·day·atm) or less. Specific examples of the oxygen-impermeable material include various materials exemplified below as the material for forming the resin layer 18. Of these, the mixed layer 28 preferably contains a material including the same component as the material for forming the resin layer 18 as the oxygen-impermeable material.

As illustrated in FIG. 6, the mixed layer 28 is not limited to the configuration in which the mixed layer is formed between the upper end of the wall portion and the second base material film 14 and on the upper portion of the recess 18a. For example, the mixed layer 28 may be formed only between the upper end of the wall portion forming the recess 18a and the second base material film 14 without being formed on the recess 18a, or may have a configuration in which the upper side is the mixed layer 28 and the lower side is the quantum dot-containing part between the upper end of the wall portion forming the recess 18a and the second base material film 14.

The content of the oxygen-impermeable material in the mixed layer 28 is not particularly limited. As the content of the oxygen-impermeable material in the mixed layer 28 increases, deterioration of the quantum dots 24 caused by oxygen can be more prevented. On the other hand, in a case where the content of the oxygen-impermeable material in the mixed layer 28 increases, the content of the quantum dots 24 relatively decreases, and thus, the optical characteristics of the mixed layer 28, in other words, the optical characteristics of the wavelength conversion member 10A decrease. In consideration of these points, the content of the oxygen-impermeable material in the mixed layer 28 is, for example, preferably 40 to 90 mass % and more preferably 50 to 80 mass %.

The thickness of the mixed layer 28 is not particularly limited either. The content of the quantum dots 24 in the mixed layer 28 is usually lower than the content of the quantum dots 24 in the quantum dot-containing part. Thus, considering the optical characteristics of the wavelength conversion member 10A, it is preferable that the thickness (the size in the vertical direction) of the mixed layer 28 is small. On the other hand, from the viewpoint of preventing the deterioration of the quantum dot 24, it is preferable that the mixed layer 28 is thick. In consideration of these points, for example, in a case where it is important to prevent the deterioration of the quantum dots 24, it is preferable that the entire region between the upper end of the wall portion forming the recess 18a of and the second base material film 14 is formed of a mixed layer.

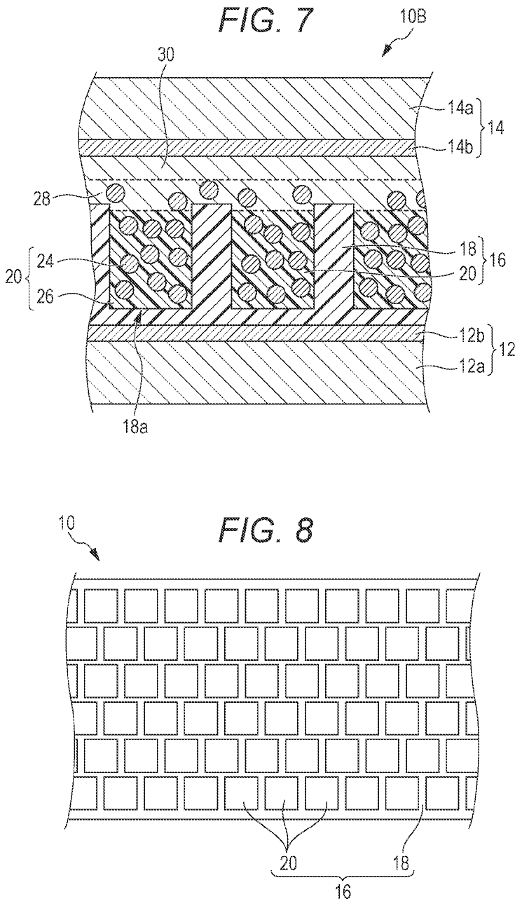

Further, as in a wavelength conversion member 10B conceptually illustrated in FIG. 7, the wavelength conversion member may include, in addition to the mixed layer 28, a layer 30 containing the same oxygen-impermeable material as the oxygen-impermeable material contained in the mixed layer 28 and not containing the quantum dots 24 (hereinafter, this layer is referred to as an “impermeable layer”) between the mixed layer 28 and the second base material film 14. Providing the impermeable layer 30 can further prevent the deterioration of the quantum dots 24 caused by oxygen permeating between the upper end of the wall portion and the second base material film 14.

The thicknesses of the impermeable layer 30 in the wavelength conversion member 10B is not particularly limited. The impermeable layer 30 may be a layer that does not include the quantum dot 24 and is formed of only an oxygen-impermeable material. Thus, as in the case of the mixed layer 28, a thicker mixed layer is advantageous in preventing the quantum dots 24 from being deteriorated by oxygen. On the other hand, from the viewpoint of the optical characteristics of the wavelength conversion member, it is preferable that the thickness is small. In a case where the wavelength conversion member 10B has the impermeable layer 30, the thicknesses of the impermeable layer 30 may be appropriately set in consideration of these points.

The mixed layer 28 and the impermeable layer 30 may be formed by various methods. As described above, the wavelength conversion member 10 may be produced by forming the resin layer 18 on the surface of the first base material film 12, filling the recess 18a of the resin layer 18 with the polymerizable composition containing quantum dots, stacking the second base material film 14 on the resin layer 18 so as to seal the polymerizable composition filled in the resin layer 18, and curing the polymerizable composition to be the quantum dot-containing part. As an example, in this production method, before the second base material film 14 is stacked, a coating liquid containing an oxygen-impermeable material is applied to the surface of the second base material film 14 on the resin layer 18 side. Then, the second base material film 14 is stacked on the resin layer 18 with the coating liquid containing the oxygen-impermeable material facing the resin layer 18. Through this process, the polymerizable composition which is to be cured between the upper end of the wall portion and the second base material film 14 serving as the quantum dot-containing part is mixed with the coating liquid containing the oxygen-impermeable material. Thereafter, by curing the mixture of the coating liquid containing the oxygen-impermeable material and the polymerizable composition, the mixed layer 28 containing the oxygen-impermeable material can be formed between the upper end of the wall portion and the second base material film 14 in addition to the quantum dots. In this case, it is possible to set whether only the mixed layer 28 is formed or both the mixed layer 28 and the impermeable layer 30 are formed by adjusting the coating thickness of the coating liquid containing the oxygen-impermeable material applied to the second base material film 14. Specifically, the impermeable layer 30 can be formed in addition to the mixed layer 28 by increasing the coating thickness of the coating liquid containing the oxygen-impermeable material, and the thicker the coating thickness of the coating liquid, the thicker the impermeable layer 30. This point will be described in detail later.

The wavelength conversion member 10 (10A, 10B) may have a configuration in which the wavelength conversion layer 16 having the resin layer 18 and the quantum dot-containing part 20 is sandwiched between the first base material film 12 and the second base material film 14. Further, the wavelength conversion member 10 may have the mixed layer 28 and/or the impermeable layer 30 in addition to the resin layer 18 and the quantum dot-containing part 20.

It is preferable that both of the first base material film 12 and the second base material film 14 are films having impermeability to oxygen. In an aspect of the wavelength conversion member 10, the first base material film 12 has a configuration in which the barrier layer 12b is stacked on the support film 12a, and the first base material film 12 is stacked on the wavelength conversion layer 16 such that the barrier layer 12b faces the wavelength conversion layer 16. The second base material film 14 also has a configuration in which the barrier layer 14b is stacked on the support film 14a, and the second base material film 14 is stacked on the wavelength conversion layer 16 with the barrier layer 14b facing the wavelength conversion layer 16.

As the barrier layer 12b of the first base material film 12, various well-known barrier layers may be used as long as they have impermeability to oxygen. Also as the barrier layer 14b of the second base material film 14, various well-known barrier layers may be used as long as they have impermeability to oxygen. Since the first base material film 12 and the second base material film 14 may have the same configuration except that the stacking positions are different, the first base material film 12 will be used as a representative example in the following description unless it is necessary to distinguish between the two.

As the barrier layer 12b of the first base material film 12, various known barrier layers may be used. It is preferable that the barrier layer has at least one inorganic layer, and it is more preferable that the barrier layer is an organic/inorganic stacking type barrier layer having one or more combinations of an inorganic layer and an organic layer serving as a underlayer of the inorganic layer.

In the wavelength conversion member 10 of the illustrated example, the barrier layer 12b of the first base material film (and the barrier layer 14b of the second base material film 14) has, as illustrated in the partially enlarged view A of FIG. 3, a configuration in which three layers of a underlying organic layer 34 formed on the surface of the support film 12a (support film 14a), an inorganic layer 36 formed on the underlying organic layer 34, and a protective organic layer 38 formed on the inorganic layer 36 are stacked.

The underlying organic layer 34 on the surface of the support film 12a, that is, the underlying organic layer 34 under the inorganic layer 36 is an underlying layer (undercoat layer) for appropriately forming the inorganic layer 36. In the organic/inorganic stacking type barrier layer, a portion mainly exhibiting barrier properties is the inorganic layer 36. Thus, by forming the underlying organic layer 34 and forming the inorganic layer 36 thereon, the surface on which the inorganic layer 36 is formed may be appropriately adjusted to form the inorganic layer 36 in which the occurrence of defects is suppressed, and high barrier properties can be obtained. The barrier layer 12b in the illustrated example has only one combination of the underlying organic layer 34 and the inorganic layer 36. However, this is merely an example, and the barrier layer may have a plurality of combinations of the underlying organic layer 34 and the inorganic layer 36. As the number of combinations of the underlying organic layer 34 and the inorganic layer 36 increases, a higher barrier property can be obtained.

The protective organic layer 38 formed on the surface of the inorganic layer 36 is a protective layer (overcoat layer) that mainly protects the inorganic layer 36 exhibiting barrier properties. By providing the protective organic layer 38, cracking, chipping, and the like of the inorganic layer 36 can be prevented, and deterioration of barrier properties of the barrier layer 12b caused by damage to the inorganic layer 36 can be prevented.

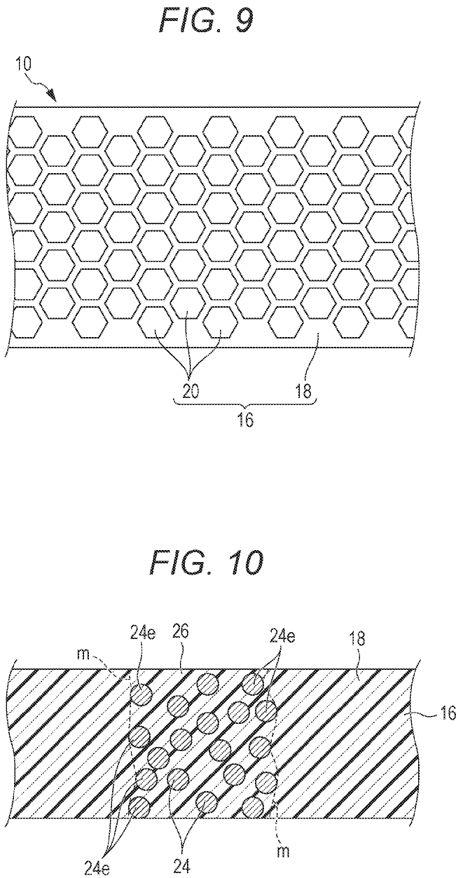

In the wavelength conversion member 10 illustrated in FIGS. 1 to 3, the quantum dot-containing part (the recess 18a) is cylindrical and circular in plan view. However, the shape of the quantum dot-containing part is not particularly limited. The quantum dot-containing part may be a polygonal prism or a regular polygonal prism such as a quadrangle in plan view as illustrated in FIG. 8 or a hexagon (honeycomb structure) in plan view as illustrated in FIG. 9. In the above-described example, the bottom surface of the cylinder or the polygonal prism is disposed in parallel to the base material film surface. However, the bottom surface does not have to be disposed parallel to the base material film surface. The shape of each quantum dot-containing part may be indefinite.

In a case where the boundary between the matrix 26 of the quantum dot-containing part and the resin layer 18 is not clear, a line connecting points on the outside (the side where the quantum dots 24 are not disposed) of quantum dots 24e positioned in the outermost portion of the region where the quantum dots 24 are closely disposed is regarded as a contour m of the quantum dot-containing part (the boundary between the quantum dot-containing part and the resin layer 18) as illustrated in FIG. 10. By irradiating the wavelength conversion layer with excitation light to cause the quantum dots to emit light and observing the wavelength conversion layer with, for example, a confocal laser microscope or the like, the positions of the quantum dots can be specified, and thus, the contour m of the quantum dot-containing part can be specified. In the present invention and the specification, the sides of a column or a polygonal prism are allowed to meander like the contour in FIG. 10. In the above-described aspect, the quantum dot-containing parts are periodically arranged in a pattern. However, as long as the plurality of quantum dot-containing parts are discretely arranged, the quantum dots may be nonperiodic as long as the desired performance is not impaired. It is preferable that the quantum dot-containing parts 20 are uniformly distributed over the entire region of the wavelength conversion layer 16 because the in-plane distribution of luminance becomes uniform.

To obtain a sufficient amount of fluorescence, it is preferable that a region occupied by the quantum dot-containing part is large. The quantum dot 24 in the quantum dot-containing part may be of one kind or of plural kinds. In addition, the quantum dots 24 in one quantum dot-containing part may be one kind, and a region including a first quantum dot and a region including a second quantum dot different from the first quantum dot may be periodically or non-periodically arranged among the plurality of quantum dot-containing parts. Three or more kinds of quantum dots may be used. Details of the quantum dot are as described above.

As described above, in the wavelength conversion layer, the shape of the quantum dot-containing part, the arrangement pattern thereof, and the like are not particularly limited. In any case, since the quantum dots are discretely arranged on the film surface, the quantum dots of the quantum dot-containing part at the cut end portion may deteriorate. However, since the quantum dots in the portion other than the cut end portion are surrounded and sealed by the resin in the direction along the film surface, it is possible to suppress deterioration of the performance due to the entry of oxygen from the direction along the film surface.

Hereinafter, the respective components of the wavelength conversion layer will be described.

As described above, the wavelength conversion member 10 illustrated in FIGS. 1 to 3 has a configuration in which the wavelength conversion layer 16 is stacked on one film surface of the first base material film 12, the second base material film 14 is further stacked on the wavelength conversion layer 16, and the wavelength conversion layer 16 is sandwiched between the two base material films.

### (Resin Layer)

The resin layer 18 may be formed by, for example, preparing, applying, and curing composition for forming resin layer containing the same polymerizable compound as the polymerizable compound forming the matrix 26. It is preferable that the resin layer 18 has impermeability to oxygen. It is preferable that the oxygen permeability of the resin layer 18 at the shortest distance between adjacent quantum dot-containing parts with the wall portion forming the recess 18a interposed therebetween satisfies 10 cc/(m²·day·atm) or less. The oxygen permeability of the resin layer 18 at the shortest distance between adjacent quantum dot-containing parts is preferably 10 cc/(m²·day·atm) or less, more preferably 1 cc/(m²·day·atm) or less, and still more preferably 1×10⁻¹ cc/(m² day·atm) or less.

The desired shortest distances between the quantum dot-containing parts, that is, a desired intervals t between the quantum dot-containing parts (the recess 18a) varies depending on the composition of the resin layer 18. The shortest distance between adjacent quantum dot-containing parts of the resin layer 18 means the shortest distance in the film surface between adjacent quantum dot-containing parts as observed from the wavelength conversion member main surface.

An elastic modulus of the resin layer 18 is preferably 0.5 to 10 GPa, more preferably 1 to 7 GPa, and still more preferably 3 to 6 GPa. Adjusting the elastic modulus of the resin layer to be in the above-described range is preferable in terms of preventing defection in the formation of the resin layer while maintaining the desired oxygen permeability. The elastic modulus of the resin layer is measured by a method exemplified in Japanese Industrial Standards (JIS) K 7161 or the like.

For the composition for forming resin layer, for example, paragraphs [0174] to [0179] of WO2018/186300A can be referenced.

The composition for forming resin layer may include a compound having a di- or higher functional photopolymerizable crosslinking group. Examples of the compound having a di- or higher functional photopolymerizable crosslinking group include (meth)acrylate; and polymerizable compounds such as a (meth)allyl compound, an allyl ether compound, a vinyl compound, and a vinyl ether compound. Since a polymerizable compound such as a (meth)allyl compound, an allyl ether compound, a vinyl compound, or a vinyl ether compound tends to have poor homopolymerizability as compared with (meth)acrylate, it is preferable to form a resin layer including a thiol-ene resin for using these polymerizable compounds in a composition for forming resin layer.

Specific examples of the polymerizable compound that may be contained in the composition for forming resin layer include, in addition to the various polymerizable compounds described in paragraph [0174] of WO2018/186300A and the (meth)acrylates described above for the polymerizable composition, diallylamines, diallyl ether, diallyl sulfide, diallyl fumarate, diallyl isophthalate, diallylpropyl isocyanurate, 1,5-hexadiene-3,4-diol, diethylene glycol divinyl ether, triallylamine, triallyl citrate, triallyl cyanurate, triallyl isocyanurate, triallyl 1,3,5-benzenetricarboxylate, 2,4,6-tris(allyloxy)1,3,5-triazine, 2,4,6-trimethyl-2,4,6-trivinylcyclotrisiloxane, pentaerythritol tetraallyl ether, and N,N,N′,N′,N″,N″-hexaallyl-1,3,5-triazine-2,4,6-triamine. For the polyfunctional thiol, the above description regarding the polymerizable composition can be referenced. Since the thiol-ene resin is usually a flexible resin as compared with a (meth)acrylate crosslinked substance, it is preferable to use a component having a rigid ring structure such as isocyanurate or triazine as a component for obtaining the thiol-ene resin in order to increase an elastic modulus and/or oxygen impermeability.

### (Base Material Film)

As described above, the first base material film 12 (and the second base material film 14) may have a configuration in which the barrier layer 12b is stacked on the support film 12a. The barrier layer 12b (and the barrier layer 14b) may include the underlying organic layer 34, the inorganic layer 36, and the protective organic layer 38. The first base material film 12 is stacked on the wavelength conversion layer 16 with the barrier layer 12b facing the wavelength conversion layer 16. In this configuration, the strength of the wavelength conversion member 10 can be improved by the support film 12a, and film formation can be easily performed. However, in the present invention and the specification, the first base material film (and the second base material film) is not limited to such a configuration having the support film 12a and the barrier layer 12b, and various film-like materials (sheet-like materials) may be used as long as necessary impermeability to oxygen can be secured. For example, the first base material film may be formed of only a support film having sufficient barrier properties. In addition, a first base material film in which only one inorganic layer is formed on a surface of a support film may also be used.

The total light transmittance of the first base material film 12 in the visible light region is preferably 80% or more and more preferably 85% or more. The visible light region is a wave length region of 380 to 780 nm, and the total light transmittance indicates an arithmetic average of the light transmittance over the visible light region.

The first base material film 12 preferably has an oxygen permeability of 1 cc/(m²·day·atm) or less. The oxygen permeability of the first base material film 12 is more preferably 0.1 cc/(m²·day·atm) or less, still more preferably 0.01 cc/(m²·day·atm) or less, and even still more preferably 0.001 cc/(m²·day·atm) or less.

The first base material film 12 preferably has water vapor barrier properties for blocking moisture (water vapor) in addition to gas barrier properties for blocking oxygen. The moisture permeability (water vapor permeability) of the first base material film 12 is preferably 0.10 g/(m²·day·atm) or less, and more preferably 0.01 g/(m²·day·atm) or less.

### (Support Film)

The support film 12a (and the support film 14a) is preferably a flexible belt-like support film that is transparent to visible light. The term “transparent to visible light” as used herein means that the light transmittance in the visible light region is 80% or more, preferably 85% or more. The light transmittance used as the index of transparency can be calculated by measuring the total light transmittance and the amount of scattered light using a method described in JIS K 7105, that is, by using an integrating sphere-type light transmittance measurement device, and subtracting a diffusion transmittance from the total light transmittance. For the support film having flexibility, a description disclosed in paragraphs [0046] to [0052] of JP2007-290369A and paragraphs [0040] to [0055] of JP2005-096108A can be referenced.

Specific examples of the support film 12a include a polyethylene terephthalate (PET) film, a film formed of a polymer having a cyclic olefin structure, and a polystyrene film.

From a viewpoint of improving impact resistance of the wavelength conversion member, the thickness of the support film 12a is preferably 10 to 500 μm, more preferably 20 to 400 μm, and still more preferably 30 to 300 μm. As in a case where the concentration of the quantum dots contained in the wavelength conversion layer 16 is reduced and a case where the thicknesses of the wavelength conversion layer 16 are reduced, it is more preferable that the absorbance of light having a wavelength of 450 nm is lower in an aspect where the retroreflection of light is increased. From this viewpoint, the thickness of the support film 12a is preferably 40 μm or less and more preferably 25 μm or less.

### (Barrier Layer)

The first base material film 12 (and the second base material film 14) has the barrier layer 12b on one surface of the support film 12a. As described above, various known barrier layers may be used as the barrier layer 12b. It is preferable to have at least one inorganic layer, and an organic/inorganic stacking type barrier layer having one or more combinations of an inorganic layer and an organic layer serving as a base of the inorganic layer is more preferable. In the wavelength conversion member 10 in the illustrated example, as illustrated in the partially enlarged view A of FIG. 3, the barrier layer 12b of the first base material film has a configuration in which three layers of the underlying organic layer 34 formed on the surface of the support film 12a, the inorganic layer 36 formed on the underlying organic layer 34, and the protective organic layer 38 formed on the inorganic layer 36 are stacked. In the following description, in a case where it is not necessary to distinguish between the underlying organic layer 34 and the protective organic layer 38, both are collectively referred to as an “organic layer”.

In the present invention and the specification, the “inorganic layer” is a layer containing an inorganic substance as a main component. The main component refers to a component occupying the largest amount on a mass basis among components constituting the layer. The same applies to the organic layer described below. The inorganic layer may be a layer in which the content of the inorganic substance is 50 mass % or more, 60 mass % or more, 70 mass % or more, 80 mass % or more, 90 mass % or more, 95 mass % or more, or 99 mass % or more. Alternatively, a layer formed of only an inorganic substance may also be used. Here, the layer formed of only an inorganic substance refers to a layer containing only an inorganic substance except for impurities inevitably mixed in the production process. In the inorganic layer, only one kind of inorganic substance may be contained, or two or more kinds of inorganic substances may be contained.

The inorganic layer 36 is preferably a layer having gas barrier properties for blocking oxygen. Specifically, the oxygen permeability of the inorganic layer is preferably 1 cc/(m²·day·atm) or less. It is also preferable that the inorganic layer has water vapor barrier properties for blocking water vapor.

The thicknesses of the inorganic layer 36 are preferably 1 to 500 nm, more preferably 5 to 300 nm, and still more preferably 10 to 150 nm. In a case where the thickness of the inorganic layer 36 is within the above range, reflection in the inorganic layer 36 can be suppressed while realizing good barrier properties, and a stacked film having a higher light transmittance can be provided.

In the present invention and the specification, the “organic layer” is a layer containing an organic substance as a main component. The organic layer may be a layer in which the content of the organic substance is 50 mass % or more, 60 mass % or more, 70 mass % or more, 80 mass % or more, 90 mass % or more, 95 mass % or more, or 99 mass % or more. Alternatively, a layer formed of only an organic substance may also be used. Here, the layer formed of only an organic substance refers to a layer containing only an organic substance except for impurities inevitably mixed in the production process. In the organic layer, only one kind of organic substance may be contained, or two or more kinds of organic substances may be contained.

For the organic layer (the underlying organic layer 34 and the protective organic layer 38), the descriptions disclosed in paragraphs [0020] to [0042] of JP2007-290369A and paragraphs [0074] to [0105] of JP2005-096108A can be referenced. In an aspect, the organic layer preferably includes a cardo polymer. This is because, as a result, the adhesive force between the organic layer and the adjacent layer, in particular, the adhesive force with the inorganic layer is increased, and more excellent gas barrier properties can be realized. For details of the cardo polymer, a description disclosed in paragraphs [0085] to [0095] of JP2005-096108A can be referenced.

The thickness of the organic layer is preferably 0.05 to 10 μm and more preferably 0.5 to 10 μm. In a case where the organic layer is formed by a wet coating method, the thickness of the organic layer is preferably 0.5 to 10 μm and more preferably 1 to 5 μm. In a case where the organic layer is formed by a dry coating method, the thickness of the organic layer is preferably 0.05 to 5 μm, and more preferably 0.05 to 1 μm. In a case where the thickness of the organic layer formed by a wet coating method or a dry coating method is within the above range, the adhesive force with the inorganic layer can be further increased.

For details of the inorganic layer, paragraphs [0193] to [0196] of WO2018/186300A can be referenced. In addition, for other details of the inorganic layer and the organic layer, the description of JP2007-290369A, JP2005-096108A, and further, US2012/0113672A1 can be referenced.

In the wavelength conversion member, the organic layer may be stacked between the support film and the inorganic layer as a underlayer of the inorganic layer, and may be stacked between the inorganic layer and the wavelength conversion layer as a protective layer of the inorganic layer. Further, in a case of having two or more inorganic layers, the organic layer may be stacked between the inorganic layers.

The first base material film 12 (and the second base material film 14) may include an unevenness-imparting layer that imparts an uneven structure on the surface opposite to the surface on the wavelength conversion layer 16 side. It is preferable that the first base material film 12 has an unevenness-imparting layer because the blocking properties and/or the sliding properties of the base material film can be improved. The unevenness-imparting layer is preferably a layer containing particles. Examples of the particles include inorganic particles such as silica, alumina, and metal oxide, and organic particles such as crosslinked polymer particles. The unevenness-imparting layer is preferably provided on the surface of the base material film on the side opposite to the wavelength conversion layer, or it may be provided on both surfaces.

The wavelength conversion member 10 may have a light scattering function to efficiently extract the fluorescence of the quantum dots to the outside. The light scattering function may be provided inside the wavelength conversion layer 16, or a layer having a light scattering function may be separately provided as a light scattering layer. The light scattering layer may be provided on a surface of the first base material film 12 and/or the second base material film 14 on the wavelength conversion layer 16 side, or may be provided on a surface of the first base material film 12 and/or the second base material film 14 on the side opposite to the wavelength conversion layer 16. In a case where the unevenness-imparting layer is provided, the unevenness-imparting layer is preferably a layer that can also serve as a light scattering layer.

### (Mixed Layer, Impermeable Layer)

As described above, the mixed layer 28 contains the quantum dots 24 contained in the quantum dot-containing part 20. The impermeable layer 30 may be a layer made of an oxygen-impermeable material that does not contain the quantum dots 24. As the oxygen-impermeable material, various materials that may be used as the material for forming the resin layer 18 may be used. Of these, the mixed layer 28 and the impermeable layer 30 preferably contain the same polymerizable compound as the polymerizable compound used for forming the resin layer 18 as the oxygen-impermeable material.

### (Method for Producing Wavelength Conversion Member)

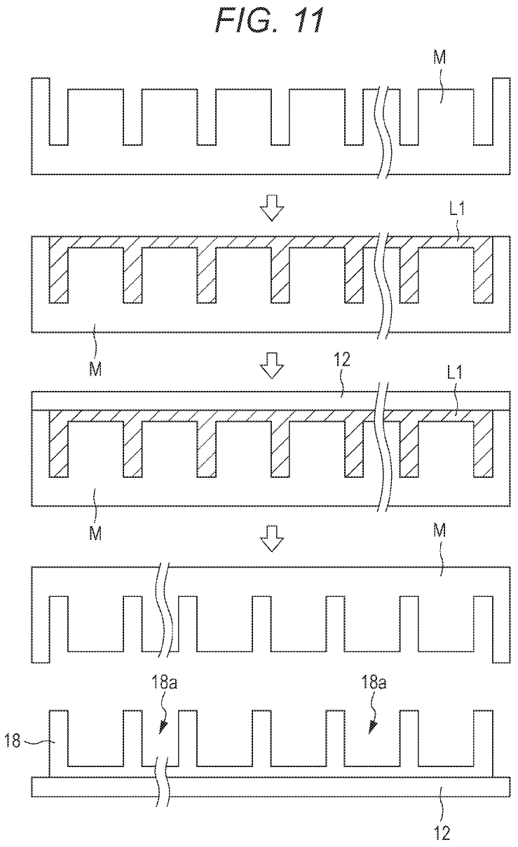

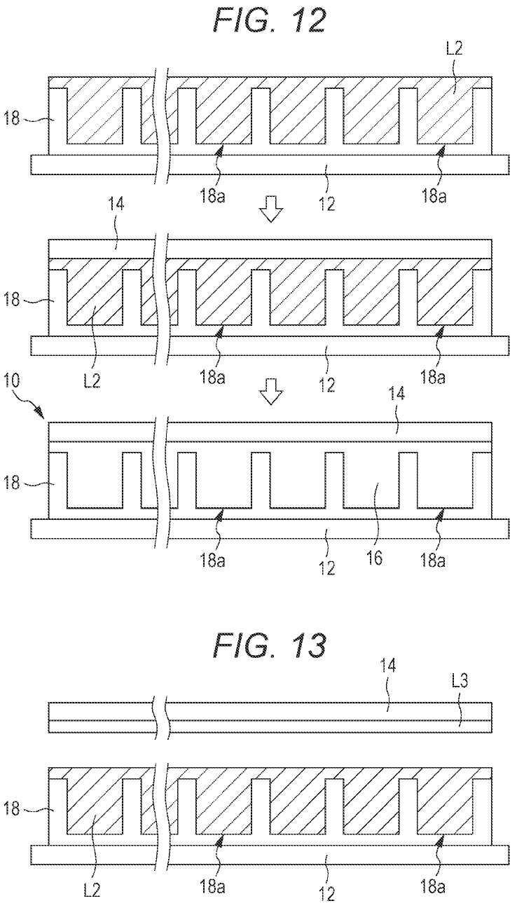

Next, an example of the production process of the wavelength conversion member will be described with reference to the conceptual diagrams of FIGS. 11 and 12.

First, composition for forming resin layer L1 for forming the resin layer 18 is prepared by adding a polymerizable compound and, as necessary, mixing various components such as a polymerization initiator, inorganic particles, and light scattering particles.

In addition, a polymerizable composition L2 including quantum dots is prepared.

Further, a mold M having an uneven pattern corresponding to the recess 18a and the wall portion of the resin layer 18 for forming the resin layer 18, the first base material film 12, and the second base material film 14 are prepared.

After these are prepared, first, the prepared mold M is filled with the prepared resin layer forming composition L1 as illustrated in the first and second stages of FIG. 11, and the first base material film 12 is stacked on the mold M so as to cover the entire surface of the composition for forming resin layer L1 as illustrated in the third stage of FIG. 11.

Next, for example, the composition for forming resin layer L1 is cured by ultraviolet irradiation or the like to form the resin layer 18, and the mold M is removed from the resin layer 18 as illustrated in the fourth stage of FIG. 11. As a result, a stack in which the resin layer 18 is stacked on one surface of the first base material film 12 such that the bottom of the recess 18a faces the first base material film 12 is formed.

After forming the stack of the first base material film 12 and the resin layer 18, the recess 18a is filled with the polymerizable composition L2 containing quantum dots (quantum dot-containing polymerizable composition) as illustrated in the first stage of FIG. 12. At this time, the recess 18a is filled with the quantum dot-containing polymerizable composition L2 such that the quantum dot-containing polymerizable composition L2 rises higher than the upper end of the wall portion of the resin layer 18 by using the surface tension and the viscosity of the polymerizable composition L2.

Next, as illustrated in the second stage of FIG. 12, the second base material film 14 is stacked so as to cover and seal the entire surface of the quantum dot-containing polymerizable composition L2. By adjusting the pressing force of the second base material film 14 at this time, the gap between the upper end of the wall portion of the resin layer 18 and the second base material film 14 can be adjusted. For example, in a case where the second base material film 14 is stacked by a laminator, the gap between the upper end of the wall portion of the resin layer 18 and the second base material film 14 can be adjusted by adjusting the pressure of the laminator.

Thereafter, for example, the quantum dot-containing polymerizable composition L2 is cured by light irradiation to form a quantum dot-containing part, and as illustrated in the third stage of FIG. 12, the wavelength conversion member 10 in which the wavelength conversion layer 16 having the quantum dot-containing part and the resin layer 18 is sandwiched between the first base material film 12 and the second base material film 14 is produced.

In a case where the mixed layer 28 or further the impermeable layer 30 is formed as in the wavelength conversion member 10A illustrated in FIG. 6 and the wavelength conversion member 10B illustrated in FIG. 7, a coating liquid L3 containing an oxygen-impermeable material is applied to one surface of the second base material film 14 as conceptually illustrated in FIG. 13 prior to stacking of the second base material film 14 illustrated in the second stage of FIG. 12.

Thereafter, as illustrated in the second stage of FIG. 12, the second base material film 14 is stacked so as to cover and seal the entire surface of the quantum dot-containing polymerizable composition L2 with the coating surface of the coating liquid L3 facing the quantum dot-containing polymerizable composition L2. This causes the quantum dot-containing polymerizable composition L2 and the coating liquid L3 containing the oxygen-impermeable material to be mixed.

Thereafter, by curing the coating liquid L3 containing the quantum dot-containing polymerizable composition L2 and the oxygen-impermeable material, a wavelength conversion member including the mixed layer 28 or further the impermeable layer 30 together with the quantum dot-containing part can be produced.

At this time, as described above, by adjusting the coating thickness of the coating liquid L3 containing the oxygen-impermeable material to the second base material film 14, it is possible to set whether only the mixed layer 28 is formed or both the mixed layer 28 and the impermeable layer 30 are formed. Specifically, in a case where the coating thickness of the coating liquid L3 containing the oxygen-impermeable material on the second base material film 14 is thin, only the mixed layer 28 can be formed, and both the mixed layer 28 and the impermeable layer 30 can be formed by increasing the coating thickness of the coating liquid L3 containing the oxygen-impermeable material on the second base material film 14, and the thicker the coating thickness of the coating liquid L3 is, the thicker the impermeable layer 30 is.

In the wavelength conversion layer, the method for forming of the recess 18a of the resin layer 18 is not limited to the method illustrated in FIG. 11, and various known methods for forming a sheet-like material having unevenness may be used. For example, a method of applying the composition for forming resin layer L1 to the first base material film 12, pressing the mold M against the composition for forming resin layer L1, and then curing the composition for forming resin layer L1, thereafter stacking the first base material film 12 and the mold M, a method of filling the composition for forming resin layer L1 between the first base material film 12 and the mold M, and then curing the composition for forming resin layer L1, and the like are exemplified. In addition to these methods, for example, it is possible to use a method of forming a plane resin layer and then forming the resin layer 18 having the recess 18a by etching or a method of forming the resin layer 18 having the recess 18a by using a print method such as an inkjet method or a dispenser method.

### [Backlight Unit]

An aspect of the present invention relates to a backlight unit comprising the wavelength conversion member and a light source.

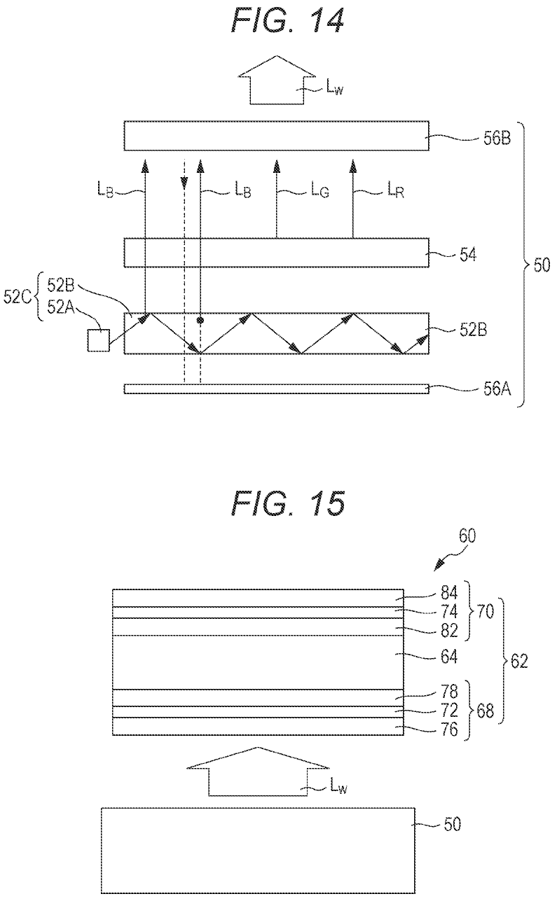

Hereinafter, an example of the backlight unit will be described with reference to the drawings. FIG. 14 is a schematic diagram illustrating a schematic configuration of the backlight unit.

As illustrated in FIG. 14, a backlight unit 50 includes a planar light source 52C including a light source 52A that emits primary light (blue light L_{B}) and a light guide plate 52B that guides and emits the primary light emitted from the light source 52A, a wavelength conversion member 54 disposed on the planar light source 52C, a reflective plate 56A disposed opposite to the wavelength conversion member 54 with the planar light source 52C interposed therebetween, and a retroreflective member 56B. In FIG. 14, the reflective plate 56A, the light guide plate 52B, the wavelength conversion member 54, and the retroreflective member 56B are separated from each other, but in practice, these members may be formed in close contact with one another.

The wavelength conversion member 54 emits fluorescence using at least a part of the primary light L_{B} emitted from the planar light source 52C as excitation light, and emits secondary light (green light L_{G} and red light L_{R}) formed of the fluorescence and the primary light L_{B} that has passed through the wavelength conversion member 54. For example, the wavelength conversion member 54 is the wavelength conversion member 10 configured such that the wavelength conversion layer 16 including quantum dots that emit green light L_{G} and quantum dots that emit red light L_{R} upon irradiation with blue light L_{B} is sandwiched between the first base material film 12 and the second base material film 14.

In FIG. 14, L_{B}, L_{G} and L_{R} emitted from the wavelength conversion member 54 enter the retroreflective member 56B, and each incident light repeats reflection between the retroreflective member 56B and the reflective plate 56A and can pass through the wavelength conversion member 54 many times. As a result, in the wavelength conversion member 54, a sufficient amount of excitation light (blue light L_{B}) is absorbed by the quantum dots 24 in the wavelength conversion layer 16 and a sufficient amount of fluorescence (L_{G}, L_{R}) is emitted, and white light L_{W} is realized and emitted from the retroreflective member 56B.

From the viewpoint of realizing high luminance and high color reproducibility, it is preferable to use a backlight unit formed into a multi-wavelength light source as the backlight unit 50. For example, it is preferable to emit blue light having a light emission center wavelength in a wavelength range of 430 to 480 nm and having a peak of a luminescence intensity with a half-width of 100 nm or less, green light having a light emission center wavelength in a wavelength range of 500 to 600 nm and having a peak of a luminescence intensity with a half-width of 100 nm or less, and red light having a light emission center wavelength in a wavelength range of 600 to 680 nm and having a peak of a luminescence intensity with a half-width of 100 nm or less.

From the viewpoint of further improvement in luminance and color reproducibility, the wavelength range of the blue light to be emitted from the backlight unit 50 is more preferably 440 to 460 nm.

From the same viewpoint, the wavelength range of the green light to be emitted from the backlight unit 50 is preferably 520 to 560 nm and more preferably 520 to 545 nm.

From the same viewpoint, the wavelength range of the red color light to be emitted from the backlight unit 50 is more preferably 610 to 640 nm.

From the same viewpoint, all the half-widths of the respective luminescence intensities of the blue light, the green light, and the red light to be emitted from the backlight unit 50 are preferably 80 nm or less, more preferably 50 nm or less, still more preferably 40 nm or less, and particularly preferably 30 nm or less. Of these, the half-width of the luminescence intensity of the blue light is particularly preferably 25 nm or less.

The light source 52A is, for example, a blue light emitting diode that emits blue light having a light emission center wavelength in the wavelength range of 430 to 480 nm. Alternatively, an ultraviolet light emitting diode that emits ultraviolet light may be used. As the light source 52A, a laser light source or the like may be used in addition to a light emitting diode. In a case where a light source that emits ultraviolet light is provided, the wavelength conversion layer 16 of the wavelength conversion member 54 may include quantum dots that emit blue light, quantum dots that emit green light, and quantum dots that emit red light upon irradiation with ultraviolet light.

As illustrated in FIG. 14, the planar light source 52C may be a planar light source including the light source 52A and the light guide plate 52B that guides and emits the primary light emitted from the light source 52A, or may be a planar light source in which the light sources 52A are arranged on a plane parallel to the wavelength conversion member 54 and a diffusion plate is provided instead of the light guide plate 52B. The former planar light source is typically referred to as an edge light type, and the latter planar light source is typically referred to as a direct type. In the above description, a case where the planar light source is used as the light source has been described as an example. However, as the light source, a light source other than the planar light source may also be used.

### <Configuration of Backlight Unit>

In FIG. 14, as the configuration of the backlight unit, the edge light type in which a light guide plate, a reflective plate, and the like are provided as constituent members has been described. However, the configuration of the backlight unit may be a direct type. A known light guide plate may be used as the light guide plate.

The reflective plate 56A is not particularly limited, and a well-known reflective plate may be used. JP3416302B, JP3363565B, JP4091978B, JP3448626B, and the like can be referenced.

The retroreflective member 56B may be formed of a well-known diffusion plate and diffusion sheet, a prism sheet (for example, BEF series manufactured by Sumitomo 3M Limited), a light guide device, and the like. With regard to the configuration of the retroreflective member 56B, JP3416302B, JP3363565B, JP4091978B, JP3448626B, and the like can be referenced.

### [Liquid Crystal Display Device]

An aspect of the present invention relates to a liquid crystal display device including the backlight unit and a liquid crystal cell.

Hereinafter, an example of the liquid crystal display device will be described with reference to the drawings. FIG. 15 is a schematic diagram illustrating a schematic configuration of a liquid crystal display device.

As illustrated in FIG. 15, a liquid crystal display device 60 includes a backlight unit 50 and a liquid crystal cell unit 62 disposed to face a retroreflective member side of the backlight unit.

As illustrated in FIG. 15, the liquid crystal cell unit 62 has a configuration in which a liquid crystal cell 64 is sandwiched between a polarizing plate 68 and a polarizing plate 70, and the polarizing plates 68 and 70 have a configuration in which both main surfaces of polarizers 72 and 74 are protected by polarizing plate protective films 76 and 78, and 82 and 84, respectively.

The liquid crystal cell 64 and the polarizing plates 68 and 70 constituting the liquid crystal display device 60, and their components are not particularly limited, and a product produced by a known method, a commercially available product, and the like may be used. In addition, a known intermediate layer such as an adhesive layer may also be provided between respective layers.

A driving mode of the liquid crystal cell 64 is not particularly limited, and various modes such as a twisted nematic (TN) mode, a super-twisted nematic (STN) mode, a vertical alignment (VA) mode, an in-plane switching (IPS) mode, and an optically compensated bend cell (OCB) mode may be used. The liquid crystal cell is preferably in any of a VA mode, an OCB mode, an IPS mode, or a TN mode. The present invention is not limited to these modes. An example of the configuration of the liquid crystal display device in a VA mode may be the configuration illustrated in FIG. 2 of JP2008-262161A. However, a specific configuration of the liquid crystal display device is not particularly limited, and a known configuration may be adopted.

The liquid crystal display device 60 may further include an accompanying functional layer such as an optical compensation member for performing optical compensation or an adhesive layer, as necessary. In addition, surface layers such as a forward scattering layer, a primer layer, an antistatic layer, and an undercoat layer may be disposed in the liquid crystal display device 60 together with (or instead of) a color filter base material, a thin film transistor base material, a lens film, a diffusion sheet, a hard coat layer, an antireflection layer, a low reflection layer, an antiglare layer, and the like.

The polarizing plate 68 on the backlight unit 50 side may include a retardation film as the polarizing plate protective film 78 on the liquid crystal cell 64 side. As such a retardation film, a known cellulose acylate film or the like may be used.

### EXAMPLES

Hereinafter, the present invention will be described more specifically based on examples. Materials, use amounts, ratios, treatment contents, treatment procedures, and the like shown in the following examples may be appropriately changed without departing from the gist of the present invention. Thus, the scope of the present invention should not be construed as being limited by the specific examples shown below. “%” described below indicates mass %, unless otherwise noted. “Room temperature” described below is 25° C.

### Examples 1 to 44 and Comparative Examples 1 to 4

### <Production of Wavelength Conversion Member>

### (Production of Barrier Film)

As the first base material film and the second base material film, a barrier film in which an inorganic layer and an organic layer were formed on a support film made of polyethylene terephthalate (PET) was produced as follows.

A PET film (COSMOSHINE A4300 manufactured by TOYOBO CO., LTD., thickness 23 μm) as a support film was used, and an organic layer and an inorganic layer were sequentially formed on one surface of the support film according to the following procedure.

Formation of underlying organic layer Trimethylolpropane triacrylate (TMPTA, manufactured by DAICEL-ALLNEX LTD.) and a photopolymerization initiator (ESACURE KT046, manufactured by Lamberti S.p.A) were prepared and weighed so as to have a mass ratio of 95:5, and these were dissolved in methylethyl ketone to prepare a coating liquid having a solid concentration of 15% for forming a underlying organic layer.

This coating liquid was applied onto a support film (PET film) in a roll-to-roll manner using a die coater and passed through a drying zone at a temperature of 50° C. for 3 minutes. Thereafter, the coating liquid was cured by irradiation with ultraviolet rays (cumulative irradiation amount: about 600 mJ/cm²) under a nitrogen atmosphere, and wound up. The thickness of the organic layer formed on the support film was 1 μm.

### Formation of Inorganic Layer

Next, a silicon nitride film was formed as an inorganic layer on a surface of the underlying organic layer using a chemical vapor deposition (CVD) apparatus for forming a film in a roll-to-roll manner.

As raw material gases, silane gas (flow rate: 160 sccm (standard cubic centimeter per minute)), ammonia gas (flow rate: 370 sccm), hydrogen gas (flow rate: 590 sccm), and nitrogen gas (flow rate: 240 sccm) were used. As a power source, a high-frequency power source with a frequency of 13.56 MHz was used. The film formation pressure was set to 40 Pa (pascals), and the achieved film thickness was 50 nm.

### Formation of Protective Organic Layer

Further, a protective organic layer was stacked on a surface of the inorganic layer. With respect to 95.0 parts by mass of a urethane skeleton acrylate polymer (ACRIT 8BR930 manufactured by Taisei Fine Chemical Co., Ltd.), 5.0 parts by mass of a photopolymerization initiator (IRGACURE184 manufactured by BASF) was weighed, and these were dissolved in methylethyl ketone to prepare a coating liquid having a solid concentration of 15% for forming a protective organic layer.

This coating liquid was directly applied to a surface of the inorganic layer in a roll-to-roll manner using a die coater and passed through a drying zone at a temperature of 100° C. for 3 minutes. Thereafter, the film was cured by irradiation with ultraviolet rays (cumulative irradiation amount: about 600 mJ/cm²) while being wound around a heat roll heated to 60° C. and conveyed, and then wound up. The thickness of the protective organic layer formed on the support film was 0.1 μm.

A barrier film with a protective organic layer was thus produced as the first base material film and the second base material film.

The barrier film had an oxygen permeability of 4.0×10⁻³ cc/(m²·day·atm) or less in a case where measured using OX-TRAN 2/20 (manufactured by Mocon, Inc.) at a measurement temperature of 23° C. and a relative humidity of 90%.

### (Formation of Resin Layer)

### Preparation of Composition for Forming Resin Layer

The following components were charged into a tank and mixed to prepare composition for forming resin layer.
Triallyl isocyanurate (TYK manufactured by Mitsubishi Chemical Corporation): 27.8 parts by mass
Pentaerythritol tetrakis(3-mercaptopropionate) (PEMP manufactured by SC Organic Chemical Co., Ltd.): 41.8 parts by mass
Light scattering particles (Advanced Alumina AA-1.5 manufactured by Sumitomo Chemical Co., Ltd.): 30.0 parts by mass
Photopolymerization initiator (IRGACURE TPO manufactured by BASF): 0.35 parts by mass
Pyrogallol (Pyrogallol manufactured by Tokyo Chemical Industry Co., Ltd.): 0.035 parts by mass

### Formation of Resin Layer

As a mold for forming a resin layer, a mold having a protrusion corresponding to the recess of the resin layer and a recess corresponding to the wall portion was prepared.

Here, the recess of the resin layer (protrusion of the mold) had a honeycomb-like pattern of regular hexagonal shapes with a side of 125 μm. The depth h of the recess (the height of the protrusion of the mold) was 40 μm, and the interval between the recesses (the interval between the protrusions of the mold (the interval t between the quantum dot-containing parts, that is, the thickness of the wall portion)) was 50 μm (see FIG. 5). The recess of the mold M serving as the wall portion had a curved bottom corner surface with a radius of curvature of 10 μm.

The previously prepared resin layer forming composition was filled so as to completely fill the recess of the mold. Next, the first base material film (barrier film) was stacked on the mold so as to cover the entire surface of the composition for forming resin layer, and the composition for forming resin layer was photocured in a state of being pressed at 0.5 MPa by a laminator. Photocuring of the composition for forming resin layer was performed by 500 mJ/cm² irradiation with ultraviolet rays from the first base material film side using an air-cooled metal halide lamp (manufactured by EYE GRAPHICS CO., LTD.) at 200 W/cm. Thereafter, the mold was removed, and a stack in which a resin layer was stacked on the first base material film was produced (see FIG. 11).

A film having a thickness of 50 μm was formed using the composition for forming resin layer under exactly the same conditions. That is, this film corresponds to a wall portion having a thickness of 50 μm in the resin layer. As a result of measuring the oxygen permeability of this film in the same manner as described above, the oxygen permeability was 1 cc/(m²·day·atm). The elastic modulus of the cured resin layer was measured according to JIS K 7161, and the elastic modulus was 2.5 GPa.

### (Production of Wavelength Conversion Member)

### Preparation of Quantum Dot-Containing Polymerizable Compositions 1 to 6

The following components were charged into a tank and mixed to prepare a quantum dot-containing polymerizable composition.

In the preparation of the quantum dot-containing polymerizable composition, a dispersion liquid of quantum dot 1 (emission maximum: 520 nm) in toluene and a dispersion liquid of quantum dot 2 (emission maximum: 630 nm) in toluene were mixed in such an amount that the total content of the quantum dots in the polymerizable composition was 2.0%.

Quantum dots 1 and 2 are the following semiconductor nanoparticles having a core-shell structure (core: InP/shell: ZnS).
Quantum dot 1: INP530-10 (average particle diameter: 5 to 7 nm) manufactured by NN-Labs
Quantum dot 2: INP620-10 (average particle diameter: 7.5 to 9.5 nm) manufactured by NN-Labs

### Quantum Dot-Containing Polymerizable Composition 1

Dispersion liquid of quantum dots in toluene: 2.0 parts by mass as quantum dots
A-DCP: 35.9 parts by mass
IBXA: 31.3 parts by mass
TIMP: 18.5 parts by mass
β-CEA: 4.63 parts by mass
Pyrogallol: 0.01 parts by mass
Irg TPO: 0.16 parts by mass
Compound listed in Table 3: 1.0 parts by mass (not added in Comparative Example 1)
Inorganic particles listed in Table 3: 7.5 parts by mass

### Quantum Dot-Containing Polymerizable Composition 2

Dispersion liquid of quantum dots in toluene: 2.0 parts by mass as quantum dots
A-DCP: 35.9 parts by mass
IBXA: 31.3 parts by mass
TIMP: 18.5 parts by mass
Acetic acid: 4.63 parts by mass
Pyrogallol: 0.01 parts by mass
Irg TPO: 0.16 parts by mass
Compound listed in Table 3: 1.0 parts by mass
Inorganic particles listed in Table 3: 7.5 parts by mass

### Quantum Dot-Containing Polymerizable Composition 3

Dispersion liquid of quantum dots in toluene: 2.0 parts by mass as quantum dots
A-DCP: 35.9 parts by mass
IBXA: 35.9 parts by mass
PEMP: 18.5 parts by mass
Pyrogallol: 0.01 parts by mass
Irg TPO: 0.16 parts by mass
Compound listed in Table 3: 1.0 parts by mass
Inorganic particles listed in Table 3: 7.5 parts by mass

### Quantum Dot-Containing Polymerizable Composition 4

Dispersion liquid of quantum dots in toluene: 2.0 parts by mass as quantum dots
A-DCP: 35.9 parts by mass
IBXA: 31.3 parts by mass
PEMP: 18.5 parts by mass
3-CEA: 4.63 parts by mass
Pyrogallol: 0.01 parts by mass
Irg TPO: 0.16 parts by mass
Compound listed in Table 3: 1.0 parts by mass
Inorganic particles listed in Table 3: 7.5 parts by mass

### Quantum Dot-Containing Polymerizable Composition 5

Dispersion liquid of quantum dots in toluene: 2.0 parts by mass as quantum dots
A-DCP: 35.9 parts by mass
IBXA: 31.3 parts by mass
PEMP: 18.5 parts by mass
Acetic acid: 4.63 parts by mass
Pyrogallol: 0.01 parts by mass
Irg TPO: 0.16 parts by mass
Compound listed in Table 3: 1.0 parts by mass
Inorganic particles listed in Table 3: 7.5 parts by mass

### Quantum Dot-Containing Polymerizable Composition 6

Dispersion liquid of quantum dots in toluene: 2.0 parts by mass as quantum dots
TAIC: 72.2 parts by mass
PEMP: 18.13 parts by mass
Pyrogallol: 0.01 parts by mass
Irg TPO: 0.16 parts by mass
Compound listed in Table 3: 1.0 parts by mass
Inorganic particles listed in Table 3: 7.5 parts by mass

### Quantum Dot-Containing Polymerizable Composition 7

Quantum dot 3 having coating layer on surface of particle having core-shell structure: 2.0 parts by mass as quantum dots
TAIC: 72.2 parts by mass
PEMP: 18.13 parts by mass
Pyrogallol: 0.01 parts by mass
Irg TPO: 0.16 parts by mass
Compound listed in Table 3: 1.0 parts by mass
Inorganic particles listed in Table 3: 7.5 parts by mass

Quantum dot 3 is a quantum dot obtained by forming a coating layer (surface reforming) on the surfaces of the particles of quantum dot 1 and quantum dot 2 described above by the following procedure.

First, 40 g of quantum dot 1 and 20 g of quantum dot 2 were placed in a 100 mL eggplant flask.

Next, the eggplant flask was connected to a rotary evaporator (N-1300E manufactured by TOKYO RIKAKIKAI CO., LTD.), and the evaporator was operated for 1 hour under the conditions of a constant-temperature bath temperature of 60° C., a pressure of 20 Pa, and a rotary rotation speed of 100 rpm (revolutions per minute) to remove toluene under reduced pressure, whereby 3 g of a quantum dot powder was obtained.

The obtained quantum dot powder was inserted into a powder tray in a vacuum chamber, and then the vacuum chamber was evacuated to 5 Pa by a large dry pump.

Next, the quantum dot powder was heated to 100° C. using a heater during film formation preparation and film formation, and vibration was applied to the quantum dot powder through the powder tray so that uniform film formation was able to be performed during film formation. While vibration was applied to the quantum dot powder, film formation of aluminum oxide (Al₂O₃) as a coating layer was performed by repeating 20 cycles of the following four steps as one cycle.

(1) Introduce water molecules as a first reaction gas to cause OH groups to adsorb onto the outermost surface of the film formation body.

(2) Purge out excess water molecules.

(3) Introduce TMA [trimethyl aluminum: Al(CH₃)₃] gas which is a second reaction gas of the aluminum oxide (Al₂O₃) film. TMA molecules react with OH groups to generate CH₄ gas.

(4) Purge out excess TMA gas and CH₄ gas.

Through the above four steps, an aluminum oxide (Al₂O₃) film having a thickness of about 0.1 nm was formed. After the film formation was completed, the vacuum chamber was opened to the atmosphere.

Quantum dot 3 in which a coating layer of aluminum oxide was formed with a film thickness of about 2 nm on the surface of a particle having a core of InP and a shell of ZnS was thus obtained.

Quantum dot 3 obtained as described above was mixed with the polymerizable composition in such an amount that the content as quantum dots was 2.0 parts by mass, whereby a quantum dot-containing polymerizable composition 7 was obtained.

### Quantum Dot-Containing Polymerizable Composition 8

Quantum dot 4 having coating layer on surface of particle having core-shell structure: 2.0 parts by mass as quantum dots
TAIC: 72.2 parts by mass
PEMP: 18.13 parts by mass
Pyrogallol: 0.01 parts by mass
Irg TPO: 0.16 parts by mass
Compound listed in Table 3: 1.0 parts by mass
Inorganic particles listed in Table 3: 7.5 parts by mass

Quantum dot 4 is a quantum dot obtained by the production method described above for quantum dot 3 except that water molecules were used as a first reaction gas of the coating layer, trichlorosilane [SiH(Cl)] was used as a second reaction gas, and the number of cycles was changed to 30 times. Quantum dot 4 is a quantum dot in which a coating layer of silica is formed with a film thickness of about 2 nm on the surface of a particle having a core of InP and a shell of ZnS.

Quantum dot 4 thus obtained was mixed with the polymerizable composition in such an amount that the content as quantum dots was 2.0 parts by mass, whereby a quantum dot-containing polymerizable composition 8 was obtained.

### Quantum Dot-Containing Polymerizable Composition 9

Dispersion liquid of quantum dots in toluene: 2.0 parts by mass as quantum dots
A-DCP: 35.9 parts by mass
IBXA: 31.3 parts by mass
TMMP: 18.5 parts by mass
β-CEA: 4.63 parts by mass
Pyrogallol: 0.01 parts by mass
Irg TPO: 0.16 parts by mass
Compound listed in Table 3: 0.1 parts by mass
Inorganic particles listed in Table 3: 7.5 parts by mass

Details of the above components are shown in Table 1.

TABLE 1

| Component | Details |
|---|---|
| A-DCP | Tricyclodecanedimethanoldiacrylate, product name |
| | NK ESTETR A-DCP (manufactured by SHIN- |
| | NAKAMURA CHEMICAL CO., LTD.) |
| IBXA | Isobornyl acrylate, product name IBXA (manufactured |
| | by OSAKA ORGANIC CHEMICAL INDUSTRY LTD.) |
| TMMP | Trimethylolpropane tris (3-mercaptopropionate), |
| | product name TMMP (manufactured by SC Organic |
| | Chemical Co., Ltd.) |
| PEMP | Pentaerythritol tetrakis (3-mercaptopropionate), |
| | product name PEMP (manufactured by SC Organic |
| | Chemical Co., Ltd.) |
| Pyrogallol | Product name Pyrogallol (manufactured by Tokyo Chemical |
| | Industry Co., Ltd.) |
| β-CEA | β-Carboxyethyl acrylate, product name β-CEA |
| | (manufactured by DAICEL-ALLNEX LTD.) |
| TAIC | Product name TAIC (manufactured by Mitsubishi |
| | Chemical Corporation) |
| Irg TPO | Product name Irgacure TPO (manufactured by BASF) |

The inorganic particles A listed in Table 3 are alumina particles (product name: Sumicorundum AA-1.5 (manufactured by Sumitomo Chemical Co., Ltd), average particle diameter: 1.50 μm).

The inorganic particles B listed in Table 3 are titanium oxide particles (product name: Ti-Pure R-706 (manufactured by Chemours Company), average particle diameter: 0.36 μm).

### Production of Wavelength Conversion Member

The recess of the resin layer was filled with the quantum dot-containing polymerizable composition so as to completely fill the recess of the resin layer of the stack of the first base material film and the resin layer previously produced. Next, the second base material film (barrier film) was stacked on the resin layer so as to cover the entire surface of the quantum dot-containing polymerizable composition, and the quantum dot-containing polymerizable composition was photocured in a state of being pressed into contact with a laminator at a pressure of 0.3 MPa to form a wavelength conversion layer in which a quantum dot-containing part (cured product obtained by curing the quantum dot-containing polymerizable composition) was formed in the recesses discretely formed in the resin layer, whereby a wavelength conversion member was produced (see FIG. 12). Photocuring of the quantum dot-containing polymerizable composition was performed by 500 mJ/cm² irradiation with ultraviolet rays from the first base material film side using an air-cooled metal halide lamp (manufactured by EYE GRAPHICS CO., LTD.) at 200 W/cm.

The produced wavelength conversion member was cut with a microtome, and a cross section of the cut piece was observed with a SEM. As a result, in this wavelength conversion member, a gap of 0.5 μm was present between the upper end of the wall portion of the resin layer and the second base material film. In addition, excitation light having a wavelength of 405 nm was irradiated, and the distribution of the light emitting particles in the cross section was observed with a confocal laser microscope (TCS SP5 manufactured by Leica) using an objective lens at 50-fold magnification. As a result, it was confirmed that in the wavelength conversion member, a layer (layer including quantum dots) having a thickness of 0.5 μm including quantum dots similar to the quantum dot-containing part formed in the recess of the resin layer was formed between the upper end of the wall portion of the resin layer and the second base material film.

Compounds (P-1) to (P-20) and (Q-1) to (Q-3) listed in Table 3 are compounds synthesized by the following methods, respectively.

In the following description, “PGME” is an abbreviation for “propylene glycol monomethyl ether” and is specifically 1-methoxy-2-propanol.

### Synthesis Example 1

### <Synthesis of Compound (P-1)>

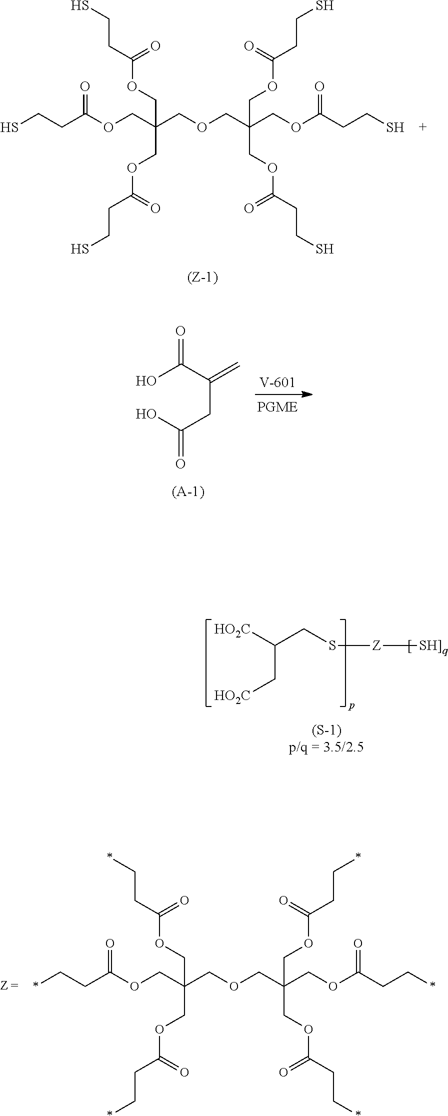

Compound (P-1) was synthesized based on the synthesis method described in paragraphs to [0348] of JP2007-277514A (paragraphs [0289] to [0429] in corresponding US2010/233595A). Specifically, Compound (P-1) was synthesized as follows.

Dipentaerythritol hexakis(3-mercaptopropionate) [(Z-1); manufactured by FUJIFILM Wako Pure Chemical Corporation] in an amount of 25.29 g and 14.71 g of itaconic acid (A-1) were dissolved in 93.33 g of 1-methoxy-2-propanol, and the solution was heated to a liquid temperature of 90° C. under a nitrogen gas stream. The feed ratio at this time was 1.0:3.5 in terms of molar ratio.

To the obtained material, 65 mg dimethyl 2,2′-azobis(2-methylpropionate) [V-601, manufactured by FUJIFILM Wako Pure Chemical Corporation] was added and heated for 2 hours. Further, 65 mg of V-601 was added thereto and reacted at a liquid temperature of 90° C. for 2 hours under a nitrogen gas stream. The obtained material was cooled to room temperature, whereby a 30 mass % solution of a mercaptan compound (S-1) in which Compound (A-1) was added to some of the sulfur atoms of Compound (Z-1) was obtained.

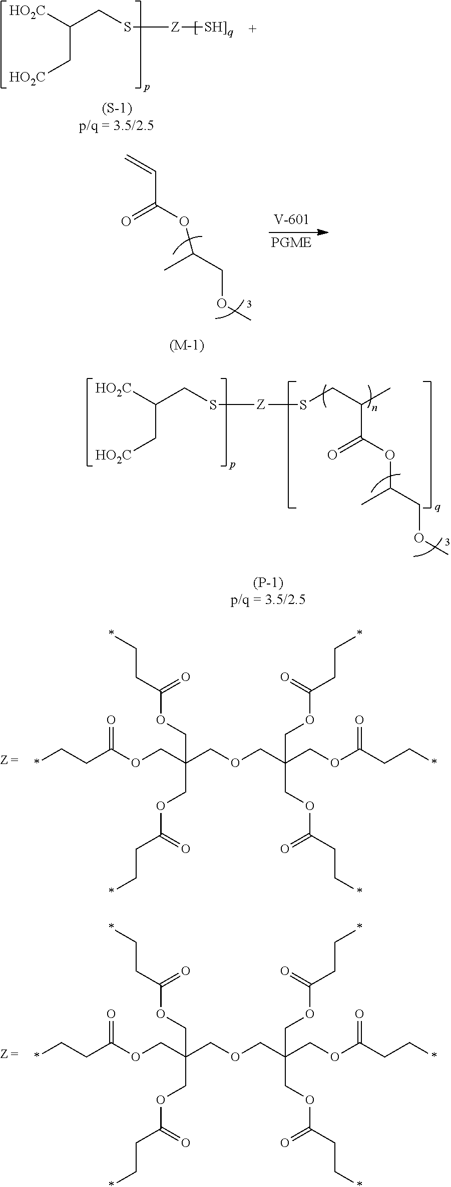

1-Methoxy-2-propanol in an amount of 16.71 g was heated to a liquid temperature of 80° C. under a nitrogen gas stream. A liquid obtained by dissolving 8.69 g of the 30 mass % solution of the mercaptan compound (S-1), 27.39 g of methoxytripropylene glycol acrylate (M-1), and 73 mg of dimethyl 2,2′-azobis(2-methylpropionate) [V-601, manufactured by FUJIFILM Wako Pure Chemical Corporation] in 27.35 g of 1-methoxy-2-propanol was added thereto dropwise for 2.5 hours and then heated at a liquid temperature of 80° C. for 2.5 hours. Further, 73 mg of V-601 was added thereto and reacted at a liquid temperature of 90° C. for 2 hours under a nitrogen gas stream. After the obtained material was cooled to room temperature, 1-methoxy-2-propanol was distilled off with an evaporator, whereby Compound (P-1) (weight-average molecular weight and melting point: see Table 2, acid value 28 mgKOH/g) was obtained. In the structure of Compound (P-1), n is the number of repeating units and is a value that can be calculated from the weight-average molecular weight and the structure. The same applies to n described below. In a case where two pieces of n are included in the structure shown below, the two pieces of n are the same or different from each other.

### Synthesis Example 2

### <Synthesis of Compound (P-2)>

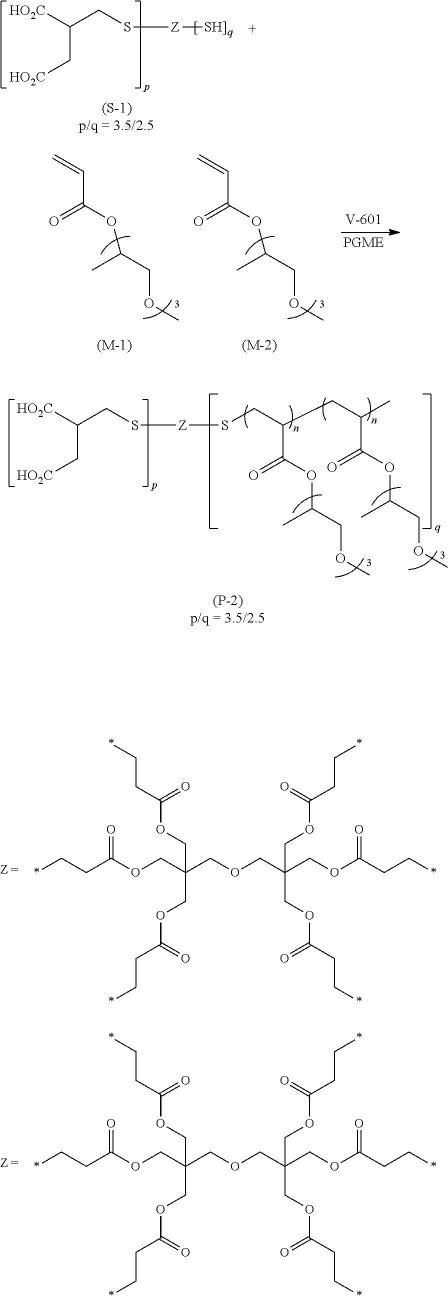

1-Methoxy-2-propanol in an amount of 8.36 g was heated to a liquid temperature of 80° C. under a nitrogen gas stream. A liquid obtained by dissolving 4.72 g of the 30 mass % solution of the mercaptan compound (S-1), 10.6 g of methoxytripropylene glycol acrylate (M-1), 3.03 g of methoxytriethylene glycol acrylate (M-2), and 40 mg of dimethyl 2,2′-azobis(2-methylpropionate) [V-601, manufactured by FUJIFILM Wako Pure Chemical Corporation] in 13.41 g of 1-methoxy-2-propanol was added thereto dropwise for 2.5 hours, and then heated at a liquid temperature of 80° C. for 2.5 hours. Further, 40 mg of V-601 was added thereto and reacted at a liquid temperature of 90° C. for 2 hours under a nitrogen gas stream. After the obtained material was cooled to room temperature, 1-methoxy-2-propanol was distilled off with an evaporator, whereby Compound (P-2) (weight-average molecular weight and melting point: see Table 2, acid value: 30 mgKOH/g) was obtained.

### Synthesis Example 3

### <Synthesis of Compound (P-3)>

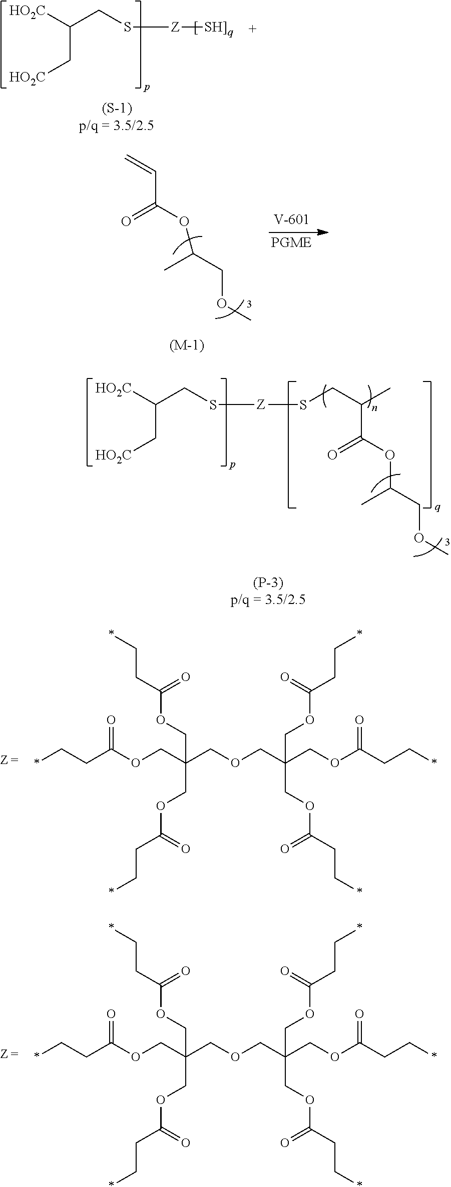

1-Methoxy-2-propanol in an amount of 8.36 g was heated to a liquid temperature of 80° C. under a nitrogen gas stream. A liquid obtained by dissolving 2.03 g of the 30 mass % solution of the mercaptan compound (S-1), 14.39 g of methoxytripropylene glycol acrylate (M-1), and 38 mg of dimethyl 2,2′-azobis(2-methylpropionate) [V-601, manufactured by FUJIFILM Wako Pure Chemical Corporation] in 15.29 g of 1-methoxy-2-propanol was added thereto dropwise for 2.5 hours, and then heated at 80° C. for 2.5 hours. Further, 38 mg of V-601 was added thereto and reacted at a liquid temperature of 90° C. for 2 hours under a nitrogen gas stream. After the obtained material was cooled to room temperature, 1-methoxy-2-propanol was distilled off with an evaporator, whereby Compound (P-3) (weight-average molecular weight and melting point: see Table 2, acid value: 13 mgKOH/g) was obtained.

### Synthesis Example 4

### <Synthesis of Compound (P-4)>

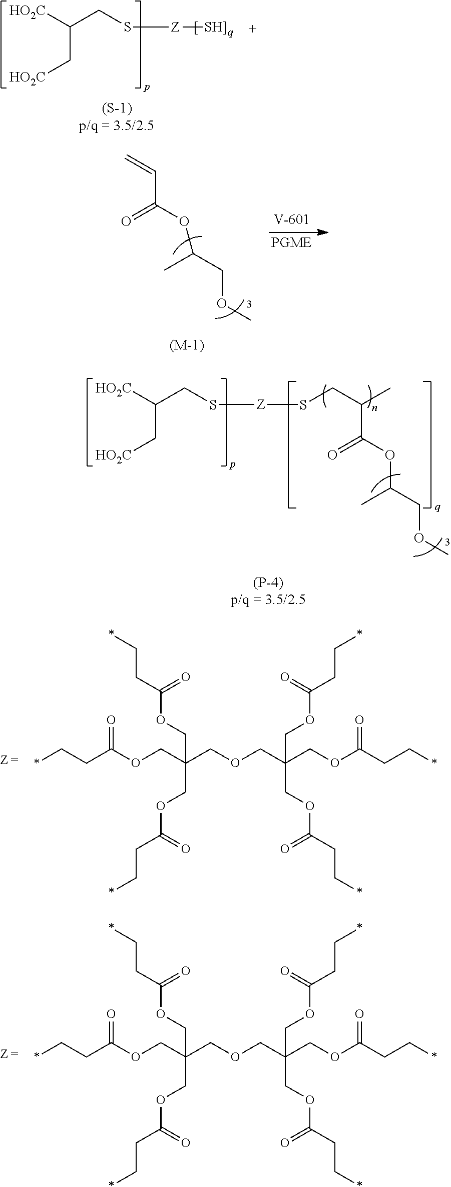

1-Methoxy-2-propanol in an amount of 8.36 g was heated to a liquid temperature of 80° C. under a nitrogen gas stream. A liquid obtained by dissolving 12.04 g of the 30 mass % solution of the mercaptan compound (S-1), 11.39 g of methoxytripropylene glycol acrylate (M-1), and 30 mg of dimethyl 2,2′-azobis(2-methylpropionate) [V-601, manufactured by FUJIFILM Wako Pure Chemical Corporation] in 8.29 g of 1-methoxy-2-propanol was added thereto dropwise for 2.5 hours, and then heated at 80° C. for 2.5 hours. Further, 30 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-4) (weight-average molecular weight and melting point: see Table 2, acid value: 76 mgKOH/g) was obtained.

### Synthesis Example 5

### <Synthesis of Compound (P-5)>

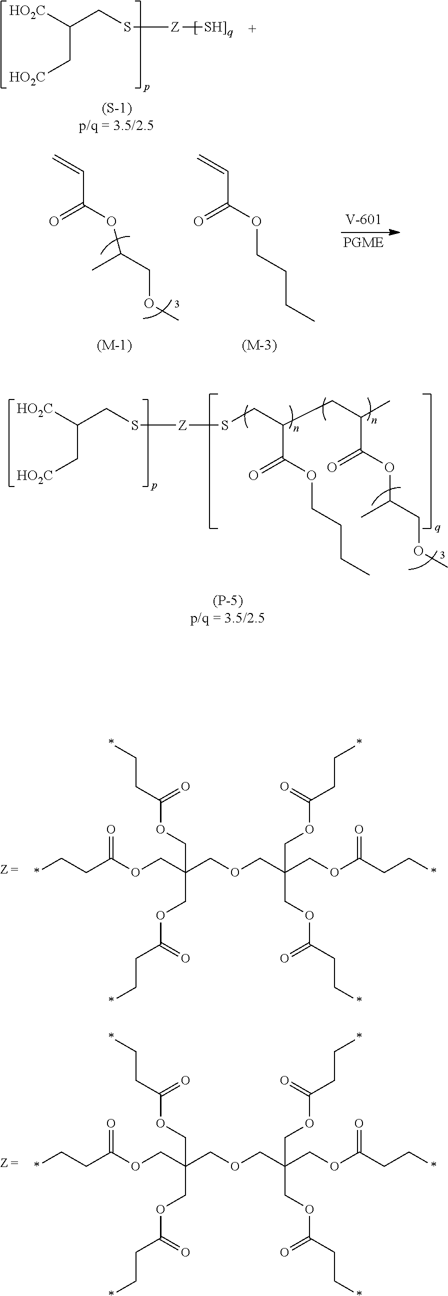

1-Methoxy-2-propanol in an amount of 8.36 g was heated to a liquid temperature of 80° C. under a nitrogen gas stream. A liquid obtained by dissolving 6.30 g of the 30 mass % solution of the mercaptan compound (S-1), 7.28 g of methoxytripropylene glycol acrylate (M-1), 5.82 g of butyl acrylate (M-3), and 53 mg dimethyl 2,2′-azobis(2-methylpropionate) [V-601, manufactured by FUJIFILM Wako Pure Chemical Corporation] in 12.30 g of 1-methoxy-2-propanol was added thereto dropwise for 2.5 hours, and then heated at a liquid temperature of 80° C. for 2.5 hours. Further, 53 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-5) (weight-average molecular weight and melting point: see Table 2, acid value: 40 mgKOH/g) was obtained.

### Synthesis Example 6

### <Synthesis of Compound (P-6)>

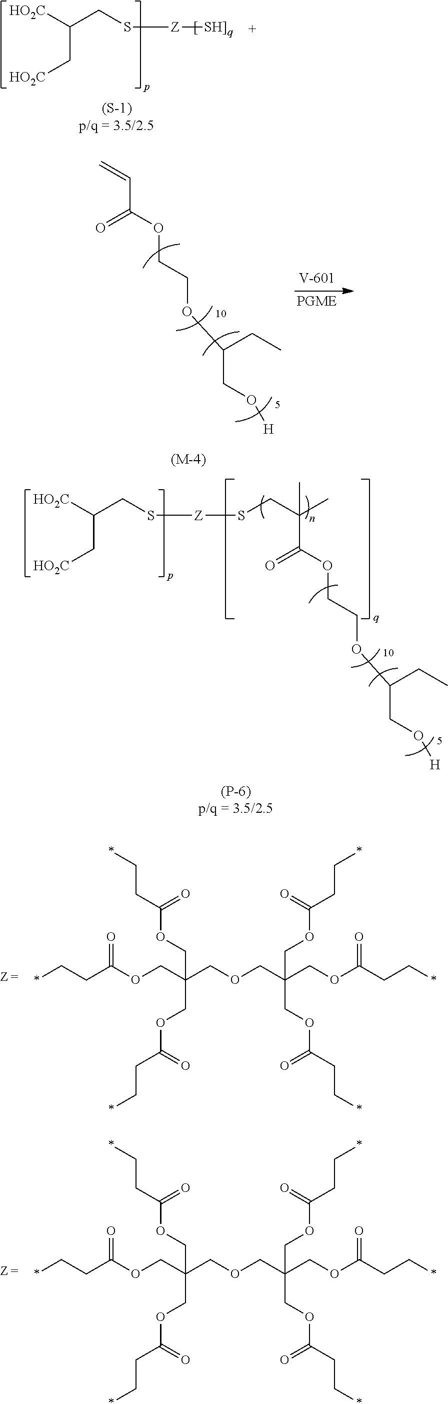

1-Methoxy-2-propanol in an amount of 8.36 g was heated to a liquid temperature of 80° C. under a nitrogen gas stream. A liquid obtained by dissolving 5.02 g of the 30 mass % solution of the mercaptan compound (S-1), 13.49 g of polyethylene glycol-polybutylene glycol monomethacrylate (M-4, 55PET-800 manufactured by NOF Corporation), and 11 mg of dimethyl 2,2′-azobis(2-methylpropionate) [V-601, manufactured by FUJIFILM Wako Pure Chemical Corporation] in 13.2 g of 1-methoxy-2-propanol was added thereto dropwise for 2.5 hours, and then heated at a liquid temperature of 80° C. for 2.5 hours. Further, 11 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-6) (weight-average molecular weight and melting point: see Table 2, acid value: 32 mgKOH/g) was obtained.

### Synthesis Example 7

### <Synthesis of Compound (P-7)>

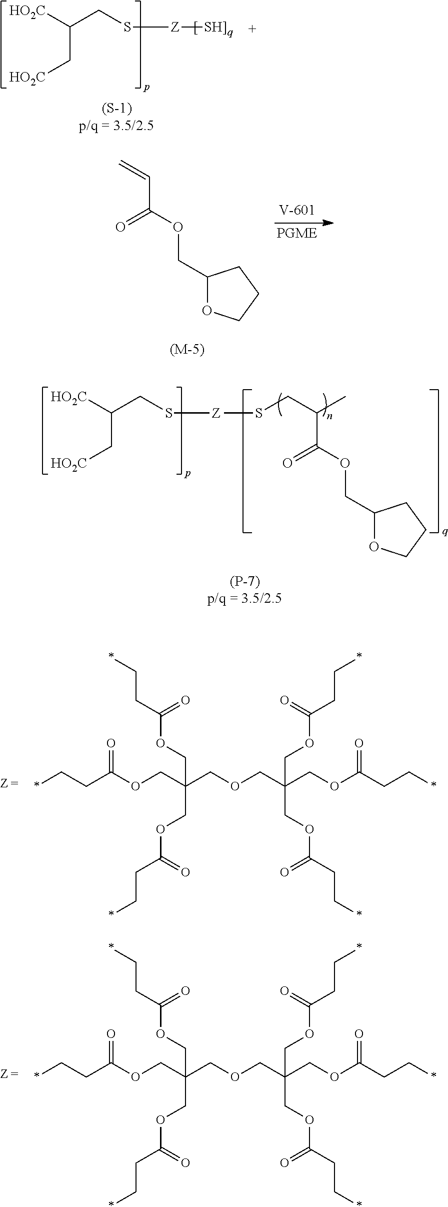

1-Methoxy-2-propanol in an amount of 7.52 g was heated to a liquid temperature of 80° C. under a nitrogen gas stream. A liquid obtained by dissolving 6.84 g of the 30 mass % solution of the mercaptan compound (S-1), 12.95 g of tetrahydrofurfuryl acrylate (M-5), and 57 mg of dimethyl 2,2′-azobis(2-methylpropionate) [V-601, manufactured by FUJIFILM Wako Pure Chemical Corporation] in 11.92 g of 1-methoxy-2-propanol was added thereto dropwise for 2.5 hours, and then heated at a liquid temperature of 80° C. for 2.5 hours. Further, 57 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-7) (weight-average molecular weight and melting point: see Table 2, acid value: 43 mgKOH/g) was obtained.

### Synthesis Example 8

### <Synthesis of Compound (P-8)>

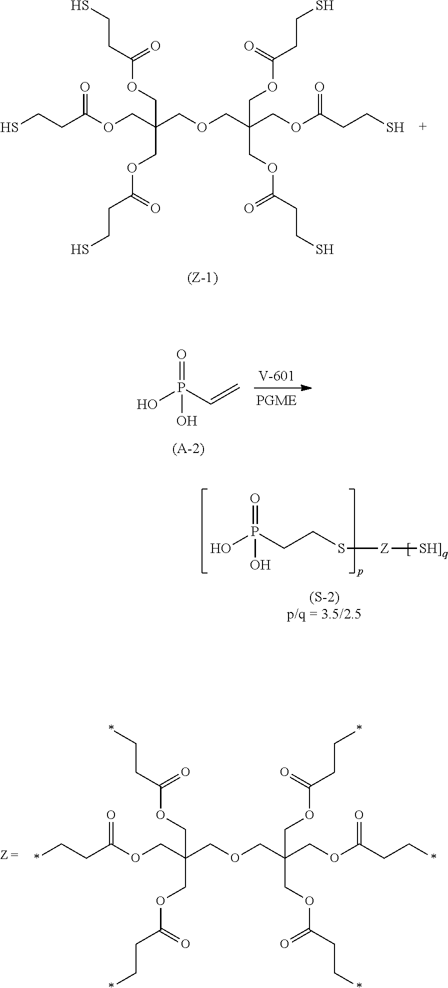

Dipentaerythritol hexakis(3-mercaptopropionate) [(Z-1); manufactured by FUJIFILM Wako Pure Chemical Corporation] in an amount of 20.23 g and 9.77 g of vinylphosphonic acid (A-2) were dissolved in 70 g of 1-methoxy-2-propanol, and the solution was heated to a liquid temperature of 90° C. under a nitrogen gas stream. The feed ratio at this time was 1.0:3.5 in terms of molar ratio.

To the obtained material, 52 mg of dimethyl 2,2′-azobis(2-methylpropionate) [V-601, manufactured by FUJIFILM Wako Pure Chemical Corporation] was added and heated for 2 hours. Further, 52 mg of V-601 was added thereto and reacted at a liquid temperature of 90° C. for 2 hours under a nitrogen gas stream. The obtained material was cooled to room temperature, whereby a 30 mass % solution of a mercaptan compound (S-2) in which Compound (A-2) was added to some of the sulfur atoms of Compound (Z-1) was obtained.

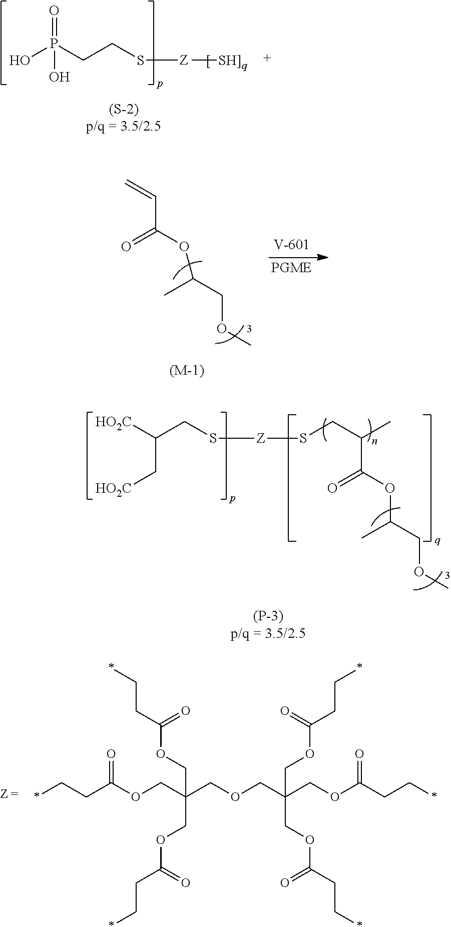

1-Methoxy-2-propanol in an amount of 16.71 g was heated to a liquid temperature of 80° C. under a nitrogen gas stream. A liquid obtained by dissolving 8.19 g of the 30 mass % solution of the mercaptan compound (S-2), 27.54 g of methoxytripropylene glycol acrylate (M-1), and 73 mg of dimethyl 2,2′-azobis(2-methylpropionate) [V-601, manufactured by FUJIFILM Wako Pure Chemical Corporation] in 27.70 g of 1-methoxy-2-propanol was added thereto dropwise for 2.5 hours, and then heated at a liquid temperature of 80° C. for 2.5 hours. Further, 73 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-8) (weight-average molecular weight and melting point: see Table 2, acid value: 14 mgKOH/g) was obtained.

### Synthesis Example 9

### <Synthesis of Compound (P-9)>

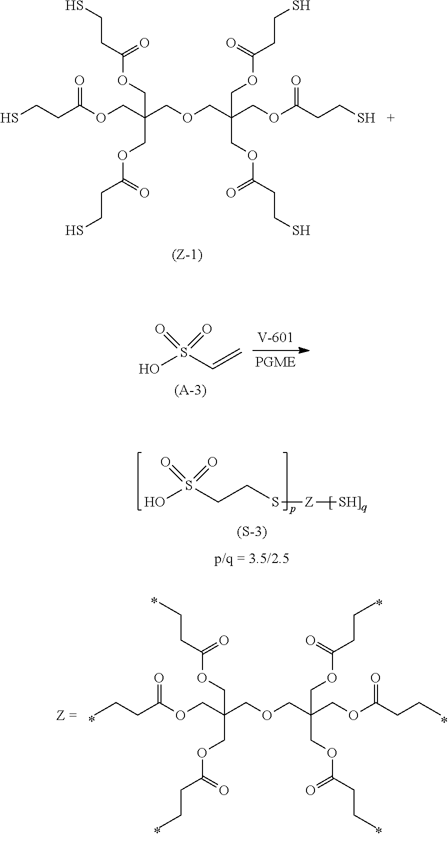

Dipentaerythritol hexakis(3-mercaptopropionate) [(Z-1); manufactured by FUJIFILM Wako Pure Chemical Corporation] in an amount of 20.23 g and 9.77 g vinylsulfonic acid (a-3) were dissolved in 70 g of 1-methoxy-2-propanol, and the solution was heated to a liquid temperature of 90° C. under a nitrogen gas stream. The feed ratio at this time was 1.0:3.5 in terms of molar ratio.

To the obtained material, 52 mg of dimethyl 2,2′-azobis(2-methylpropionate) [V-601, manufactured by FUJIFILM Wako Pure Chemical Corporation] was added and heated for 2 hours. Further, 52 mg of V-601 was added thereto and reacted at a liquid temperature of 90° C. for 2 hours under a nitrogen gas stream. The obtained material was cooled to room temperature, whereby a 30 mass % solution of a mercaptan compound (S-3) in which Compound (A-2) was added to some of the sulfur atoms of Compound (Z-1) was obtained.

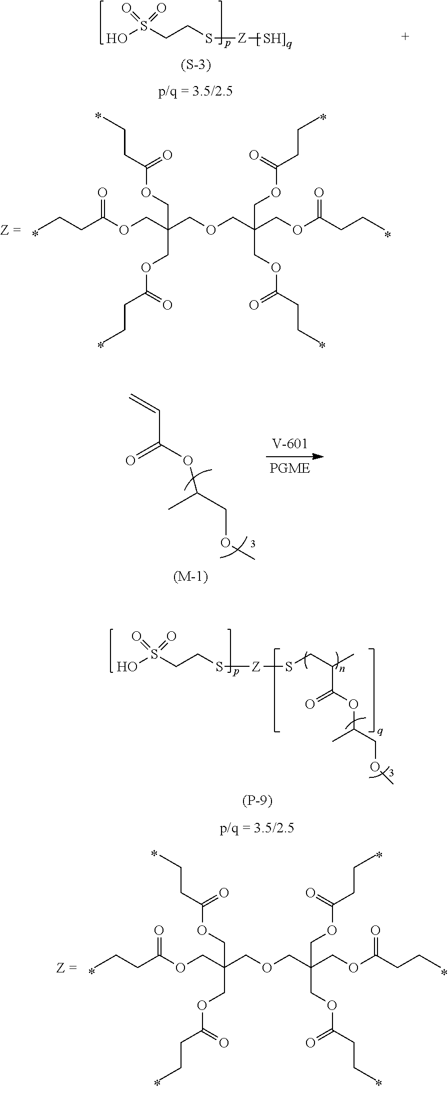

1-Methoxy-2-propanol in an amount of 16.71 g was heated to a liquid temperature of 80° C. under a nitrogen gas stream. A liquid obtained by dissolving 8.19 g of the 30 mass % solution of the mercaptan compound (S-3), 27.54 g of methoxytripropylene glycol acrylate (M-1), and 73 mg of dimethyl 2,2′-azobis(2-methylpropionate) [V-601, manufactured by FUJIFILM Wako Pure Chemical Corporation] in 27.69 g of 1-methoxy-2-propanol was added thereto dropwise for 2.5 hours, and then heated at a liquid temperature of 80° C. for 2.5 hours. Further, 73 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-9) (weight-average molecular weight and melting point: see Table 2, acid value: 14 mgKOH/g) was obtained.

### Synthesis Example 10

### <Synthesis of Compound (P-10)>

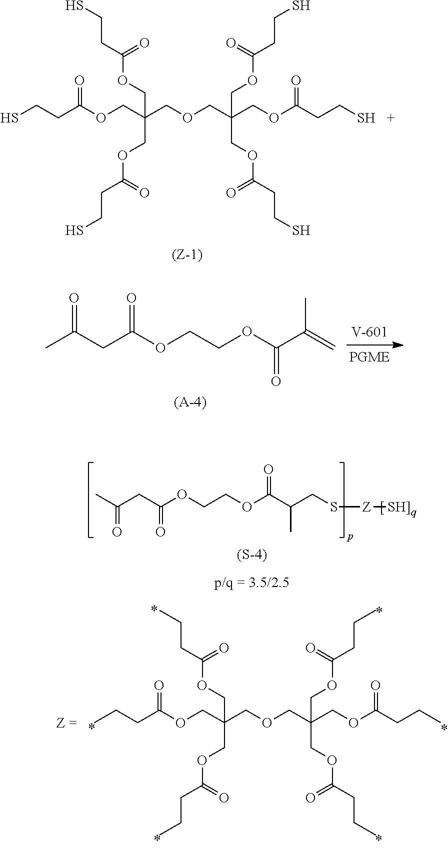

Dipentaerythritol hexakis(3-mercaptopropionate) [(Z-1); manufactured by FUJIFILM Wako Pure Chemical Corporation] in an amount of 15.33 g and 14.67 g of 2-(methacryloyloxy) ethyl acetoacetate (A-4) were dissolved in 70 g of 1-methoxy-2-propanol, and the solution was heated to a liquid temperature of 90° C. under a nitrogen gas stream. The feed ratio at this time was 1.0:3.5 in terms of molar ratio.

To the obtained material, 39 mg dimethyl 2,2′-azobis(2-methylpropionate) [V-601, manufactured by FUJIFILM Wako Pure Chemical Corporation] was added and heated for 2 hours. Further, 39 mg of V-601 was added thereto and reacted at a liquid temperature of 90° C. for 2 hours under a nitrogen gas stream. The obtained material was cooled to room temperature, whereby a 30 mass % solution of a mercaptan compound (S-4) in which Compound (A-4) was added to some of the sulfur atoms of Compound (Z-1) was obtained.

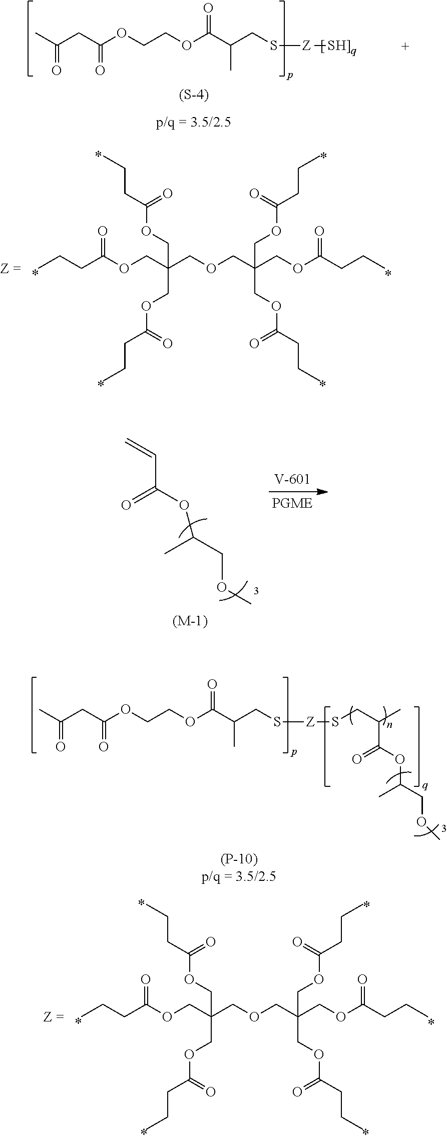

1-Methoxy-2-propanol in an amount of 16.71 g was heated to a liquid temperature of 80° C. under a nitrogen gas stream. A liquid obtained by dissolving 10.54 g of the 30 mass % solution of the mercaptan compound (S-4), 26.84 g of methoxytripropylene glycol acrylate (M-1), and 71 mg of dimethyl 2,2′-azobis(2-methylpropionate) [V-601, manufactured by FUJIFILM Wako Pure Chemical Corporation] in 26.05 g of 1-methoxy-2-propanol was added thereto dropwise for 2.5 hours, and then heated at a liquid temperature of 80° C. for 2.5 hours. Further, 71 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-10) (weight-average molecular weight and melting point: see Table 2, acid value: 13 mgKOH/g) was obtained.

### Synthesis Example 11

### <Synthesis of Compound (P-11)>

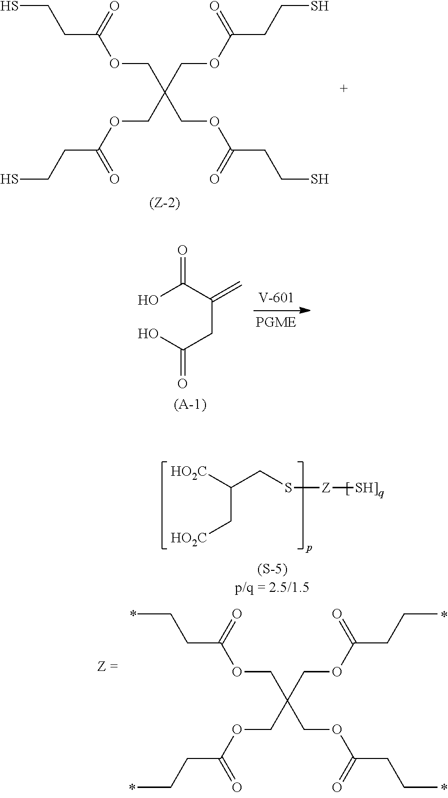

Pentaerythritol tetra(3-mercaptopropionate) [(Z-2); manufactured by FUJIFILM Wako Pure Chemical Corporation] in an amount of 18.01 g and 11.99 g of itaconic acid (A-1) were dissolved in 70 g of 1-methoxy-2-propanol, and the solution was heated to a liquid temperature of 90° C. under a nitrogen gas stream. The feed ratio at this time was 1.0:2.5 in terms of molar ratio.

To the obtained material, 53 mg of dimethyl 2,2′-azobis(2-methylpropionate) [V-601, manufactured by FUJIFILM Wako Pure Chemical Corporation] was added and heated for 2 hours. Further, 53 mg of V-601 was added thereto and reacted at a liquid temperature of 90° C. for 2 hours under a nitrogen gas stream. The obtained material was cooled to room temperature, whereby a 30 mass % solution of a mercaptan compound (S-5) in which Compound (A-1) was added to some of the sulfur atoms of Compound (Z-2) was obtained.

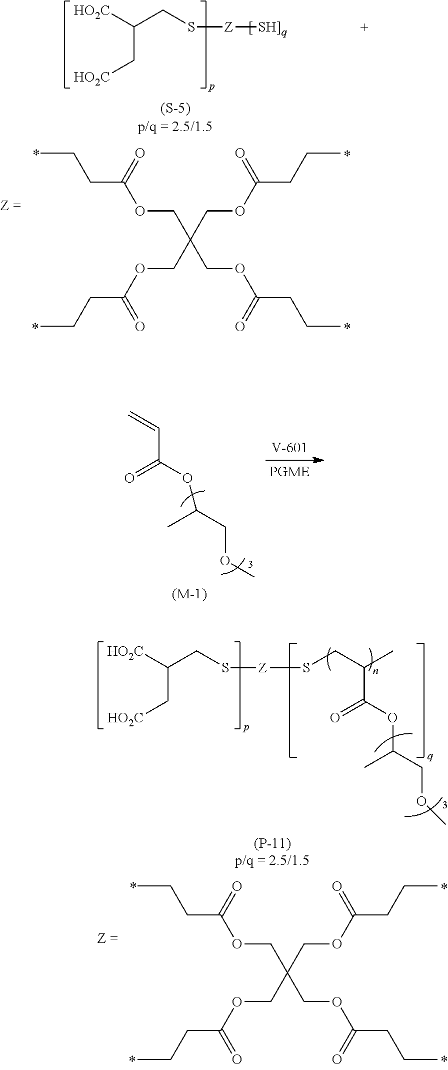

1-Methoxy-2-propanol in an amount of 16.71 g was heated to a liquid temperature of 80° C. under a nitrogen gas stream. A liquid obtained by dissolving 9.44 g of the 30 mass % solution of the mercaptan compound (S-5), 27.17 g of methoxytripropylene glycol acrylate (M-1), and 72 mg of dimethyl 2,2′-azobis(2-methylpropionate) [V-601, manufactured by FUJIFILM Wako Pure Chemical Corporation] in 26.82 g of 1-methoxy-2-propanol was added thereto dropwise for 2.5 hours, and then heated at a liquid temperature of 80° C. for 2.5 hours. Further, 72 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-11) (weight-average molecular weight and melting point: see Table 2, acid value: 33 mgKOH/g) was obtained.

### Synthesis Example 12

### <Synthesis of Compound (P-12)>

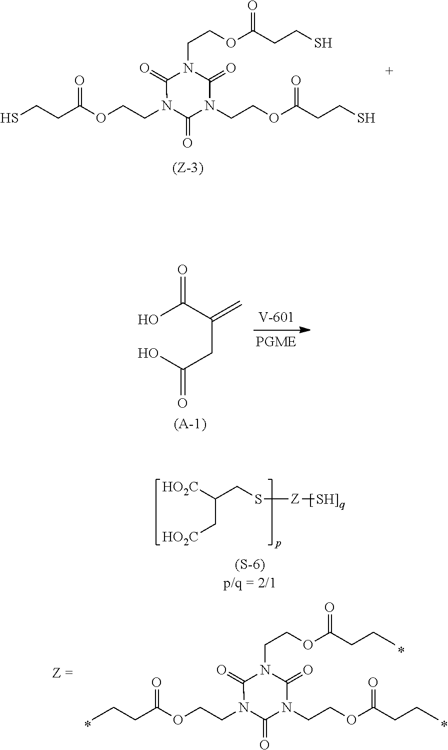

Tris[2-(3-mercaptopropionyloxy)ethyl] isocyanuric acid [(Z-3); manufactured by Tokyo Chemical Industry Co., Ltd] in an amount of 20.07 g and 9.93 g of itaconic acid (A-1) were dissolved in 70 g of 1-methoxy-2-propanol and heated to a liquid temperature of 90° C. under a nitrogen gas stream. The feed ratio at this time was 1.0:2.0 in terms of molar ratio.

To the obtained material, 44 mg dimethyl 2,2′-azobis(2-methylpropionate) [V-601, manufactured by FUJIFILM Wako Pure Chemical Corporation] was added and heated for 2 hours. Further, 44 mg of V-601 was added thereto and reacted at a liquid temperature of 90° C. for 2 hours under a nitrogen gas stream. The obtained material was cooled to room temperature, whereby a 30 mass % solution of a mercaptan compound (S-6) in which Compound (A-1) was added to some of the sulfur atoms of Compound (Z-3) was obtained.

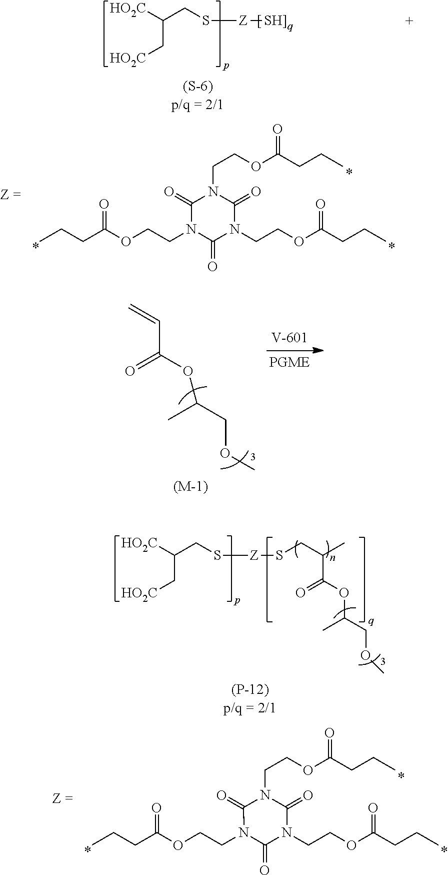

1-Methoxy-2-propanol in an amount of 16.71 g was heated to a liquid temperature of 80° C. under a nitrogen gas stream. A liquid obtained by dissolving 13.11 g of the 30 mass % solution of the mercaptan compound (S-6), 26.07 g of methoxytripropylene glycol acrylate (M-1), and 69 mg of dimethyl 2,2′-azobis(2-methylpropionate) [V-601, manufactured by FUJIFILM Wako Pure Chemical Corporation] in 24.25 g of 1-methoxy-2-propanol was added thereto dropwise for 2.5 hours, and then heated at a liquid temperature of 80° C. for 2.5 hours. Further, 69 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-12) (weight-average molecular weight and melting point: see Table 2, acid value: 37 mgKOH/g) was obtained.

### Synthesis Example 13

### <Synthesis of Compound (P-13)>

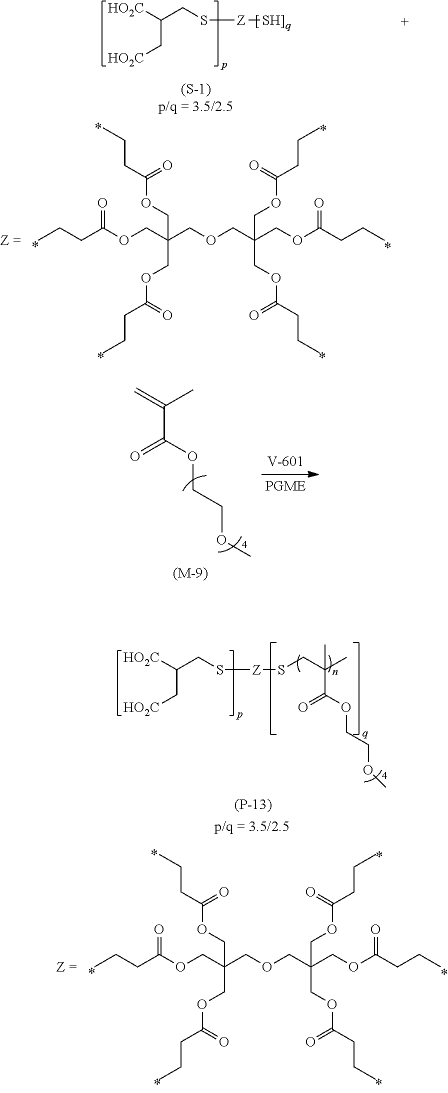

1-Methoxy-2-propanol in an amount of 16.71 g was heated to a liquid temperature of 80° C. under a nitrogen gas stream. A liquid obtained by dissolving 15.2 g of the 30 mass % solution of the mercaptan compound (S-1), 25.44 g of PME-200 (M-9) manufactured by NOF Corporation, and 64 mg of dimethyl 2,2′-azobis(2-methylpropionate) [V-601, manufactured by FUJIFILM Wako Pure Chemical Corporation] in 22.79 g of 1-methoxy-2-propanol was added thereto dropwise for 2.5 hours, and then heated at a liquid temperature of 80° C. for 2.5 hours. Further, 64 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-13) (weight-average molecular weight and melting point: see Table 2, acid value: 48 mgKOH/g) was obtained.

### Synthesis Example 14

### <Synthesis of Compound (P-14)>

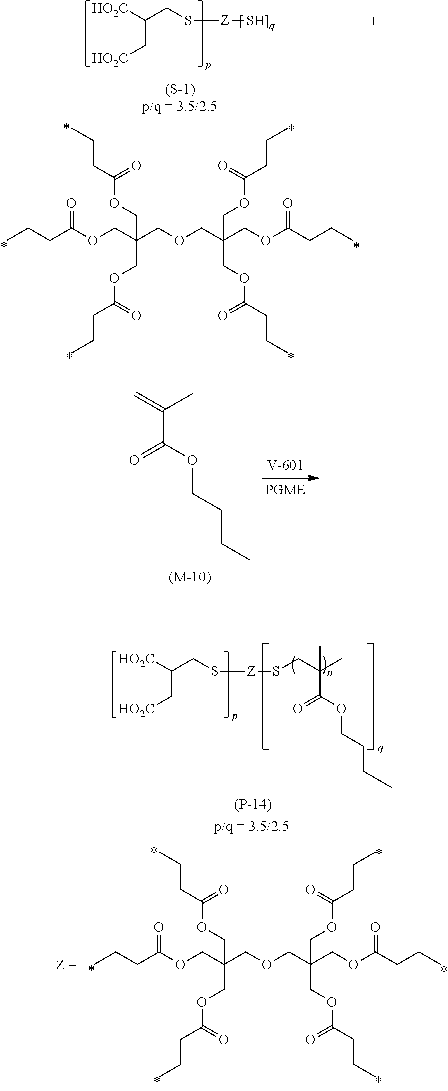

1-Methoxy-2-propanol in an amount of 16.71 g was heated to a liquid temperature of 80° C. under a nitrogen gas stream. A liquid obtained by dissolving 18.85 g of the 30 mass % solution of the mercaptan compound (S-1), 24.35 g of butyl methacrylate (M-10), and 118 mg of dimethyl 2, 2′-azobis(2-methylpropionate) [V-601, manufactured by FUJIFILM Wako Pure Chemical Corporation] in 27.35 g of 1-methoxy-2-propanol was added thereto dropwise for 2.5 hours, and then heated at a liquid temperature of 80° C. for 2.5 hours. Further, 118 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-14) (weight-average molecular weight and melting point: see Table 2, acid value: 60 mgKOH/g) was obtained.

### Synthesis Example 15

### <Synthesis of Compound (P-15)>

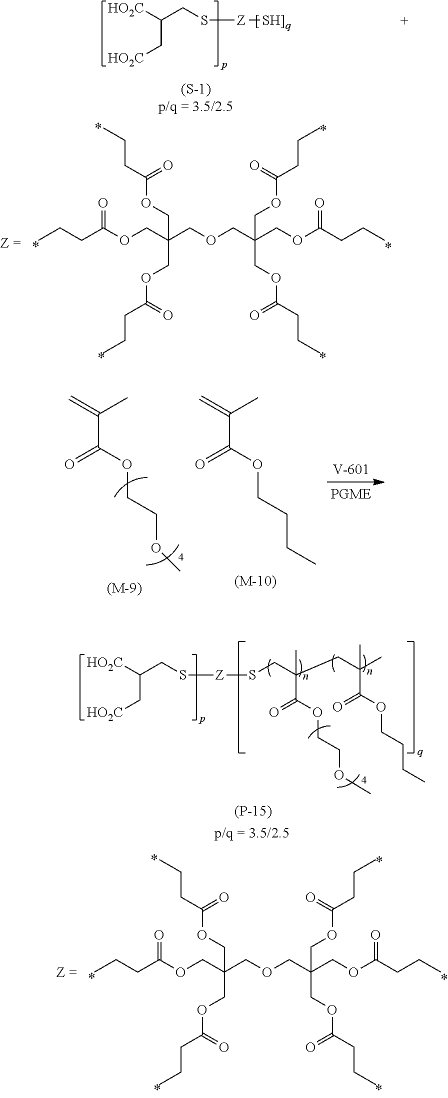

1-Methoxy-2-propanol in an amount of 16.71 g was heated to a liquid temperature of 80° C. under a nitrogen gas stream. A liquid obtained by dissolving 14.96 g the 30 mass % of the solution of the mercaptan compound (S-1), 12.76 g of PME-200 (M-9) manufactured by NOF Corporation, 12.76 g of butyl methacrylate (M-10), and 94 mg of dimethyl 2,2′-azobis(2-methylpropionate) [V-601, manufactured by FUJIFILM Wako Pure Chemical Corporation] in 22.96 g of 1-methoxy-2-propanol was added thereto dropwise for 2.5 hours, and then heated at a liquid temperature of 80° C. for 2.5 hours. Further, 94 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-15) (weight-average molecular weight and melting point: see Table 2, acid value: 47 mgKOH/g) was obtained.

### Synthesis Example 16

### <Synthesis of Compound (P-16)>

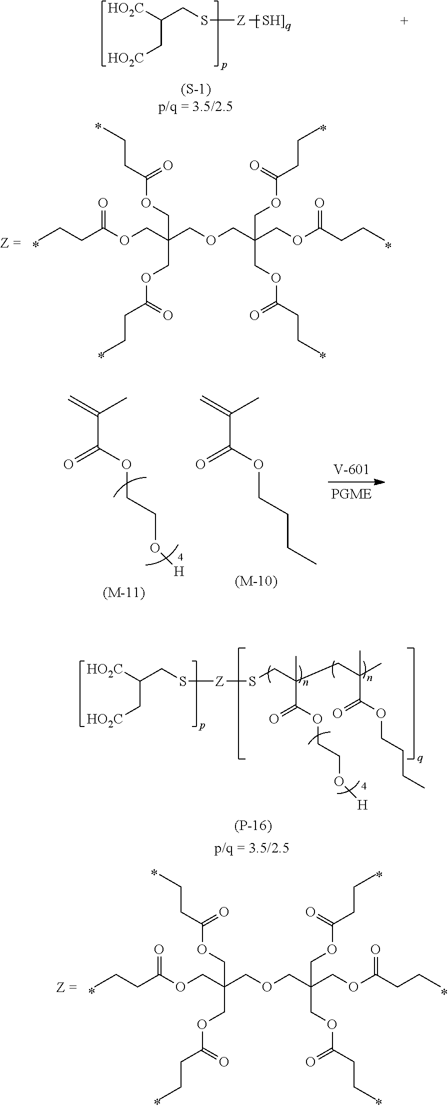

1-Methoxy-2-propanol in an amount of 16.71 g was heated to a liquid temperature of 80° C. under a nitrogen gas stream. A liquid obtained by dissolving 15.06 g of the 30 mass % solution of the mercaptan compound (S-1), 12.74 g of AE-200 (M-11) manufactured by NOF Corporation, 12.74 g of butyl methacrylate (M-10), and 94 mg of dimethyl 2,2′-azobis(2-methylpropionate) [V-601, manufactured by FUJIFILM Wako Pure Chemical Corporation] in 22.89 g 1-methoxy-2-propanol was added thereto dropwise for 2.5 hours, and then heated at a liquid temperature of 80° C. for 2.5 hours. Further, 94 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-16) (weight-average molecular weight and melting points: see Table 2, acid value: 48 mgKOH/g) was obtained.

### Synthesis Example 17

### <Synthesis of Compound (P-17)>

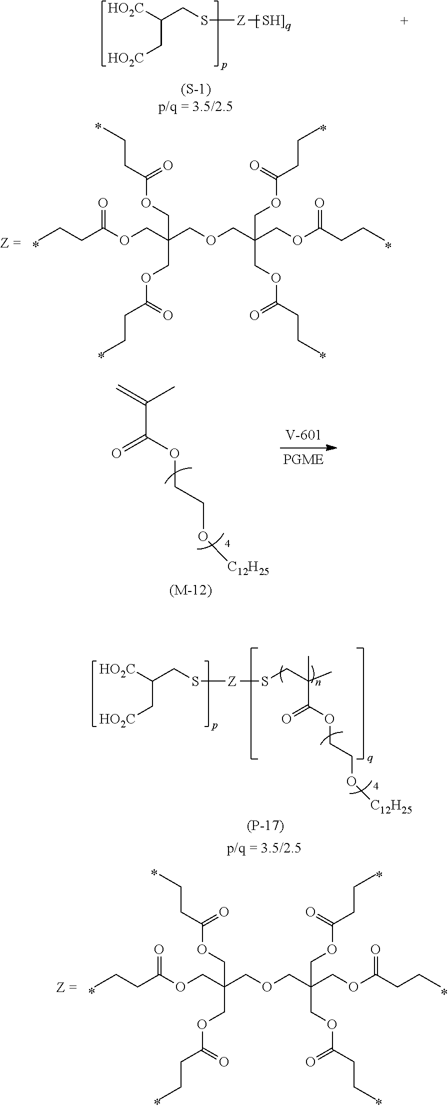

1-Methoxy-2-propanol in an amount of 16.71 g was heated to a liquid temperature of 80° C. under a nitrogen gas stream. A liquid obtained by dissolving 7.08 g of the 30 mass % solution of the mercaptan compound (S-1), 27.88 g of PLE-1300 (M-12) manufactured by NOF Corporation, and 15 mg of dimethyl 2,2′-azobis(2-methylpropionate) [V-601, manufactured by FUJIFILM Wako Pure Chemical Corporation] in 28.47 g of 1-methoxy-2-propanol was added thereto dropwise for 2.5 hours, and then heated at a liquid temperature of 80° C. for 2.5 hours. Further, 15 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-17) (weight-average molecular weight and melting point: see Table 2, acid value: 22 mgKOH/g) was obtained.

### Synthesis Example 18

### <Synthesis of Compound (P-18)>

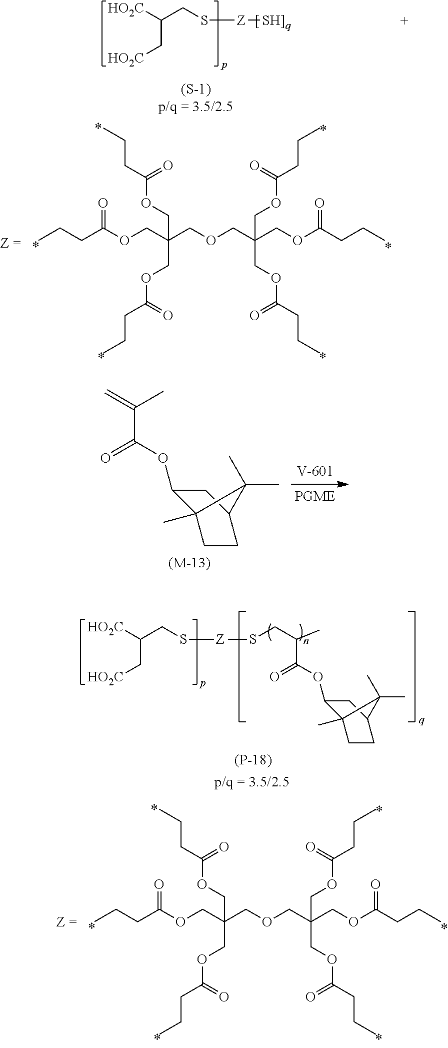

1-Methoxy-2-propanol in an amount of 16.71 g was heated to a liquid temperature of 80° C. under a nitrogen gas stream. A liquid obtained by dissolving 10.63 g of the 30 mass % solution of the mercaptan compound (S-1), 26.81 g of isobornyl acrylate (M-13), and 89 mg of dimethyl 2,2′-azobis(2-methylpropionate) [V-601, manufactured by FUJIFILM Wako Pure Chemical Corporation] in 22.96 g of 1-methoxy-2-propanol was added thereto dropwise for 2.5 hours, and then heated at a liquid temperature of 80° C. for 2.5 hours. Further, 89 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-18) (weight-average molecular weight and melting point: see Table 2, acid value: 34 mgKOH/g) was obtained.

### Synthesis Example 19

### <Synthesis of Compound (P-19)>

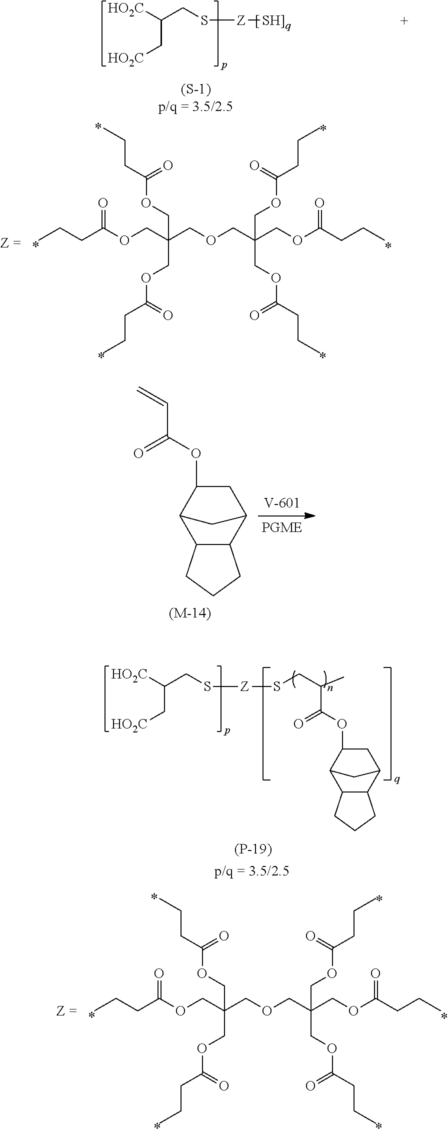

1-Methoxy-2-propanol in an amount of 16.71 g was heated to a liquid temperature of 80° C. under a nitrogen gas stream. A liquid obtained by dissolving 10.72 g of the 30 mass % solution of the mercaptan compound (S-1), 26.78 g of dicyclopentanyl acrylate (M-14), and 90 mg of dimethyl 2,2′-azobis(2-methylpropionate) [V-601, manufactured by FUJIFILM Wako Pure Chemical Corporation] in 25.93 g of 1-methoxy-2-propanol was added thereto dropwise for 2.5 hours, and then heated at a liquid temperature of 80° C. for 2.5 hours. Further, 90 mg of V-601 was further added thereto and reacted at a liquid temperature of 90° C. for 2 hours under a nitrogen gas stream. After the solution was cooled to room temperature, 1-methoxy-2-propanol was distilled off with an evaporator, whereby Compound (P-19) (weight-average molecular weight and melting point: see Table 2, acid value: 34 mgKOH/g) was obtained.

### Synthesis Example 20

### <Synthesis of Compound (P-20)>

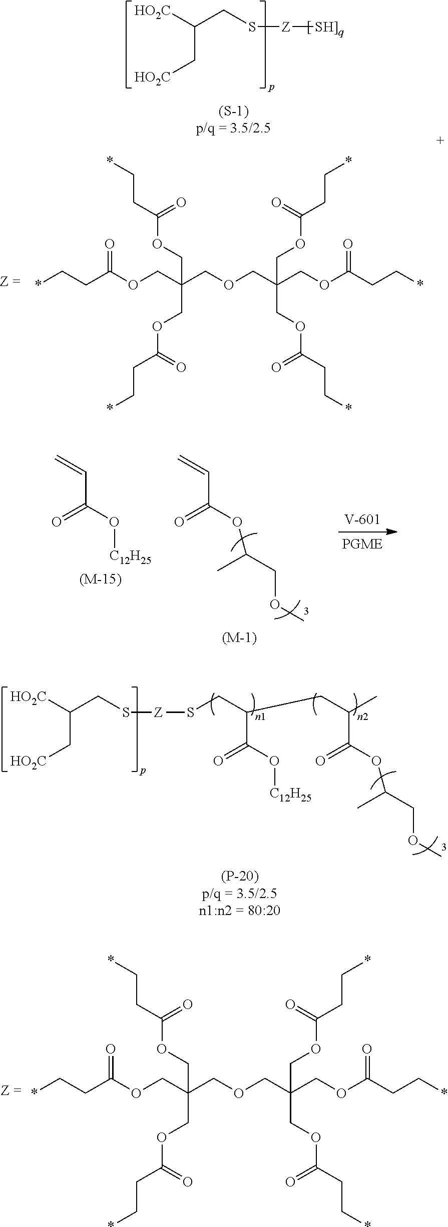

1-Methoxy-2-propanol in an amount of 16.71 g was heated to a liquid temperature of 80° C. under a nitrogen gas stream. A liquid obtained by dissolving 9.2 g of the 30 mass % solution of the mercaptan compound (S-1), 21.52 g of dodecylacrylate (M-15), 5.72 g of methoxytripropylene glycol acrylate (M-1), and 77 mg of dimethyl 2,2′-azobis(2-methylpropionate) [V-601, manufactured by FUJIFILM Wako Pure Chemical Corporation] in 26.99 g of 1-methoxy-2-propanol was added thereto dropwise for 2.5 hours, and then heated at a liquid temperature of 80° C. for 2.5 hours. Further, 77 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (P-20) (weight-average molecular weight and melting point: see Table 2, acid value: 29 mgKOH/g) was obtained.

### Synthesis Example 21

### <Synthesis of Compound (P-21)>

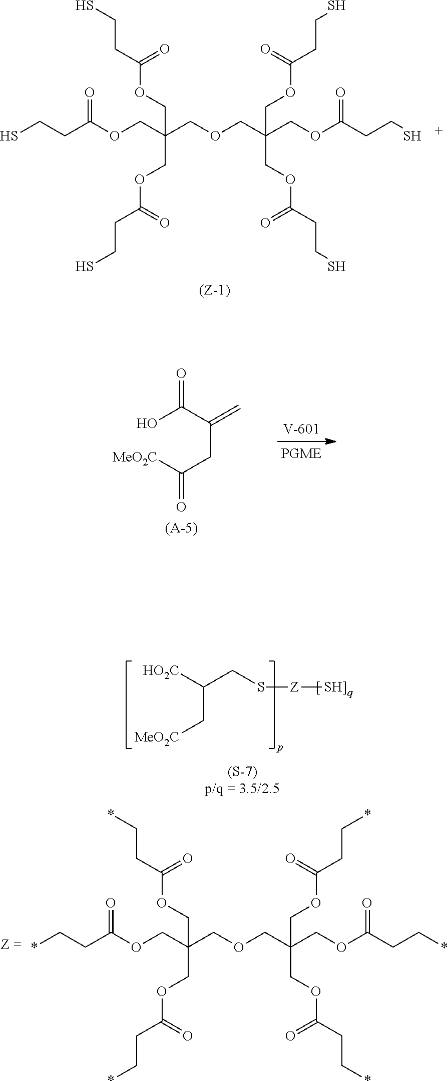

Dipentaerythritol hexakis(3-mercaptopropionate) [(Z-1); manufactured by SC Organic Chemical Co., Ltd.] in an amount of 18.25 g and 11.75 g of monomethylitaconate (A-5) were dissolved in 70.0 g of 1-methoxy-2-propanol and heated to a liquid temperature of 90° C. under a nitrogen gas stream. The feed ratio at this time was 1.0:3.5 in terms of molar ratio. To the obtained material, 47 mg of dimethyl 2,2′-azobis(2-methylpropionate) [V-601, manufactured by FUJIFILM Wako Pure Chemical Corporation] was added and heated for 2 hours. Further, 47 mg of V-601 was added thereto and reacted at a liquid temperature of 90° C. for 2 hours under a nitrogen gas stream. The obtained material was cooled to room temperature, whereby a 30 mass % solution of a mercaptan compound (S-7) in which Compound (A-5) was added to some of the sulfur atoms of Compound (Z-1) was obtained.

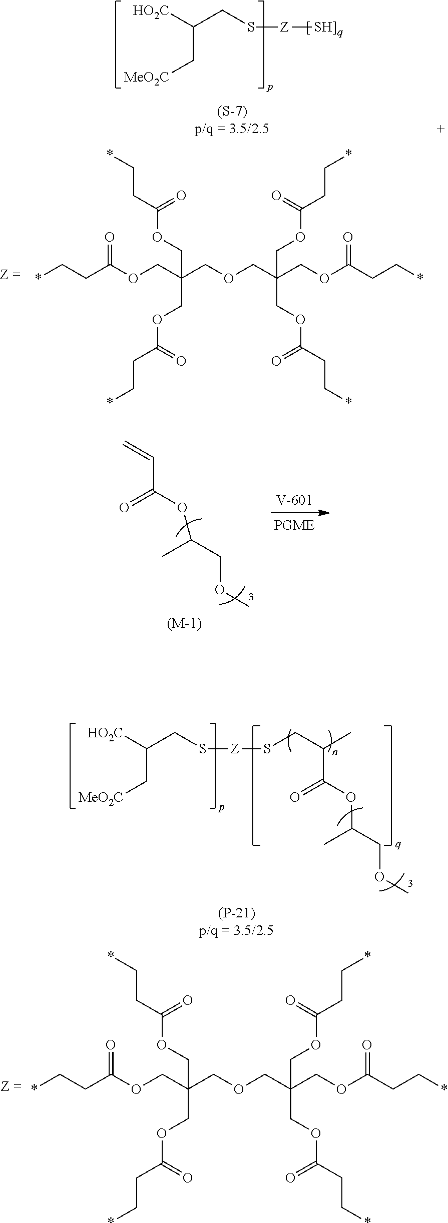

1-Methoxy-2-propanol in an amount of 16.71 g was heated to 80° C. under nitrogen gas stream. A liquid obtained by dissolving 28.35 g of the 30 mass % solution of the mercaptan compound (S-7), 21.50 g of methoxytripropylene glycol acrylate (M-1), and 57 mg of dimethyl 2,2′-azobis(2-methylpropionate) [V-601, manufactured by FUJIFILM Wako Pure Chemical Corporation] in 19.16 g of 1-methoxy-2-propanol was added thereto dropwise for 2.5 hours, and then heated at a liquid temperature of 80° C. for 2.5 hours. Further, 57 mg of V-601 was added thereto and reacted at a liquid temperature of 90° C. for 2 hours under a nitrogen gas stream. After the solution was cooled to room temperature, 1-methoxy-2-propanol was distilled off under reduced pressure at 60° C., 20 g of methanol was added thereto, and then distillation was performed again under reduced pressure at 60° C., whereby Compound (P-21) (weight-average molecular weight and melting point: see Table 2, acid value: 43 mgKOH/g) was obtained. In Compound (P-21), the content of the branch-containing partial structure is 95 mass %.

### Synthesis Example 22

### <Synthesis of Compound (P-22)>

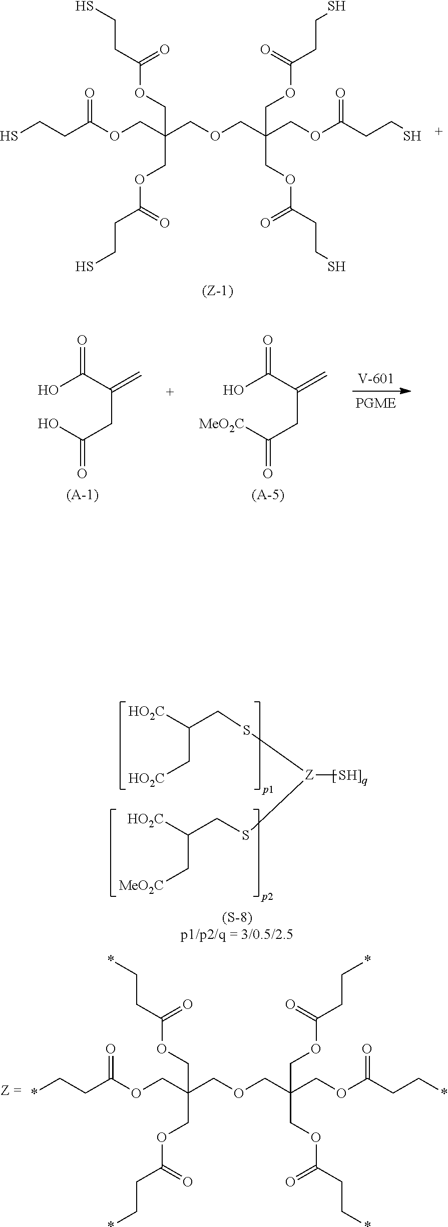

Dipentaerythritol hexakis(3-mercaptopropionate) [(Z-1); manufactured by SC Organic Chemical Co., Ltd] in an amount of 18.86 g, 9.40 g of itaconic acid (A-1), and 1.74 g of monomethyl itaconate (A-5) were dissolved in 70.0 g of 1-methoxy-2-propanol, and the solution was heated to a liquid temperature of 90° C. under a nitrogen gas stream. The feed ratio at this time was 1.0:3.0:0.5 in terms of molar ratio. To the obtained material, 49 mg dimethyl 2,2′-azobis(2-methylpropionate) [V-601, manufactured by FUJIFILM Wako Pure Chemical Corporation] was added and heated for 2 hours. Further, 49 mg of V-601 was added thereto and reacted at a liquid temperature of 90° C. for 2 hours under a nitrogen gas stream. The obtained material was cooled to room temperature, whereby a 30 mass % solution of a mercaptan compound (S-8) in which Compound (A-1) and Compound (A-5) were added to some of the sulfur atoms of Compound (Z-1) was obtained.

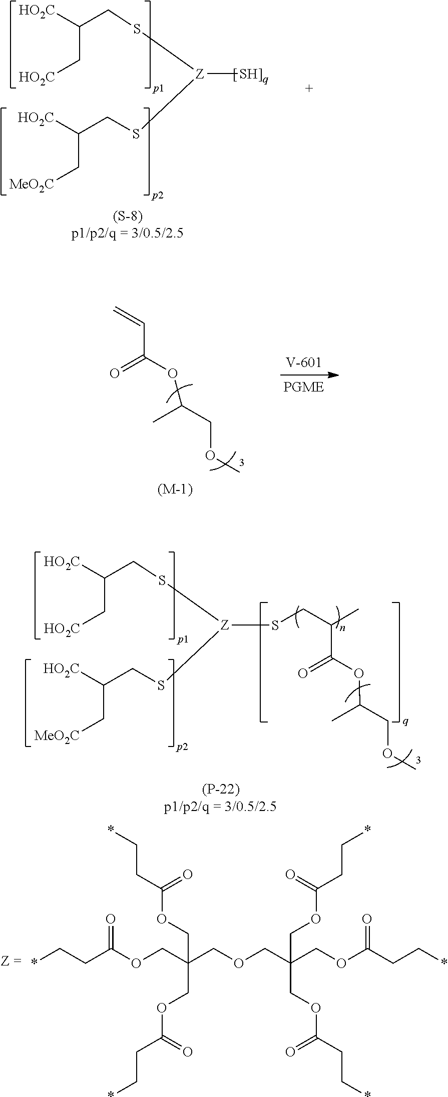

1-Methoxy-2-propanol in an amount of 14.68 g was heated to 75° C. under a nitrogen gas stream. A liquid obtained by dissolving 8.73 g of the 30 mass % solution of the mercaptan compound (S-8), 27.38 g of methoxytripropylene glycol acrylate (M-1), and 73 mg of dimethyl 2,2′-azobis(2-methylpropionate) [V-601, FUJIFILM Wako Pure Chemical Corporation] in 28.15 g of 1-methoxy-2-propanol was added thereto dropwise for 2.5 hours, and then heated at a liquid temperature of 75° C. for 2.5 hours. Further, 73 mg of V-601 was added thereto and reacted at a liquid temperature of 90° C. for 2 hours under a nitrogen gas stream. After the solution was cooled to room temperature, 1-methoxy-2-propanol was distilled off under reduced pressure at 60° C., 20 g of methanol was added thereto, and then distillation was performed again under reduced pressure at 60° C., whereby Compound (P-22) (weight-average molecular weight and melting point: see Table 2, acid value: 26 mgKOH/g) was obtained.

In Compound (P-22), the content of the branch-containing partial structure is 95 mass %.

### Synthesis Example 23

### <Synthesis of Compound (P-23)>

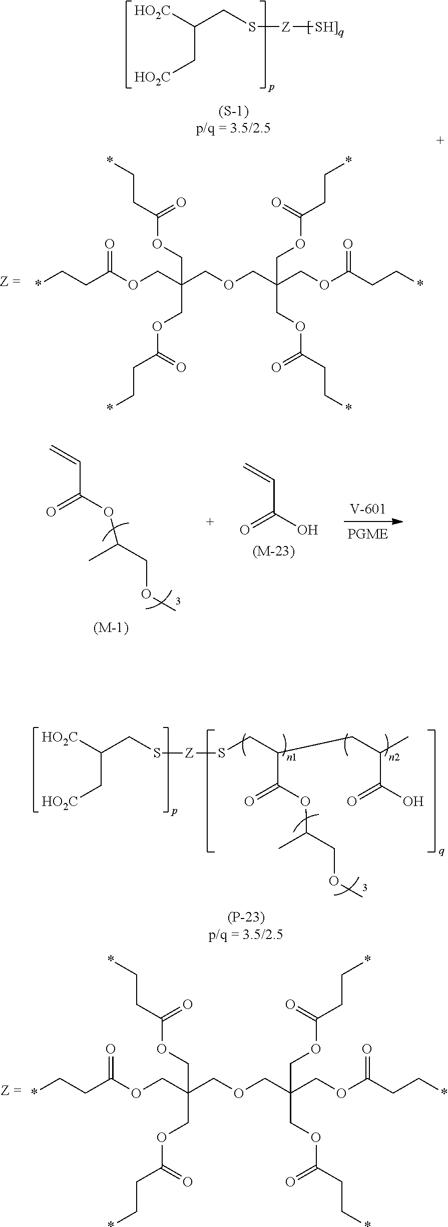

1-Methoxy-2-propanol in an amount of 14.68 g was heated to 75° C. under a nitrogen gas stream. A liquid obtained by dissolving 8.89 g of the 30 mass % solution of the mercaptan compound (S-1), 27.06 g of methoxytripropylene glycol acrylate (M-1), 0.27 g of acrylic acid (M-23), and 74 mg of dimethyl 2,2′-azobis(2-methylpropionate) [V-601, FUJIFILM Wako Pure Chemical Corporation] in 28.15 g of 1-methoxy-2-propanol was added thereto dropwise for 2.5 hours, and then heated at a liquid temperature of 75° C. for 2.5 hours. Further, 74 mg of V-601 was added thereto and reacted at a liquid temperature of 90° C. for 2 hours under a nitrogen gas stream. After the solution was cooled to room temperature, 1-methoxy-2-propanol was distilled off at 60° C. under reduced pressure, 20 g of 2-propanol was added thereto, and then distillation was performed again at 60° C. under reduced pressure, whereby Compound (P-23) (weight-average molecular weight and melting point: see Table 2, acid value: 35 mgKOH/g) was obtained. In the structure of Compound (P-23), n1 and n2 are the numbers of repeating units, and they are the same or different from each other. n1 and n2 are values that can be calculated from the weight-average molecular weight and the structure. The same applies to n1 and n2 described below.

In Compound (P-23), the content of the branch-containing partial structure is 95 mass %.

### Synthesis Example 24

### <Synthesis of Compound (P-24)>

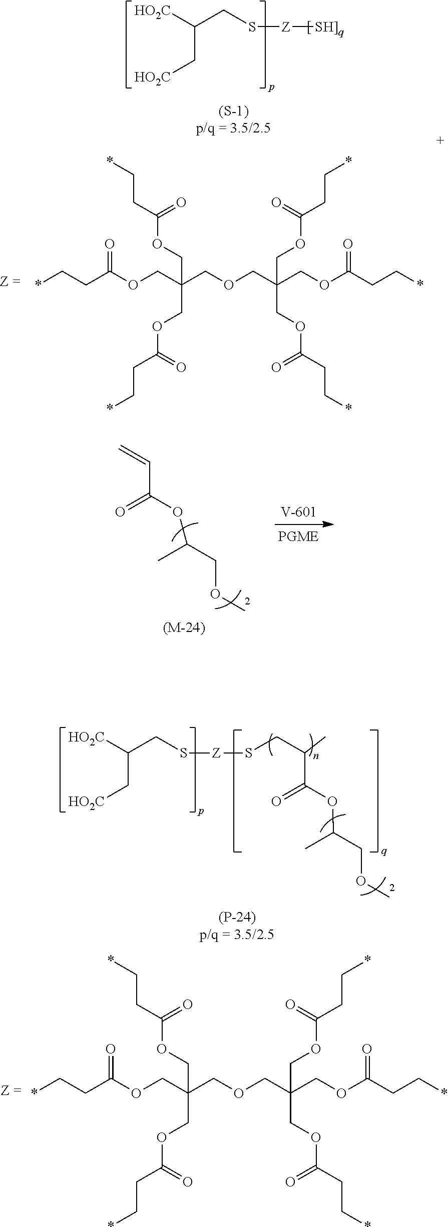

1-Methoxy-2-propanol in an amount of 14.68 g was heated to 80° C. under a nitrogen gas stream. A liquid obtained by dissolving 10.91 g of the 30 mass % solution of the mercaptan compound (S-1), 26.73 g of methoxydipropylene glycol acrylate (M-24, Light Acrylate DPM-A manufactured by Kyoeisha Chemical Co., Ltd.), and 91 mg of dimethyl 2,2′-azobis(2-methylpropionate) [V-601, manufactured by FUJIFILM Wako Pure Chemical Corporation] in 26.63 g of 1-methoxy-2-propanol was added dropwise thereto for 2.5 hours, and then heated at a liquid temperature of 80° C. for 2.5 hours. Further, 91 mg of V-601 was added thereto and reacted at a liquid temperature of 90° C. for 2 hours under a nitrogen gas stream. After the solution was cooled to room temperature, 1-methoxy-2-propanol was distilled off at 70° C. under reduced pressure, 20 g of methanol was added thereto, and then distillation was performed again at 70° C. under reduced pressure, whereby Compound (P-24) (weight-average molecular weight and melting point: see Table 2, acid value: 35 mgKOH/g) was obtained. In Compound (P-24), the content of the branch-containing partial structure is 95 mass %.

### Synthesis Example 25

### <Synthesis of Compound (P-25)>

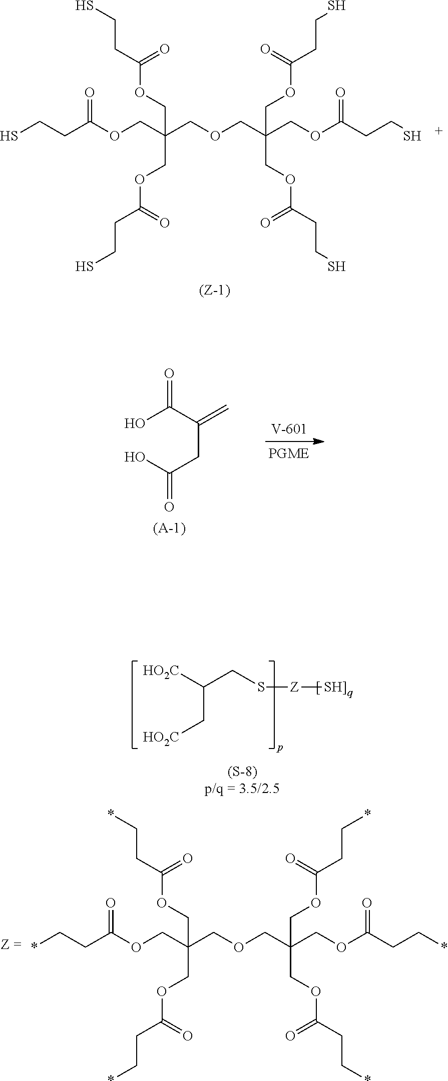

Dipentaerythritol hexakis(3-mercaptopropionate) [(Z-1); manufactured by SC Organic Chemical Co., Ltd.] in an amount of 18.97 g and 11.03 g of itaconic acid (A-1) were dissolved in 70.0 g of 1-methoxy-2-propanol and heated to a liquid temperature of 90° C. under a nitrogen gas stream. The feed ratio at this time was 1.0:3.5 in terms of molar ratio. To the obtained material, 49 mg dimethyl 2,2′-azobis(2-methylpropionate) [V-601, manufactured by FUJIFILM Wako Pure Chemical Corporation] was added and heated for 2 hours. Further, 49 mg of V-601 was added thereto and reacted at a liquid temperature of 90° C. for 2 hours under a nitrogen gas stream. The obtained material was cooled to room temperature, whereby a 30 mass % solution of a mercaptan compound (S-8) in which Compound (A-1) was added to some of the sulfur atoms of Compound (Z-1) was obtained.

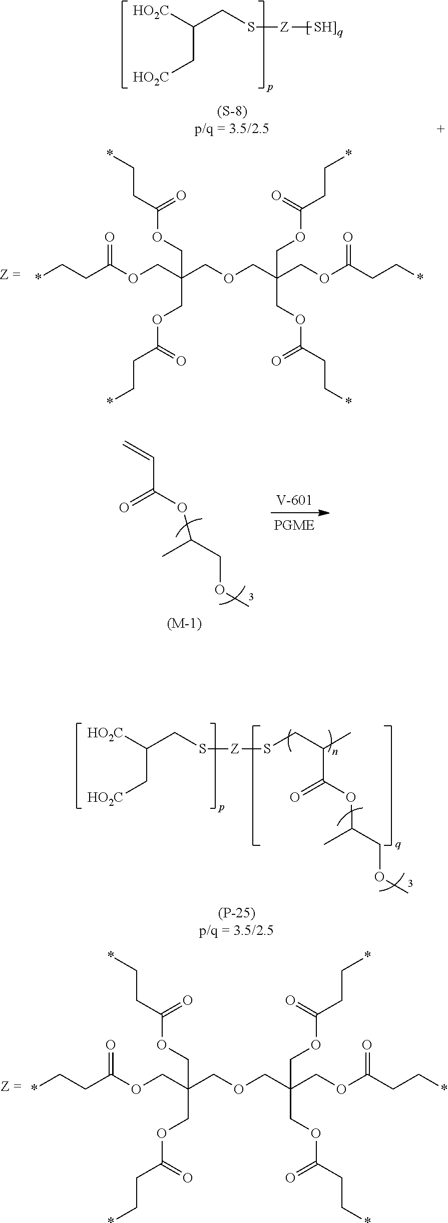

1-Methoxy-2-propanol in an amount of 15.54 g was heated to 75° C. under a nitrogen gas stream. A liquid obtained by dissolving 8.69 g of the 30 mass % solution of the mercaptan compound (S-8), 27.39 g of methoxytripropylene glycol acrylate [(M-1), manufactured by SHIN-NAKAMURA CHEMICAL Co., Ltd.], and 73 mg of dimethyl 2,2′-azobis(2-methylpropionate) [V-601, manufactured by FUJIFILM Wako Pure Chemical Corporation] in 10.91 g of 1-methoxy-2-propanol was added dropwise thereto for 2.5 hours, and then 5.57 g of 1-methoxy-2-propanol was added dropwise thereto for 10 minutes. Subsequently, the obtained material was heated at a liquid temperature of 75° C. for 2.5 hours. Further, 73 mg of V-601 was added thereto and reacted at a liquid temperature of 90° C. for 2 hours under a nitrogen gas stream. After the solution was cooled to room temperature, 1-methoxy-2-propanol was distilled off under reduced pressure at 70° C., 20 g of methanol was added thereto, and then distillation was performed again under reduced pressure at 70° C., whereby Compound (P-25) (weight-average molecular weight and melting point: see Table 2, acid value: 28 mgKOH/g) was obtained.

In Compound (P-25), the content of the branch-containing partial structure is 95 mass %.

### Synthesis Example 26

### <Synthesis of Compound (P-26)>

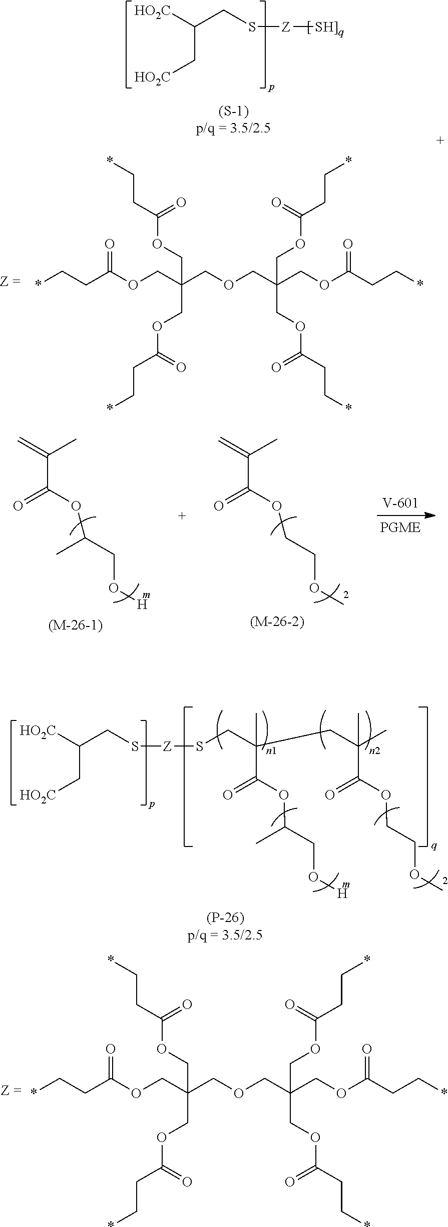

1-Methoxy-2-propanol in an amount of 16.71 g was heated to 80° C. under nitrogen gas stream. A liquid obtained by dissolving 8.99 g of the 30 mass % solution of the mercaptan compound (S-1), 13.65 g of polypropylene glycol methacrylate [(M-26-1), BLEMMER PP-1000 manufactured by NOF Corporation], 13.65 g of methoxydiethylene glycol methacrylate (M-26-2), and 75 mg of dimethyl 2,2′-azobis(2-methylpropionate) [V-601, manufactured by FUJIFILM Wako Pure Chemical Corporation] in 32.71 g of 1-methoxy-2-propanol was added dropwise thereto for 2.5 hours, and then heated at a liquid temperature of 80° C. for 2.5 hours. Further, 75 mg of V-601 was added thereto and reacted at a liquid temperature of 90° C. for 2 hours under a nitrogen gas stream. After the solution was cooled to room temperature, 1-methoxy-2-propanol was distilled off at 70° C. under reduced pressure, 20 g of methanol was added thereto, and then distillation was performed again at 70° C. under reduced pressure, whereby Compound (P-26) (weight-average molecular weight and melting point: see Table 2, acid value: 28 mgKOH/g) was obtained.

In Compound (P-26), the content of the branch-containing partial structure is 95 mass %.

### Synthesis Example 27

### <Synthesis of Compound (P-27)>

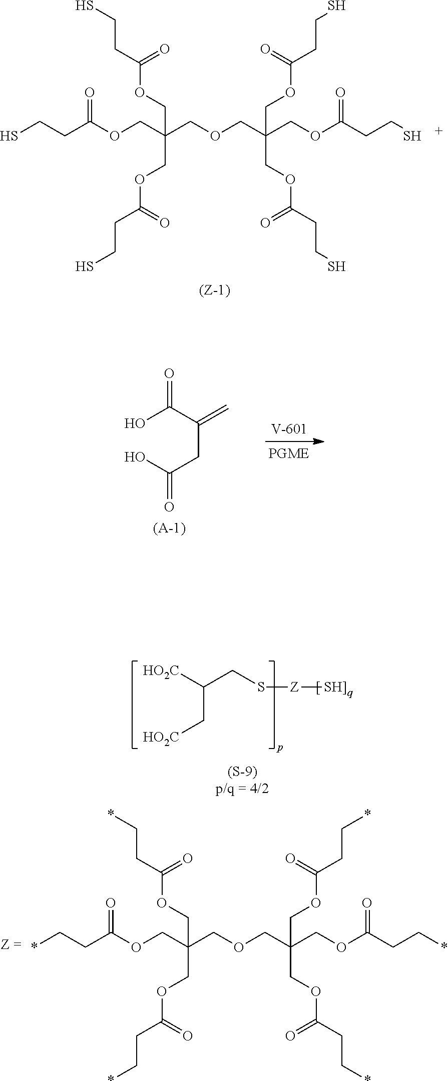

Dipentaerythritol hexakis(3-mercaptopropionate) [(Z-1); manufactured by SC Organic Chemical Co., Ltd.] in an amount of 18.02 g and 11.98 g of itaconic acid (A-1) were dissolved in 70.0 g of 1-methoxy-2-propanol and heated to a liquid temperature of 90° C. under a nitrogen gas stream. The feed ratio at this time was 1.0:4.0 in terms of molar ratio. To the obtained material, 53 mg of dimethyl 2,2′-azobis(2-methylpropionate) [V-601, manufactured by FUJIFILM Wako Pure Chemical Corporation] was added and heated for 2 hours. Further, 53 mg of V-601 was added thereto and reacted at a liquid temperature of 90° C. for 2 hours under a nitrogen gas stream. The obtained material was cooled to room temperature, whereby a 30 mass % solution of a mercaptan compound (S-9) in which Compound (A-1) was added to some of the sulfur atoms of Compound (Z-1) was obtained.

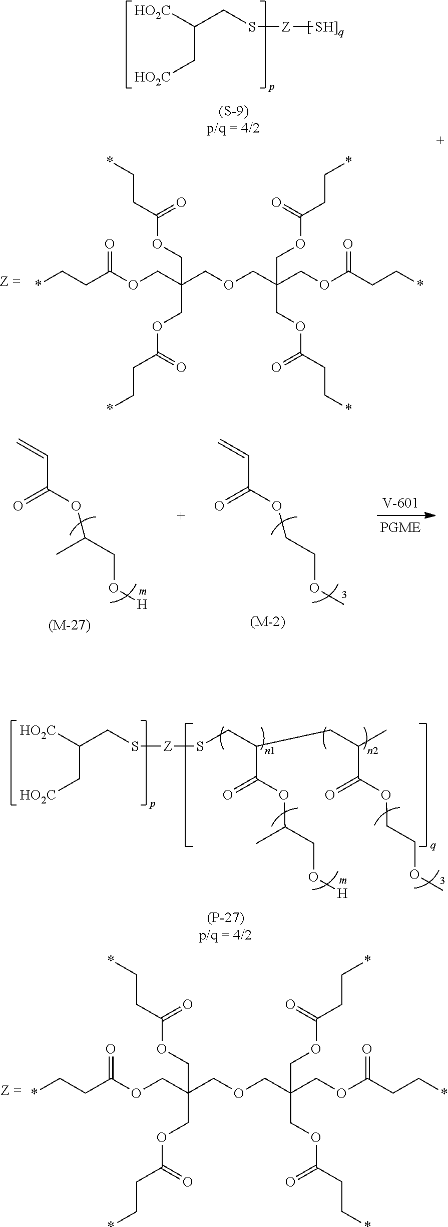

1-Methoxy-2-propanol in an amount of 16.71 g was heated to 80° C. under nitrogen gas stream. A liquid obtained by dissolving 10.18 g of the 30 mass % solution of the mercaptan compound (S-9), 13.47 g of polypropylene glycol acrylate [(M-27), BLEMMER AP-400 manufactured by NOF Corporation], 13.47 g of triethylene glycol acrylate (M-2), and 65 mg of dimethyl 2,2′-azobis(2-methylpropionate) [V-601, manufactured by FUJIFILM Wako Pure Chemical Corporation] in 31.87 g of 1-methoxy-2-propanol was added dropwise thereto for 2.5 hours, and then heated at a liquid temperature of 80° C. for 2.5 hours. Further, 65 mg of V-601 was added thereto and reacted at a liquid temperature of 90° C. for 2 hours under a nitrogen gas stream. After the solution was cooled to room temperature, 1-methoxy-2-propanol was distilled off under reduced pressure at 70° C., 20 g of methanol was added thereto, and then distillation was performed again under reduced pressure at 70° C., whereby Compound (P-27) (weight-average molecular weight and melting point: see Table 1, acid value: 35 mgKOH/g) was obtained.

In Compound (P-27), the content of the branch-containing partial structure is 95 mass %.

### Comparative Synthesis Example 1

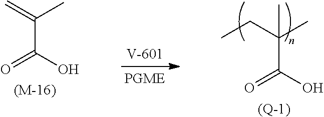

1-Methoxy-2-propanol in an amount of 8.0 g was heated to a liquid temperature of 80° C. under a nitrogen gas stream. A liquid obtained by dissolving 12.03 g of the methacrylic acid (M-16) and 83 mg of dimethyl 2,2′-azobis(2-methylpropionate) [V-601, manufactured by FUJIFILM Wako Pure Chemical Corporation] in 14.3 g of 1-methoxy-2-propanol was added dropwise thereto for 2.5 hours, and then heated at a liquid temperature of 80° C. for 2.5 hours. Further, 83 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (Q-1) (weight-average molecular weight and melting point: see Table 2, acid value: 650 mgKOH/g) was obtained as a powder.

### Comparative Synthesis Example 2

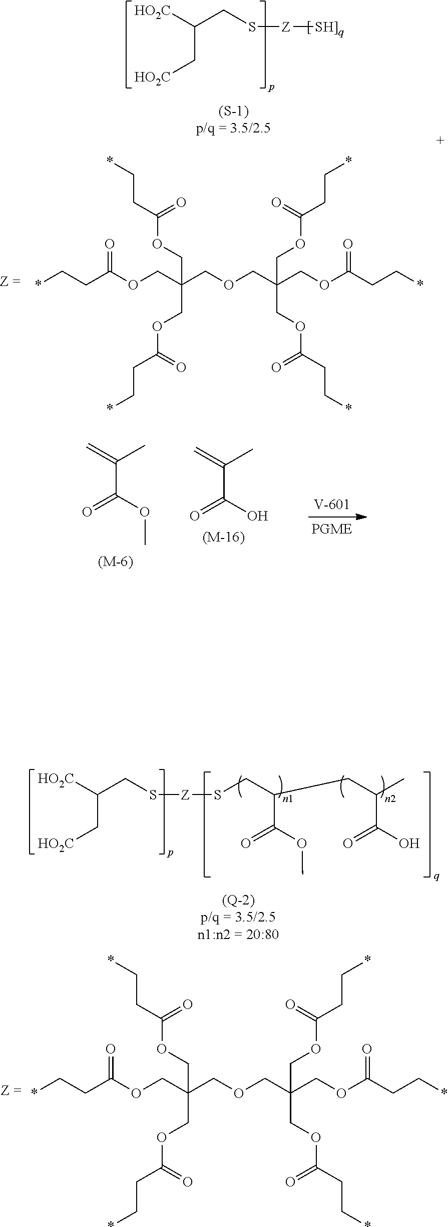

1-Methoxy-2-propanol in an amount of 16.71 g was heated to a liquid temperature of 80° C. under a nitrogen gas stream. A liquid obtained by dissolving 18.22 g of the 30 mass % solution of the mercaptan compound (S-1), 5.64 g of methyl methacrylate (M-6), 18.89 g of methacrylic acid (M-16), and 191 mg of dimethyl 2,2′-azobis(2-methylpropionate) [V-601, manufactured by FUJIFILM Wako Pure Chemical Corporation] in 20.68 g of 1-methoxy-2-propanol was added dropwise thereto for 2.5 hours, and then heated at a liquid temperature of 80° C. for 2.5 hours. Further, 191 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (Q-2) (weight-average molecular weight and melting point: see Table 2, acid value: 468 mgKOH/g) was obtained.

Compound (Q-2) shown in Table 3 is a compound having a structure similar to that of Compound C-7 described in WO2016/189827A.

### Comparative Synthesis Example 3

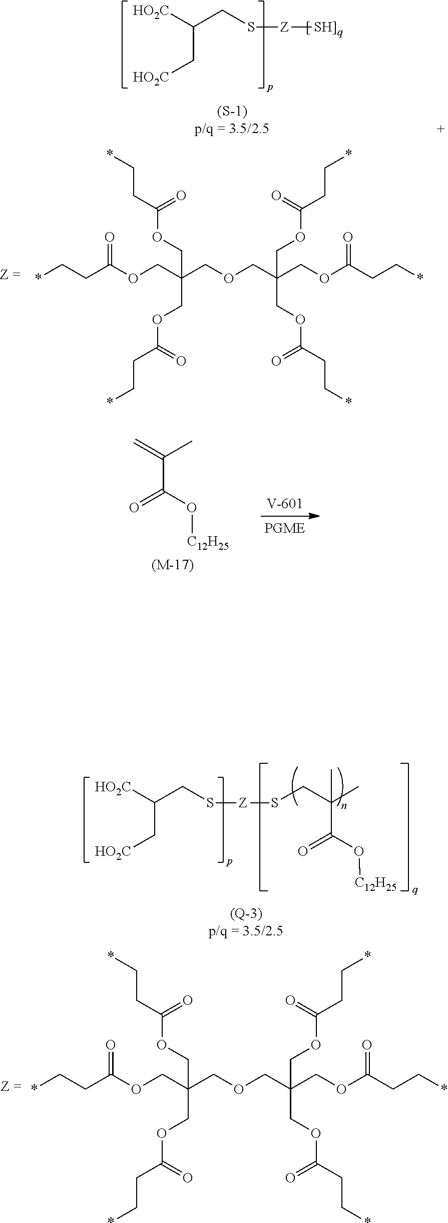

1-Methoxy-2-propanol in an amount of 16.71 g was heated to a liquid temperature of 80° C. under a nitrogen gas stream. A liquid obtained by dissolving 12.08 g of the 30 mass % solution of the mercaptan compound (S-1), 26.38 g of dodecylmethacrylate (M-17), and 76 mg of dimethyl 2,2′-azobis(2-methylpropionate) [V-601, manufactured by FUJIFILM Wako Pure Chemical Corporation] in 24.97 g of 1-methoxy-2-propanol was added dropwise thereto for 2.5 hours, and then heated at a liquid temperature of 80° C. for 2.5 hours. Further, 76 mg of V-601 was added thereto and reacted at a liquid temperature of 90° C. for 2 hours under a nitrogen gas stream. After the solution was cooled to room temperature, 1-methoxy-2-propanol was distilled off with an evaporator, whereby Compound (Q-3) (weight-average molecular weight and melting point: see Table 2, acid value: 38 mgKOH/g) was obtained.

Compound (Q-3) is a compound having a structure similar to that of Compound C-5 described in WO2016/189827A, and n in the above structure is 30.

The details of the compounds synthesized as described above are shown in Table 2 (Table 2-1 to Table 2-8). In Table 2, A¹, R³, Z, R⁴, P¹, p, and q are A¹, R³, Z, R⁴, P¹, p, and q in General Formula (2), respectively. Hereinafter, “*” represents a bonding position with an adjacent atom.

[Table 2-1]

| Compound | A¹ | R³ | Z | R⁴ | P¹ |
|---|---|---|---|---|---|
| P-1 | 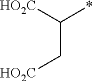 [SMILES: *C(CC(=O)O)C(=O)O] | —CH₂— | 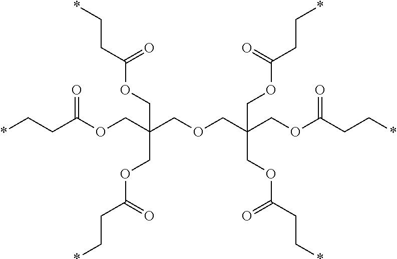 [SMILES: *CCC(=O)OCC(COCC(COC(=O)CC*)(COC(=O)CC*)COC(=O)CC*)(COC(=O)CC*)COC(=O)CC*] | Single bond | 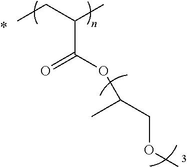 |
| P-2 | 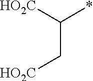 [SMILES: *C(CC(=O)O)C(=O)O] | —CH₂— | 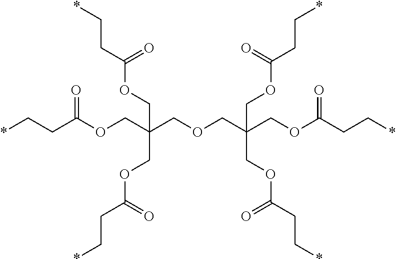 [SMILES: *CCC(=O)OCC(COCC(COC(=O)CC*)(COC(=O)CC*)COC(=O)CC*)(COC(=O)CC*)COC(=O)CC*] | Single bond | 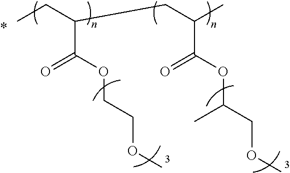 |
| P-3 | 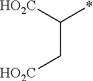 [SMILES: *C(CC(=O)O)C(=O)O] | —CH₂— | 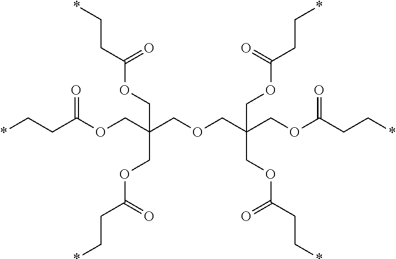 [SMILES: *CCC(=O)OCC(COCC(COC(=O)CC*)(COC(=O)CC*)COC(=O)CC*)(COC(=O)CC*)COC(=O)CC*] | Single bond | 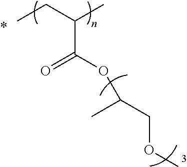 |
| Compound | p | q | Weight-average molecular weight | I/O value of P¹ | Melting point |
| P-1 | 3.5 | 2.5 | 7000 | 0.545 | <25 ° C. |
| P-2 | 3.5 | 2.5 | 7000 | 1.000 | <25° C. |
| P-3 | 3.5 | 2.5 | 18000 | 0.545 | <25° C. |

[Table 2-2]

| Compound | A¹ | R³ | Z | R⁴ | P¹ |
|---|---|---|---|---|---|
| P-4 | 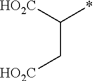 [SMILES: *C(CC(=O)O)C(=O)O] | —CH₂— | 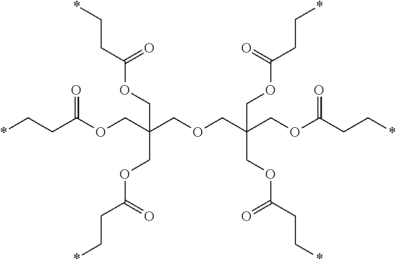 [SMILES: *CCC(=O)OCC(COCC(COC(=O)CC*)(COC(=O)CC*)COC(=O)CC*)(COC(=O)CC*)COC(=O)CC*] | Single bond | 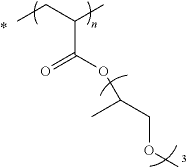 |
| P-5 | 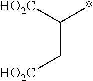 [SMILES: *C(CC(=O)O)C(=O)O] | —CH₂— | 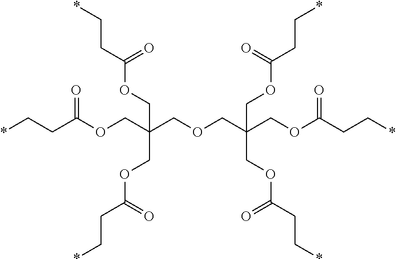 [SMILES: *CCC(=O)OCC(COCC(COC(=O)CC*)(COC(=O)CC*)COC(=O)CC*)(COC(=O)CC*)COC(=O)CC*] | Single bond | 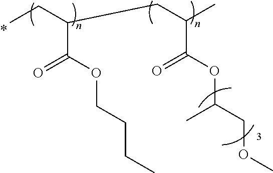 |
| P-6 | 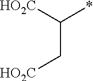 [SMILES: *C(CC(=O)O)C(=O)O] | —CH₂— | 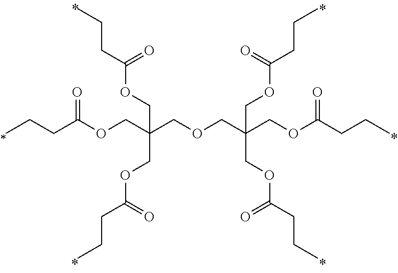 | Single bond | 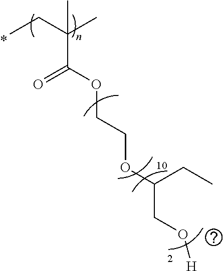 |
| | | | Weight-average | | |
| Compound | p | q | molecular weight | I/O value of P¹ | Melting point |
| P-4 | 3.5 | 2.5 | 3500 | 0.545 | <25° C. |
| P-5 | 3.5 | 2.5 | 7000 | 0.545 | <25° C. |
| P-6 | 3.5 | 2.5 | 7000 | 1.183 | <25° C. |

[Table 2-3]

| Compound | A¹ | R³ | Z | R⁴ | P¹ |
|---|---|---|---|---|---|
| P-7 | 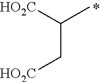 | —CH₂— | 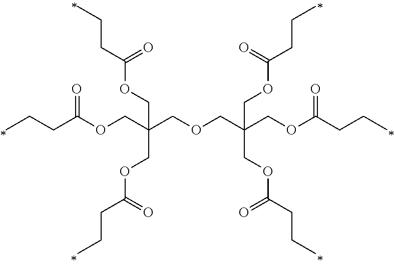 | Single bond | 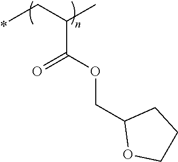 |
| P-8 | 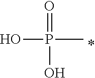 | —CH₂CH₂— | 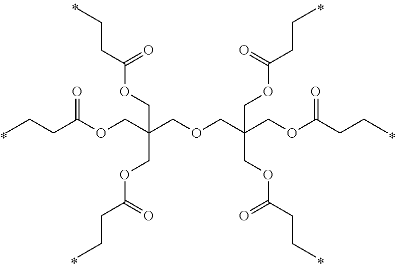 | Single bond | 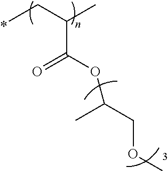 |
| P-9 | 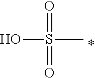 | —CH₂CH₂— | 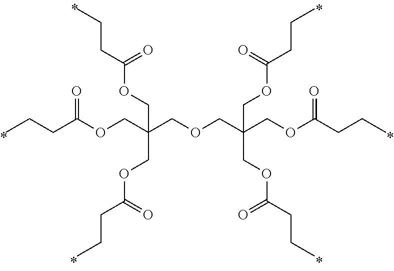 | Single bond | 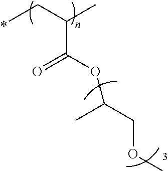 |
| | | | Weight-average | | |
| Compound | p | q | molecular weight | I/O value of P¹ | Melting point |
| P-7 | 3.5 | 2.5 | 7000 | 0.643 | <25° C. |
| P-8 | 3.5 | 2.5 | 7000 | 0.545 | <25° C. |
| P-9 | 3.5 | 2.5 | 7000 | 0.545 | <25° C. |

[Table 2-4]

| Compound | A¹ | R³ | Z | R⁴ | P¹ |
|---|---|---|---|---|---|
| P-10 | 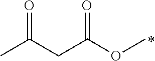 | 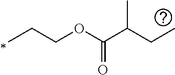 | 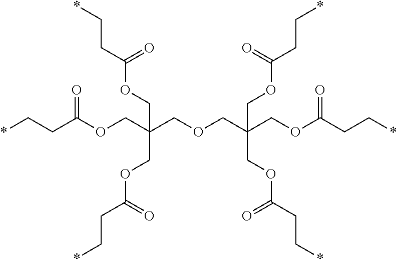 [SMILES: *CCC(=O)OCC(COCC(COC(=O)CC*)(COC(=O)CC*)COC(=O)CC*)(COC(=O)CC*)COC(=O)CC*] | Single bond | 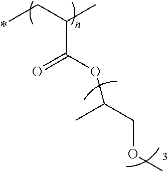 |
| P-11 | 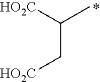 | —CH₂— | 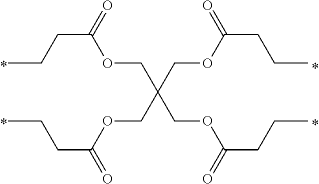 | Single bond | 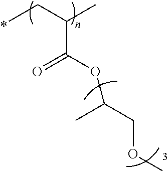 |
| P-12 | 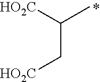 | —CH₂— | 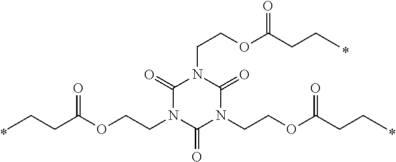 | Single bond | 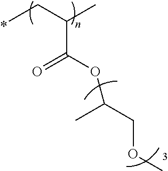 |
| | | | Weight-average | | |
| Compound | p | q | molecular weight | I/O value of P¹ | Melting point |
| P-10 | 3.5 | 2.5 | 7000 | 0.545 | <25° C. |
| P-11 | 2.5 | 1.5 | 4700 | 0.545 | <25° C. |
| P-12 | 2 | 1 | 4500 | 0.545 | <25° C. |

[Table 2-5]

| Compound | A¹ | R³ | Z | R⁴ | P¹ |
|---|---|---|---|---|---|
| P-13 | 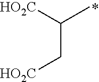 | —CH₂— | 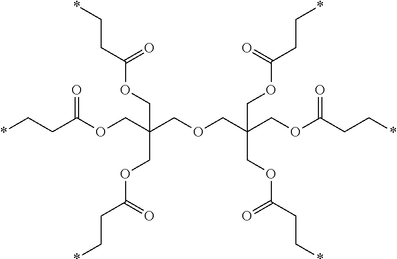 [SMILES: *CCC(=O)OCC(COCC(COC(=O)CC*)(COC(=O)CC*)COC(=O)CC*)(COC(=O)CC*)COC(=O)CC*] | Single bond | 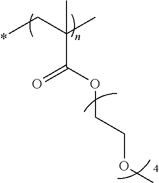 |
| P-14 | 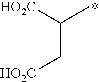 | —CH₂— | 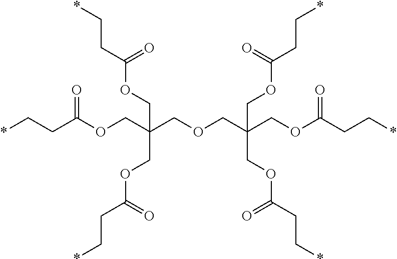 [SMILES: *CCC(=O)OCC(COCC(COC(=O)CC*)(COC(=O)CC*)COC(=O)CC*)(COC(=O)CC*)COC(=O)CC*] | Single bond | 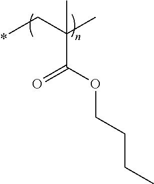 |
| P-15 | 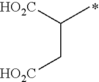 | —CH₂— | 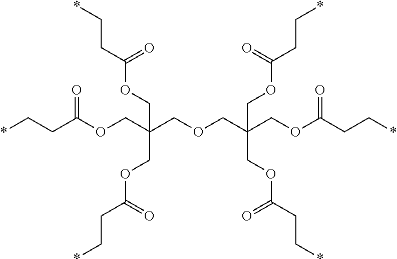 [SMILES: *CCC(=O)OCC(COCC(COC(=O)CC*)(COC(=O)CC*)COC(=O)CC*)(COC(=O)CC*)COC(=O)CC*] | Single bond | 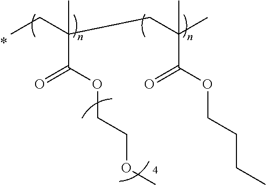 |
| | | | Weight-average | | |
| Compound | p | q | molecular weight | I/O value of P¹ | Melting point |
| P-13 | 3.5 | 2.5 | 7000 | 1.500 | <25° C. |
| P-14 | 3.5 | 2.5 | 6000 | 0.429 | 35° C. |
| P-15 | 3.5 | 2.5 | 8200 | 1.059 | <25° C. |

[Table 2-6]

| Compound | A¹ | R³ | Z | R⁴ | P¹ |
|---|---|---|---|---|---|
| P-16 | 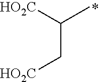 | —CH₂— | 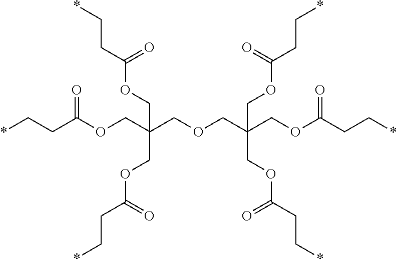 [SMILES: *CCC(=O)OCC(COCC(COC(=O)CC*)(COC(=O)CC*)COC(=O)CC*)(COC(=O)CC*)COC(=O)CC*] | Single bond | 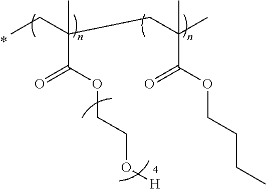 |
| P-17 | 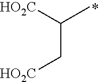 | —CH₂— | 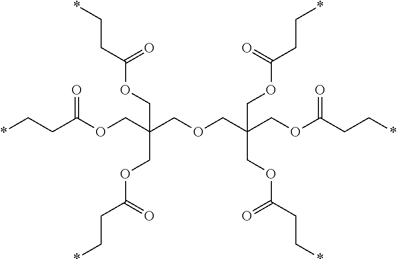 [SMILES: *CCC(=O)OCC(COCC(COC(=O)CC*)(COC(=O)CC*)COC(=O)CC*)(COC(=O)CC*)COC(=O)CC*] | Single bond | 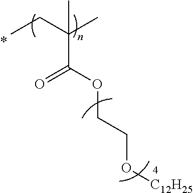 |
| P-18 | 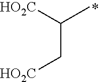 | —CH₂— | 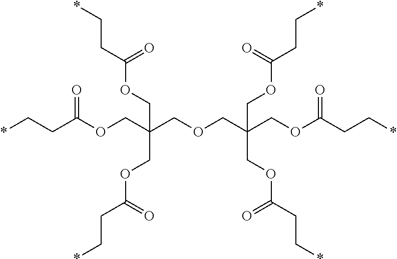 [SMILES: *CCC(=O)OCC(COCC(COC(=O)CC*)(COC(=O)CC*)COC(=O)CC*)(COC(=O)CC*)COC(=O)CC*] | Single bond | 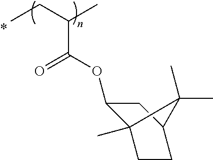 |
| | | | Weight-average | | |
| Compound | p | q | molecular weight | I/O value of P¹ | Melting point |
| P-16 | 3.5 | 2.5 | 7000 | 1.212 | <25° C. |
| P-17 | 3.5 | 2.5 | 14000 | 0.714 | <25° C. |
| P-18 | 3.5 | 2.5 | 5000 | 0.421 | 85° C. |

[Table 2-7]

| Compound | A¹ | R³ | Z | R⁴ | P¹ |
|---|---|---|---|---|---|
| P-19 | 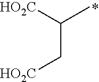 | —CH₂— | 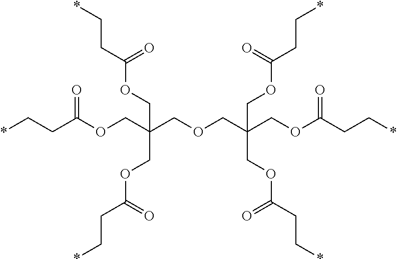 [SMILES: *CCC(=O)OCC(COCC(COC(=O)CC*)(COC(=O)CC*)COC(=O)CC*)(COC(=O)CC*)COC(=O)CC*] | Single bond | 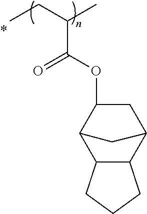 |
| P20 | 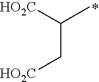 | —CH₂— | 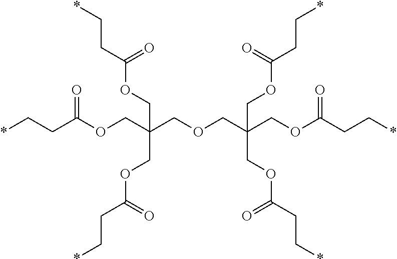 [SMILES: *CCC(=O)OCC(COCC(COC(=O)CC*)(COC(=O)CC*)COC(=O)CC*)(COC(=O)CC*)COC(=O)CC*] | Single bond | 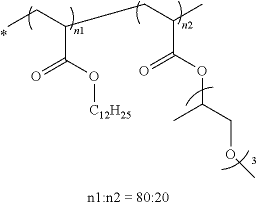 |
| | | | Weight-average | | |
| Compound | p | q | molecular weight | I/O value of P¹ | Melting point |
| P-18 | 3.5 | 2.5 | 5000 | 0.450 | <25° C. |
| P-19 | 3.5 | 2.5 | 7000 | 0.270 | <25° C. |

[Table 2-8]

| Compound | A¹ | R³ | Z | R⁴ | P¹ |
|---|---|---|---|---|---|
| (P-21) | 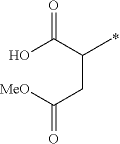 | —CH₂— | 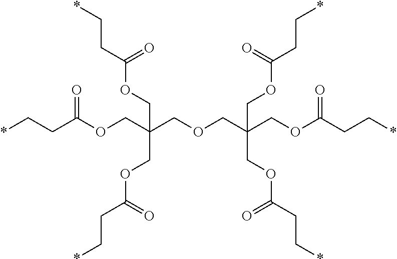 [SMILES: *CCC(=O)OCC(COCC(COC(=O)CC*)(COC(=O)CC*)COC(=O)CC*)(COC(=O)CC*)COC(=O)CC*] | Single bond | 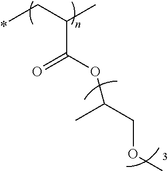 |
| (P-22) | 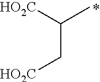 | —CH₂— | 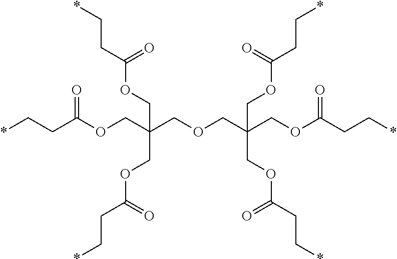 [SMILES: *CCC(=O)OCC(COCC(COC(=O)CC*)(COC(=O)CC*)COC(=O)CC*)(COC(=O)CC*)COC(=O)CC*] | Single bond | 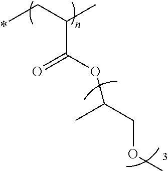 |
| | 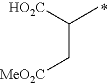 | | | | |
| (P-23) | 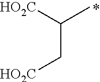 | —CH₂— | 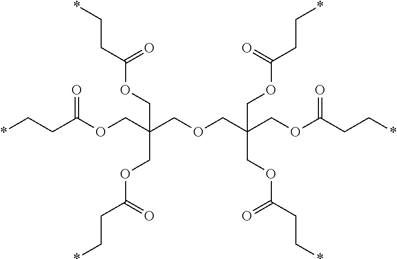 [SMILES: *CCC(=O)OCC(COCC(COC(=O)CC*)(COC(=O)CC*)COC(=O)CC*)(COC(=O)CC*)COC(=O)CC*] | Single bond | 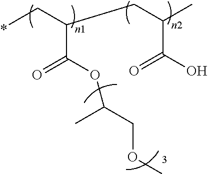 |
| (P-24) | 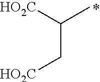 | —CH₂— | 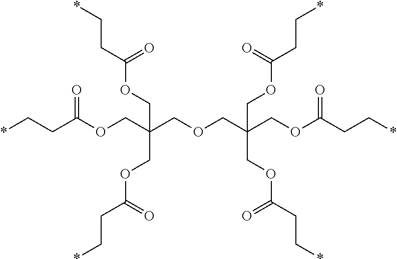 [SMILES: *CCC(=O)OCC(COCC(COC(=O)CC*)(COC(=O)CC*)COC(=O)CC*)(COC(=O)CC*)COC(=O)CC*] | Single bond | 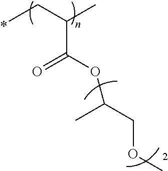 |
| (P-25) | 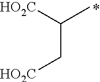 | —CH₂— | 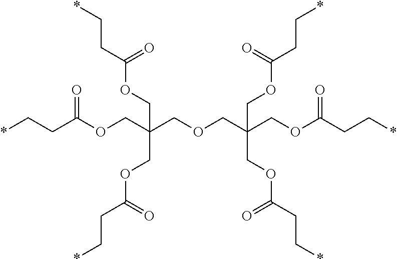 [SMILES: *CCC(=O)OCC(COCC(COC(=O)CC*)(COC(=O)CC*)COC(=O)CC*)(COC(=O)CC*)COC(=O)CC*] | Single bond | 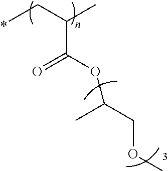 |
| (P-26) | 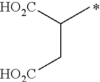 | —CH₂— | 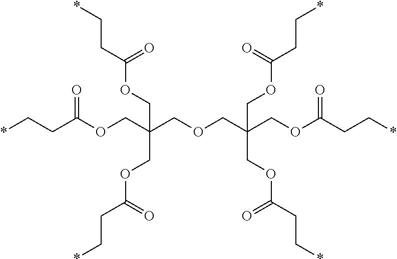 [SMILES: *CCC(=O)OCC(COCC(COC(=O)CC*)(COC(=O)CC*)COC(=O)CC*)(COC(=O)CC*)COC(=O)CC*] | Single bond | 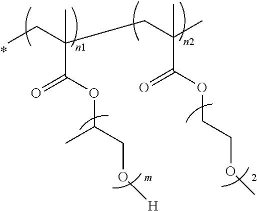 |
| (P-27) | 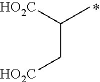 | —CH₂— | 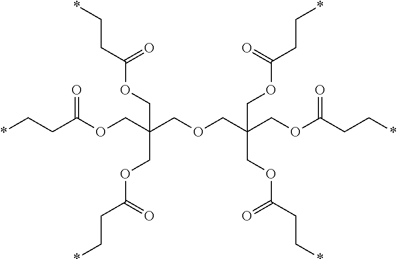 [SMILES: *CCC(=O)OCC(COCC(COC(=O)CC*)(COC(=O)CC*)COC(=O)CC*)(COC(=O)CC*)COC(=O)CC*] | Single bond | 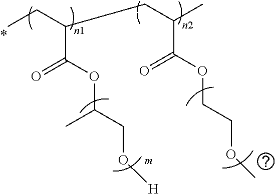 |
| | | | Weight-average | | |
| Compound | p | q | molecular weight | I/O value of P¹ | Melting point |
| (P-21) | 3.5 | 2.5 | 4500 | 0.545 | <25° C. |
| (P-22) | 30./0.5 | 2.5 | 8000 | 0.545 | <25° C. |
| (P-23) | 3.5 | 2.5 | 8000 | 0.631 | <25° C. |
| (P-24) | 3.5 | 2.5 | 7000 | 0.588 | <25° C. |
| (P-25) | 3.5 | 2.5 | 7500 | 0.545 | <25° C. |
| (P-26) | 3.5 | 2.5 | 12000 | 1.10 | <25° C. |
| (P-27) | 4 | 2 | 6000 | 1.25 | <25° C. |

[Table 2-9]

| Compound | A¹ | R³ | Z | R⁴ | P¹ |
|---|---|---|---|---|---|
| Q-1 | — | — | — | — | 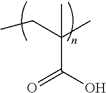 |
| Q-2 | 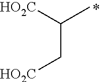 | —CH₂— | 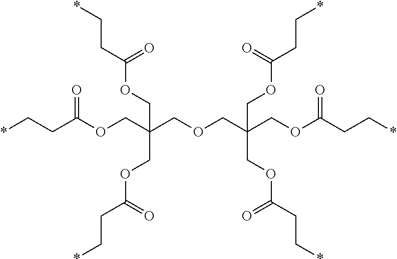 [SMILES: *CCC(=O)OCC(COCC(COC(=O)CC*)(COC(=O)CC*)COC(=O)CC*)(COC(=O)CC*)COC(=O)CC*] | Single bond | 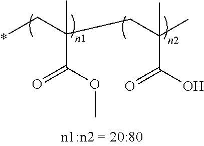 |
| Q-3 | 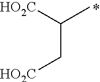 | —CH₂— | 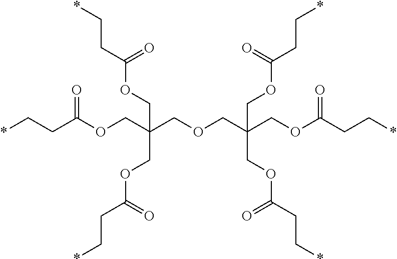 [SMILES: *CCC(=O)OCC(COCC(COC(=O)CC*)(COC(=O)CC*)COC(=O)CC*)(COC(=O)CC*)COC(=O)CC*] | Single bond | 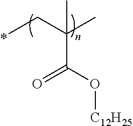 |
| | | | Weight-average | | |
| Compound | p | q | molecular weight | I/O value of P¹ | Melting point |
| Q-1 | | | 7000 | 2.500 | 260° C. |
| Q-2 | 1.5 | 4.5 | 7000 | 2.150 | 95° C. |
| Q-3 | 4 | 2 | 8000 | 0.200 | 55° C. |

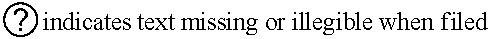

### [Evaluation Method]

The following items were evaluated by the following methods. In Comparative Example 3 and Comparative Example 4, since the evaluation result of the solubility was C, the evaluation of other items was not performed.

### (1) Dispersibility of Inorganic Particles

The sedimentation velocity of the inorganic particles in the quantum dot-containing polymerizable composition prepared as described above was measured by the following method.

### (Method for Measuring Sedimentation Velocity)

The quantum dot-containing polymerizable composition prepared as described above was collected in an amount of 30 g, placed in a 30 mL vial, stirred, and then the vial was allowed to stand in a horizontal place. At that time, it was visually confirmed that the inorganic particles (alumina particles or titanium oxide particles) were uniformly dispersed in the entire liquid. After the vial was left to stand for 24 hours, the inorganic particles (alumina particles or titanium oxide particles) were sedimentated, and the presence of a supernatant portion in which the inorganic particles (alumina particles or titanium oxide particles) were not present was visually confirmed. The thickness of the supernatant portion after standing for 24 hours was measured with a ruler, and the measured value was taken as the sedimentation velocity (unit: mm/day) of the inorganic particles. The difference between the inorganic particles (alumina particles or titanium oxide particles) and the quantum dots can be distinguished by the color of the particles (alumina particles and titanium oxide particles: white, quantum dots: brown).

The dispersibility of the inorganic particles listed in Table 3 in the polymerizable composition was evaluated according to the following evaluation criteria.

### (Evaluation Criteria)

A; Sedimentation speed of inorganic particles is less than 6 mm/day
B; Sedimentation speed of inorganic particles is 6 mm/day or more and less than 10 mm/day
C; Sedimentation speed of inorganic particles is 10 mm/day or more

### (2) Solubility

A quantum dot-containing polymerizable composition was prepared by the method described above, except that the compound listed in Table 3 and the inorganic particles listed in Table 3 were not added.

While the prepared quantum dot-containing polymerizable composition (liquid temperature 25° C.) was stirred, a predetermined amount of the compound listed in Table 3 was added. When complete dissolution was visually confirmed, the same compound was further added, and this operation was repeated.

The concentration of the same compound at the maximum addition amount at which undissolved residues were not visually confirmed was calculated, and the solubility was evaluated based on the calculated concentration according to the following evaluation criteria.

### (Evaluation Criteria)

A: Dissolved in an amount of 20 mass % or more with respect to 100 mass % of quantum dot-containing polymerizable composition
B: Dissolved in an amount of 5 mass % or more and less than 20 mass % with respect to 100 mass % of quantum dot-containing polymerizable composition
C: Dissolved in an amount of less than 5 mass % or insoluble with respect to 100 mass % of quantum dot-containing polymerizable composition

### (3) Luminance (Relative Luminance) of Wavelength Conversion Member

A commercially available tablet terminal (Kindle Fire HDX7 manufactured by Amazon.com, Inc.) including a blue light source in a backlight unit was disassembled, and the backlight unit was taken out. Instead of the quantum dot enhancement film (QDEF) which is a wavelength conversion film incorporated into the backlight unit, each of wavelength conversion members of examples or comparative examples cut into a rectangle was incorporated. A liquid crystal display device was thus produced.

The produced liquid crystal display device was turned on, the entire surface was caused to display white, and the luminance was measured using a luminance meter (SR3 manufactured by Topcon Corporation) installed at a position of 520 mm in a direction perpendicular to the surface of the light guide plate.

For each of examples and comparative examples, the luminance (relative luminance) was obtained as a relative value to the luminance of Comparative Example 1. Based on the relative luminance obtained as described above, the luminance was evaluated according to the following evaluation criteria. In a case where the evaluation result is A or B, it can be said that the wavelength conversion member is capable of emitting light with high luminance.

### (Evaluation Criteria)

A: Relative luminance>100%
B: 97%≤Relative luminance≤100%
C: Relative luminance<97%

### (4) Wavelength Shift

For each of examples and comparative examples, a wavelength conversion member for reference was produced by the method described above except that the compound listed in Table 3 was not contained.

A liquid crystal display device produced by the method described in (3) above was turned on, the entire surface was caused to display white, and the emission spectrum of each of the wavelength conversion members of examples and comparative examples and the emission spectrum of the wavelength conversion member for reference were measured in an optical spectrum measurement mode of a luminance meter (SR3 manufactured by Topcon Corporation). The difference (that is, wavelength shift) between the light emission center wavelength near the wavelength 630 nm and the light emission center wavelength of the wavelength conversion member for reference was evaluated according to the following evaluation criteria.

### (Evaluation Criteria)

A: Wavelength shift is less than 1 nm
B: Wavelength shift is 1 nm or more and less than 2 nm
C: Wavelength shift is 2 nm or more

The results of the evaluations is shown in Table 3 (Tables 3-1 and 3-2).

TABLE 3-1

| | Quantum dot- | | | Evaluation result | | | |
|---|---|---|---|---|---|---|---|
| | containing | | | | Dispersibility | | |
| | polymerizable | Inorganic | | | of inorganic | | Wavelength |
| | composition | particle | Compound | Solubility | particle | Luminance | shift |
| Example 1 | 1 | A | P-1 | A | A | A | A |
| Example 2 | 1 | A | P-2 | A | A | A | B |
| Example 3 | 1 | A | P-3 | A | B | A | B |
| Example 4 | 1 | A | P-4 | A | B | A | A |
| Example 5 | 1 | A | P-5 | A | A | A | A |
| Example 6 | 1 | A | P-6 | B | A | A | B |
| Example 7 | 1 | A | P-7 | A | A | A | A |
| Example 8 | 1 | A | P-8 | A | A | A | A |
| Example 9 | 1 | A | P-9 | A | B | A | A |
| Example 10 | 1 | A | P-10 | A | B | A | A |
| Example 11 | 1 | A | P-11 | A | A | A | A |
| Example 12 | 1 | A | P-12 | A | B | A | A |
| Example 13 | 1 | A | P-13 | A | A | B | B |
| Example 14 | 1 | A | P-14 | B | A | A | A |
| Example 15 | 1 | A | P-15 | B | A | A | B |
| Example 16 | 1 | A | P-16 | B | A | A | B |
| Example 17 | 1 | A | P-17 | A | A | A | A |
| Example 18 | 1 | A | P-18 | B | A | A | A |
| Example 19 | 1 | A | P-19 | A | A | A | A |
| Example 20 | 1 | A | P-20 | B | A | A | A |
| Example 21 | 1 | B | P-1 | A | A | B | A |
| Example 22 | 2 | A | P-1 | A | A | A | A |
| Example 23 | 2 | B | P-1 | A | A | B | A |
| Example 24 | 3 | A | P-1 | A | A | A | A |
| Example 25 | 3 | B | P-1 | A | A | B | A |
| Example 26 | 4 | A | P-1 | A | A | A | A |
| Example 27 | 4 | B | P-1 | A | A | B | A |
| Example 28 | 5 | A | P-1 | A | A | A | A |
| Example 29 | 5 | B | P-1 | A | A | B | A |
| Example 30 | 6 | A | P-1 | A | A | A | A |
| Example 31 | 6 | B | P-1 | A | A | B | A |
| Example 32 | 7 | B | P-1 | A | A | B | A |
| Example 33 | 8 | B | P-1 | A | A | B | A |
| Comparative | 1 | A | — | — | C | Reference | A |
| Example 1 | | | | | | | |
| Comparative | 1 | A | Q-1 | B | C | C | C |
| Example 2 | | | | | | | |
| Comparative | 1 | A | Q-2 | C | — | — | — |
| Example 3 | | | | | | | |
| Comparative | 1 | A | Q-3 | C | — | — | — |
| Example 4 | | | | | | | |

TABLE 3-2

| | Quantum dot- | | | Evaluation result | | | |
|---|---|---|---|---|---|---|---|
| | containing | | | | Dispersibility | | |
| | polymerizable | Inorganic | | | of inorganic | | Wavelength |
| | composition | particle | Compound | Solubility | particle | Luminance | shift |
| Example 34 | 1 | A | P-21 | A | B | A | A |
| Example 35 | 1 | A | P-22 | A | A | A | A |
| Example 36 | 1 | A | P-23 | A | A | A | A |
| Example 37 | 1 | A | P-24 | A | A | A | A |
| Example 38 | 1 | A | P-25 | A | A | A | A |
| Example 39 | 1 | A | P-26 | A | A | B | B |
| Example 40 | 1 | A | P-27 | A | A | B | B |
| Example 41 | 9 | A | P-22 | A | A | A | A |
| Example 42 | 9 | A | P-23 | A | A | A | A |
| Example 43 | 9 | A | P-24 | A | A | A | A |
| Example 44 | 9 | A | P-25 | A | A | A | A |

An aspect of the present invention is useful in the technical field of liquid crystal display devices.

### EXPLANATION OF REFERENCES

10, 10A, 10B: wavelength conversion member
12: first base material film
12a, 14a: support film
12b, 14b: barrier layer
14: second base material film
16: wavelength conversion layer
18: resin layer
18a: recess
20: quantum dot-containing part
24, 24e: quantum dot
26: matrix
28: mixed layer
30: impermeable layer
34: underlying organic layer
36: inorganic layer
38: protective organic layer
50: backlight unit
52A: light source
52B: light guide plate
52C: planar light source
54: wavelength conversion member
56A: reflective plate
56B: retroreflective member
60: liquid crystal display device
62: liquid crystal cell unit
64: liquid crystal cell
68, 70: polarizing plate
72, 74: polarizer
76, 78, 82, 84: polarizing plate protective film
L1: composition for forming resin layer
L2: quantum dot-containing polymerizable composition
L3: coating liquid containing oxygen-impermeable material
M: mold

What is claimed is:

1. A polymerizable composition comprising:
quantum dots;
a polymerizable compound containing one or more polymerizable groups selected from the group consisting of a (meth)acryloyl group and a (meth)allyl group in one molecule;
inorganic particles having an average particle diameter of 0.10 μm or more; and
a compound represented by General Formula (1), 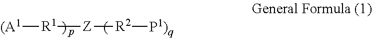
in General Formula (1), p is in a range of 2 to 9,
q is in a range of 1 to 8,
p+q is an integer in a range of 3 to 10,
Z represents a (p+q)-valent organic group,
R¹ and R² each independently represent a single bond or a divalent group,
A¹ represents a monovalent group including one or more groups selected from the group consisting of an acidic group, a basic group having a nitrogen atom, a urea group, a urethane group, a group having a coordinating oxygen atom, a hydrocarbon group having 4 or more carbon atoms, an alkoxysilyl group, an epoxy group, an isocyanate group, and a hydroxy group,
P¹ represents a polymer structure having an I/O value of 0.250 or more and 1.650 or less,
p pieces of A¹'s and p pieces of R¹'s each independently may be the same or different from each other, and
in a case where q is 2 or more, q pieces of R²'s and q pieces of P¹'s each independently may be the same or different from each other.

2. The polymerizable composition according to claim 1,
wherein the I/O value of P¹ is 0.300 or more and 1.300 or less.

3. The polymerizable composition according to claim 1,
wherein the I/O value of P¹ is 0.400 or more and 0.700 or less.

4. The polymerizable composition according to claim 1,
wherein the compound has a melting point of 30° C. or lower.

5. The polymerizable composition according to claim 1,
wherein the compound is a compound represented by General Formula (2), 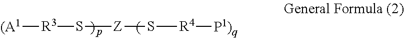
in General Formula (2), R³ and R⁴ each independently represent a single bond or a divalent group, p pieces of R³'s may be the same or different from each other, in a case where q is 2 or more, q pieces of R⁴'s may be the same or different from each other, and A¹, Z, P¹, p, and q each have the same definition as in General Formula (1).

6. The polymerizable composition according to claim 1,
wherein the polymer structure represented by P¹ includes a vinyl polymer chain.

7. The polymerizable composition according to claim 6,
wherein the vinyl polymer chain includes a repeating unit represented by General Formula (4-3), 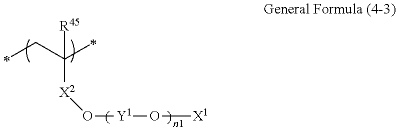
in General Formula (4-3), X¹ represents a hydrogen atom or a monovalent organic group, X² represents a divalent organic group, Y¹ represents a divalent organic group, X¹ and Y may form a ring, n1 is 1 or more, and * represents a bonding position with an adjacent atom.

8. The polymerizable composition according to claim 1,
wherein the polymer structure represented by P¹ includes a polyalkylene glycol chain.

9. The polymerizable composition according to claim 8,
wherein the polyalkylene glycol chain is a polypropylene glycol chain.

10. The polymerizable composition according to claim 1,
wherein the compound has a weight-average molecular weight in a range of 4,000 to 15,000.

11. The polymerizable composition according to claim 1,
wherein the inorganic particles have an average particle diameter of 0.30 μm or more and 5.00 μm or less.

12. The polymerizable composition according to claim 1,
wherein the inorganic particles have an average particle diameter of 0.30 μm or more and 5.00 μm or less,
the compound has a weight-average molecular weight in a range of 4,000 to 15,000, the compound has a melting point of 30° C. or lower, and
the compound is a compound represented by General Formula (2), 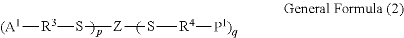
in General Formula (2), R³ and R⁴ are each independently represents a single bond or a divalent group, p pieces of R³'s may be the same or different from each other, in a case where q is 2 or more, q pieces of R⁴'s may be the same or different from each other, A¹, Z, P¹, p, and q each have the same definition as in General Formula (1),
P¹ has an I/O value of 0.400 or more and 0.700 or less,
the polymer structure represented by P¹ includes a vinyl polymer chain, and
the vinyl polymer chain includes a repeating unit represented by General Formula (4-3), 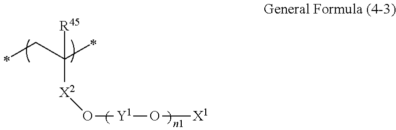
in General Formula (4-3), X¹ represents a hydrogen atom or a monovalent organic group, X² represents a divalent organic group, Y¹ represents a divalent organic group, X¹ and Y¹ may form a ring, n1 is 1 or more, and * represents a bonding position with an adjacent atom, and
the polymer structure represented by P¹ includes a polypropylene glycol chain.

13. A cured product obtained by curing the polymerizable composition according to claim 1.

14. A wavelength conversion member comprising the cured product according to claim 13.

15. A backlight unit comprising:
the wavelength conversion member according to claim 14; and
a light source.

16. A liquid crystal display device comprising:
the backlight unit according to claim 15; and
a liquid crystal cell.
